(19) United States
(12) Patent Application Publication
(10) Pub. No.: US 2025/0045304 A1
(43) Pub. Date: Feb. 6, 2025

(54) METHOD AND SYSTEM FOR INTERPRETING INPUTTED INFORMATION

(71) Applicant: Quatro Consulting LLC, Austin, TX (US)

(72) Inventor: Frank Quatro, Austin, TX (US)

(21) Appl. No.: 18/920,579

(22) Filed: Oct. 18, 2024

Related U.S. Application Data
(63) Continuation-in-part of application No. 18/745,678, filed on Jun. 17, 2024.
Application No. 18/745,678 is a continuation of application No. 17/769,700, filed on Apr. 15, 2022, now Pat. No. 12,032,603.

(51) Int. Cl. G06F 16/28; G06F 16/22; G06F 16/25; G06N 20/00

(52) U.S. Cl. CPC G06F 16/288; G06F 16/2282; G06F 16/254; G06N 20/00

(57) ABSTRACT

Methods and systems for interpreting inputted information are described herein. In some embodiments, a method comprises processing inputted information wherein processing inputted information uses one or more intelligence modules using one or more intelligence models to process the inputted information; making, by the one or more intelligence modules, one or more decisions about inputted information based on the one or more intelligence models; learning, by the one or more intelligence modules, to update the one or more intelligence models; and interpreting inputted information based on the one or more decisions.

### CLAIM OF PRIORITY

This application is a continuation-in-part of and claims the benefit of priority under 35 U.S.C. § 120 to U.S. patent application Ser. No. 18/745,678, filed on Jun. 17, 2024, which is a continuation of U.S. patent application Ser. No. 17/769,700, filed on Apr. 15, 2022, which is a U.S. National Stage Filing under 35 U.S.C. 371 from International Application No. PCT/US2019/000053, filed on Oct. 15, 2019, and published as WO 2021/076089 A1 on Apr. 22, 2021, each of which is incorporated by reference herein in its entirety.

### TECHNICAL FIELD

The present disclosure relates to methods and systems for interpreting inputted information.

### BACKGROUND

Enabling machines, devices and systems to make decisions and perform tasks that would normally require human intelligence is a valuable technological advancement. Performing artificial intelligence and automated decision making, in real-time with a variety of information and immediately learning from good or bad decisions and new information, is valuable innovation with multiple uses and applications. An example of one application is data error correction. Traditional information decision tools are reactive because they attempt to address information and/or decision errors after they are persisted in a computing system. Decision and/or information errors may reside or occur in a computing system for days or months. Inputted information and/or decisions related to inputted information introduce system risk that the information and/or decisions are not accurate. Accurate information and decisions reduce the overall risk in meeting a system's goal. Without this foundation, decision makers cannot make decisions with confidence. What is needed is a data or information processing, intelligence and decision system that addresses these issues and more.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 is a block diagram of a computing device, in accordance with an illustrative embodiment;

FIG. 2 is a block diagram of a computing system, in accordance with an illustrative embodiment;

FIG. 3 is a block diagram of a hyperintelligence system and one or more networks and computing environment, in accordance with some embodiments;

FIG. 4 illustrate a block diagram of a hyperintelligence system, in accordance with some embodiments;

FIG. 5 illustrates a detailed block diagram of a hyperintelligence system, in accordance with some embodiments;

FIG. 6 illustrates a block diagram to illustrate various configurations of a hyperintelligence system, in accordance with some embodiments.

FIG. 7 illustrates a sequence diagram, in accordance with some embodiments.

FIG. 8 illustrates a sequence diagram, in accordance with some embodiments.

FIG. 9 illustrates a sequence diagram, in accordance with some embodiments.

FIG. 10 illustrates a sequence diagram, in accordance with some embodiments.

FIG. 11 illustrates a sequence diagram, in accordance with some embodiments.

FIG. 12 illustrates a sequence diagram, in accordance with some embodiments.

FIG. 13 illustrates a prior art traditional data quality tool implementation;

FIG. 14 illustrates TYPO (IS A TRADEMARK/SERVICEMARK OF QUATRO CONSULTING LLC) in the context of a data quality application of a hyperintelligence system, in accordance with some embodiments;

FIG. 15 illustrates TYPO (IS A TRADEMARK/SERVICEMARK OF QUATRO CONSULTING LLC) data quality barrier for enterprise information systems, in accordance with some embodiments; and

FIG. 16 illustrates a traditional data quality tool using TYPO (IS A TRADEMARK/SERVICEMARK OF QUATRO CONSULTING LLC), in accordance with some embodiments;

FIG. 17 illustrates a flow diagram of a hyperintelligence system lifecycle, in accordance with some embodiments;

FIG. 18 illustrates a schematic diagram of a directed acyclic graph, in accordance with some embodiments;

FIG. 19 illustrates a schematic diagram of a directed acyclic graph, in accordance with some embodiments;

FIG. 20 illustrates a schematic diagram of a directed acyclic graph, in accordance with some embodiments.

FIG. 21 depicts a flow chart of a process to obtain software code that generates inferences based on inputted data obtained from a computing device or system, in accordance with one or more example implementations.

FIG. 22 illustrate a flow diagram of a process to determine mappings between data stored in different databases using generative models, in accordance with one or more example implementations.

FIG. 23 is a block diagram illustrating components of a machine, according to some example implementations, able to read instructions from a machine-readable medium (e.g., a machine-readable storage medium) and perform any one or more of the methodologies discussed herein.

FIG. 24 is a block diagram illustrating system 2400 that includes an example software architecture, which may be used in conjunction with various hardware architectures herein described.

### DETAILED DESCRIPTION

In the following description, for the purposes of explanation, numerous specific details are set forth in order to provide a thorough understanding. Some embodiments may be practiced without these specific details. Features described in one embodiment may be combined with features described in a different embodiment. In some examples, well-known structures and devices are described with reference to block diagrams in order to avoid unnecessarily obscuring the present invention.

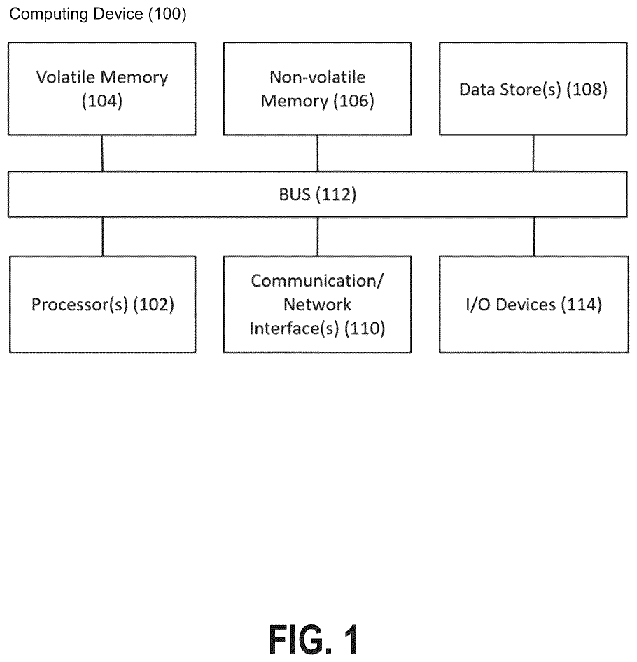

According to one embodiment, the methods and systems described herein are implemented by one or more general-purpose and/or special-purpose computing devices. As shown in FIG. 1, computing device 100 can include one or more processors 102, volatile memory 104 (e.g., RAM), non-volatile memory 106 (e.g., one or more hard disk drives (HDDs), other magnetic or optical storage media, one or more solid state drives (SSDs) such as a flash drive or other solid state storage media, one or more hybrid magnetic and solid state drives), zero or more data store(s) 108, or zero or more virtual storage volumes, such as a cloud storage, or a combination of such physical storage volumes and virtual storage or arrays thereof), zero or more communication/network interfaces 110, and communication bus 112. User interfaces can include graphical user interface (GUI) (e.g., a touchscreen, a display, etc.) or one or more other input/output (I/O) devices 114 (e.g., a mouse, a keyboard, sensor, etc.). Non-volatile memory 106 may store an operating system, one or more applications, and information/data such that, for example, computer instructions of operating system and/or applications are executed by processor(s) 102 out of volatile memory 104. Information or data can be entered using an input device of or received from other I/O device(s) 114. Various elements of computing device 100 can communicate via communication bus 112. Computing device 100 as shown in FIG. 1 is shown merely as an example, as the methods and systems described herein can be implemented by any computing or processing environment and with any type of machine or set of machines that can have suitable hardware and/or software capable of operating as described herein.

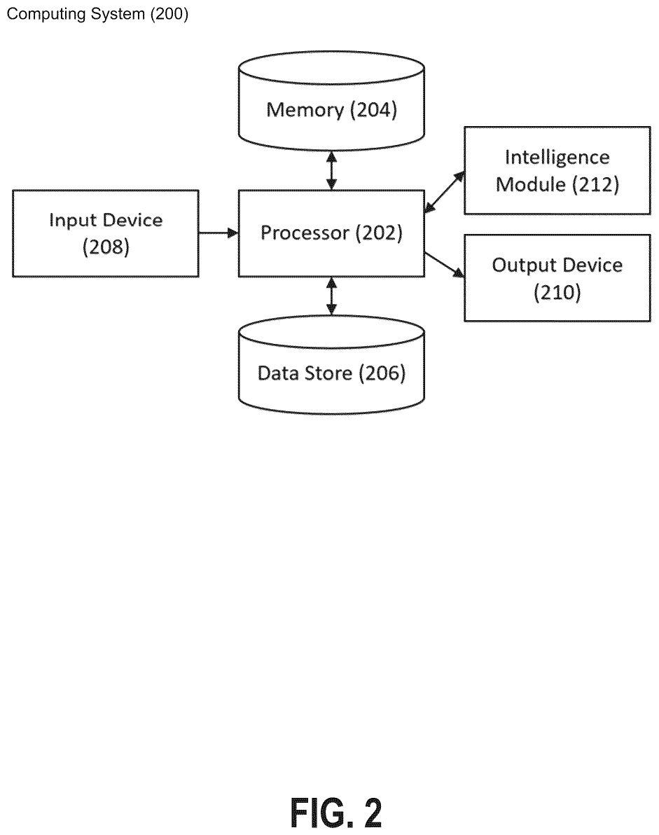

Referring now to FIG. 2, a computing system 200 in which the methods and systems described herein are executed or deployed in accordance with an illustrative embodiment is shown. Computing system 200 can include one or more processors 202, memory 204, one or more data store(s) 206 (e.g., RAM) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof). Computing system 200 also includes one or more other input/output (I/O) devices 208, 210. In accordance with the methods and systems described herein, computing system 200 includes an intelligence module 212. Memory 204, data store 206, input/output devices 208, 210 and intelligence module 212 may be communicatively coupled to processor 202 via one or more networks, communication buses or wired or wireless links. Computing system 200 as shown in FIG. 2 is shown merely as an example, as the methods and systems described herein can be implemented by any computing or processing environment and with any type of machine or set of machines that can have suitable hardware and/or software capable of operating as described herein. Computing system 200 and intelligence module 212 and the methods and systems described herein will be further described in detail below in reference to additional figures.

Processor(s) 102,202 can be implemented by one or more programmable processors executing one or more computer programs to perform the functions of the method or system. As used herein, the term “processor” describes an electronic circuit that performs a function, an operation, or a sequence of operations. The function, operation, or sequence of operations can be hard coded into the electronic circuit or soft coded by way of instructions held in a memory device. A “processor” can perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, graphics processing units (GPUs), or general-purpose computers with associated memory. The “processor” can be analog, digital or mixed-signal. In some embodiments, the “processor” can be one or more physical processors or one or more “virtual” (e.g., remotely located or “cloud”) processors. According to one embodiment, the methods and systems described herein are implemented by one or more general-purpose and/or special-purpose computing devices. The general-purpose and/or special-purpose computing devices may be hard-wired to perform the methods, or may include digital electronic devices such as one or more application-specific integrated circuits (ASICs), field programmable gate arrays (FPGAs), graphics processing units (GPUs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICS, FPGAs, GPUs, or NPUs with custom programming to accomplish the methods. The special-purpose computing devices may be desktop computer systems, portable computer systems, handheld devices, networking devices or any other device or system that incorporates hard-wired and/or program logic to implement the methods or techniques.

The terms “memory” or “data store” as used herein refers to any non-transitory media that store data, information and/or instructions that cause a machine to operate in a specific fashion. Such storage media may comprise non-volatile media and/or volatile media. Non-volatile media includes, for example, optical or magnetic disks, such as storage device. Volatile media includes dynamic memory, such as main memory. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires. Transmission media can also take the form of acoustic or light waves, such as those generated during radio-wave, infra-red or wireless/cellular information/data communications.

Various forms of media may be involved in carrying one or more sequences of one or more instructions to processors 102, 202 for execution. For example, the instructions may initially be carried on a magnetic disk or solid state drive of a remote computer. Communications interfaces can include one or more interfaces to enable computer device or system 100, 200 to access a one or more computer networks such as a LAN, a WAN, or the Internet through a variety of wired and/or wireless or cellular connections. In described embodiments, a first computing device 100 can execute an application on behalf of a user of a client computing device, can execute a virtual machine, which provides an execution session within which applications execute on behalf of a user or a client computing device, such as a hosted desktop session, can execute a terminal services session to provide a hosted desktop environment, or can provide access to a computing environment including one or more of: one or more applications, one or more desktop applications, and one or more desktop sessions in which one or more applications can execute.

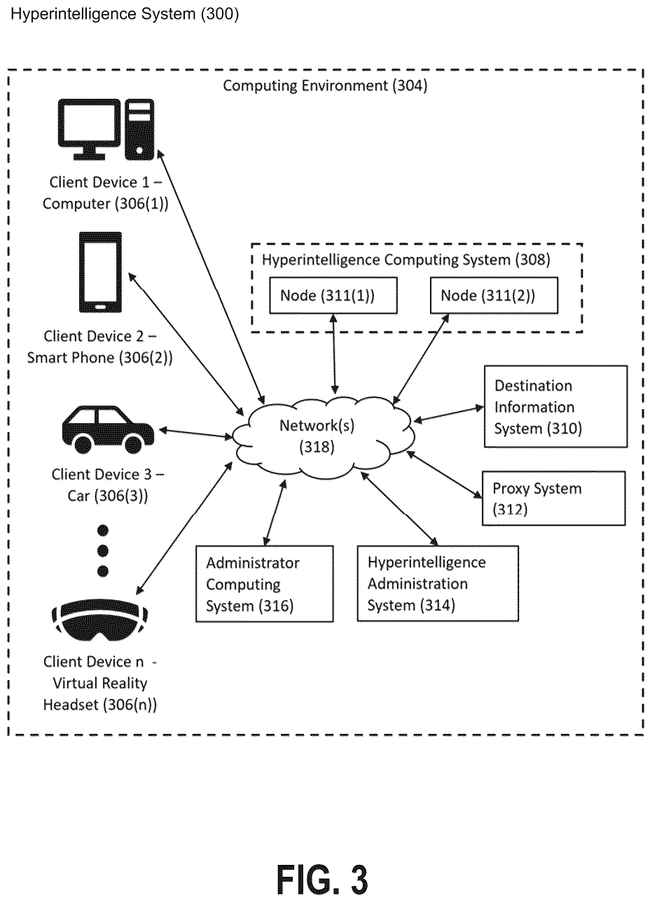

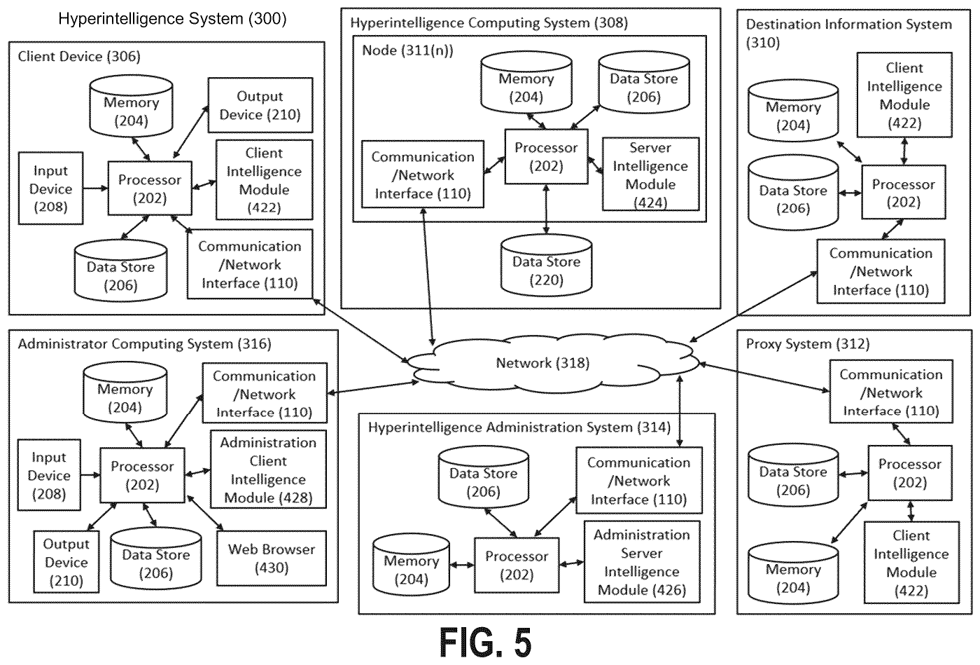

Turning now to FIGS. 3, 4 and 5, a hyperintelligence system and one or more networks and computing environment in or by which the methods and systems described herein are executed or deployed is illustrated, in accordance with some embodiments. It will be understood that identical reference numbers shown in FIGS. 1-5 indicate identical components. The components illustrated in FIGS. 1-5 may be implemented in software and/or hardware. Each component may be distributed over multiple applications, systems, devices and/or machines. Multiple components may be combined into one application, system, device and/or machine. Methods or operations described with respect to one component may instead be performed by another component. Some embodiments may be practiced without these specific details. Features described in one embodiment may be combined with features described in a different embodiment. In some examples, well-known structures and devices are described with reference to a block diagram in order to avoid unnecessarily obscuring the present invention.

### Introduction To Hyperintelligence System

The hyperintelligence system 300 platform is an information processing and decision system/platform which provides fast decisions to interpret inputted information and make the best future decisions possible from real-time feedback and learning via artificial intelligence, machine learning, data science, statistics and other approaches.

### Hyperintelligence System Lifecycle

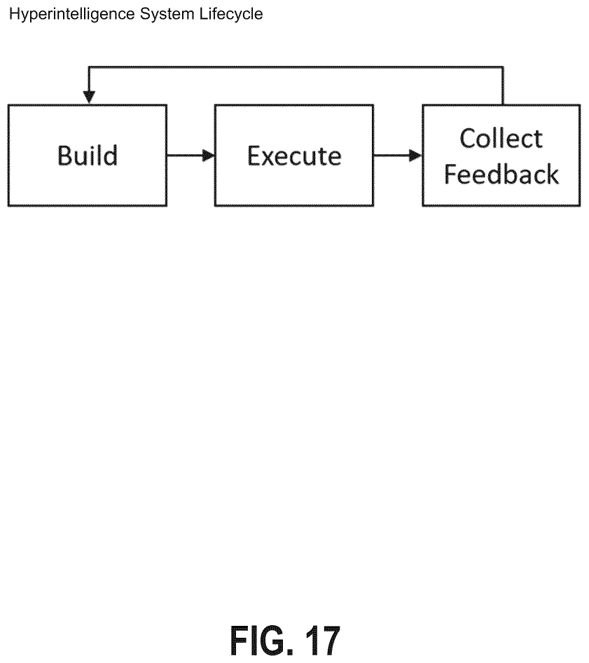

To understand the method and systems executed in/by hyperintelligence system 300 an understanding of the overall lifecycle and a description of a few key concepts is helpful or may be necessary. Hyperintelligence system 300 makes use of, executes or employs one or more intelligence models (sometimes referred to as just models herein) to make/provide decision(s) or prediction(s) based on inputted information/data. A model must be built and deployed before it can be used to make a decision. A model may be rebuilt after feedback regarding a decision is provided. This enables the model to learn. As a result, three phases exist in the overall lifecycle: Build model(s), Execute model(s), and Collect Feedback for model(s) as illustrated in FIG. 17. One or more models that the hyperintelligence systems makes use of, executes, employs, builds, trains, fine-tunes, stores, or distributes may have multi-modal inputs or outputs. The final results and decisions may be multi-modal. Foundation models may be fine-tuned prior to deployment into the hyperintelligence system or fine-tuned during the build phase of the hyperintelligence system lifecycle or Train Model steps of Build Predictor Model DAG and Build Profiler Model DAG. Feedback collected may be multi-modal. Any device, system, or user of the hyperintelligence system may provide, interact with, or receive multi-modal data. Decision plans and workflow must support multi-modal data.

Each phase includes steps in its lifecycle which may or may not be executed concurrently. Building a model and executing a model are two separate phases of a model lifecycle. Each phase requires different information. Templates are declarative JSON (JavaScript Object Notation) files. There are two templates in the hyperintelligence system, model template and model type template. Each template is used to create a model or model type. A model type template stores the information relevant to a model type. A model template will reference a model type. A model template stores the information necessary to build and execute a model. During model build and model execution, steps may be skipped by providing a null value for the template property. This will provide flexible configuration and the ability to create models or rules that do not use all the steps in an artificial intelligence algorithm or other advanced data science methods. Throughout this document the terms model, algorithm or rule may refer to the same concept unless noted otherwise. A template may inherit from and override or extend one parent template. A JavaScript mixin for the parent and child JSON templates will be used to merge the two templates into one template. Templates may be versioned and deployed to one or more model storage repositories.

The build configuration of the model template is used during the model build phase of the hyperintelligence system lifecycle. The build configuration that is used at runtime during the model build phase may be overridden by specifying a ConfigurationService (see Configuration Service section) key with the naming convention <algorithm-name>.<version>.modelConfiguration or <algorithm-name>.latest.model and a value equal to a repository locator. This will enable the model builder to download this model template from the model storage repository. Model type templates are created and managed through the Administration Client Intelligence Module or the administration server intelligence module.

### Model Type Template Properties

Model type template properties are detailed below:
name—Unique user-friendly model type name (combination of name, group, type and classifier must be unique). Prefixed with “predictor-”, “rule-” or “profiler-”. (Note: The predictor type examples for TYPO (is a trademark/servicemark of Quatro Consulting LLC) are predictor-duplicate and predictor-error). The profiler types are profiler-domain-detector-<domain-tag> or profiler-metric-<metric-name> (for example: profiler-domain-detector-email, profiler-domain-detector-address, profiler-domain-detector-firstname, profiler-metric-fuzzy-unique-count), (NOTE: profiler-metric models are typically not traditional data science models and are typically logic or calculations based on all or a portion of values in a column or set of columns.)
group—user-friendly group name
type—Optional-user-friendly type name
classifier-Optional-user-friendly classifier
version-Version of model type
result_type—The result type is one of: binary-classification, multi-class-classification, multi-label-classification, probability (value in range of 0-1), continuous, multi-modal, any, audio, video, image, three-dimensional (3D) data, multidimensional, vector, BCI signal, or uri. This result type is used by the Rapid Optimization (see Rapid Optimization section).
decision_logic_array—array of objects with runtime and logic properties. The runtime property is the runtime necessary to execute the Decision Logic. For example, python, c, c++, java, scala, spark, r, or javascript. The logic property is the logic or code that will be executed by the runtime. See Decision Logic section.

### Model Template Properties

Model template properties are detailed below:
name—user-friendly model name (combination of name, group, type and classifier must be unique)
group—user-friendly group name
type—Optional-user-friendly type name
classifier—Optional-user-friendly classifier
version—Version of model
model_type—Unique identifier to the type of model. Upon creation of a model template, if the model type does not exist, then the template creation or update will fail and an appropriate user-friendly message is provided.
result_metadata—Array of key value pairs containing additional result attributes like confidence_level, result_source (one of table-level-model, model, rapid-optimization), etc.
algorithm—Unique identifier to algorithm package including version (use Apache Maven convention)
tenant_id-Unique tenant identifier and publisher/maintainer of the template
runtime—This is the runtime necessary to run the model. One of python, c, c++, java, scala, spark, r, or javascript
executeRequires—Array of the required runtime dependencies to execute the model
buildRequires—Array of the required runtime dependencies to build the model
testRequires—Array of the required test dependencies for model testing
min_required_records—Minimum number of required records in the dataset to build the model
build_lifecycle_engine—The type of lifecycle engine for the build phase. Defaults to DAG engine.
build_logic—Array with logic for steps in the model build process that are called in an order determined by the build_lifecycle_engine. Each item includes a unique step name and the path to the function. Step names include:
   run_before_build-Initialization function for the build process
   validate_build_params-Validate build parameters in build_params property
   determine_training_resources-logic to determine the preferred node size and number for training. Logic includes determining the preferred node size and node number (specifies resource levels for number of CPUs, CPU speed, memory, disk space, IOPS, network speed, etc.). This logic will overwrite any default value provided in the build_params
   determine_test_resources-logic to determine the preferred node size and number for testing. Logic includes determining the preferred node size and node number (specifies resource levels for number of CPUs, CPU speed, memory, disk space, IOPS, network speed, etc.). This logic will overwrite any default value provided in the build_params
   determine_execute_resources-logic to determine the preferred node size and number for executing during data processing of data in motion or at rest. Logic includes determining the preferred node size and node number (specifies resource levels for number of CPUs, CPU speed, memory, disk space, IOPS, network speed, etc.). This logic will overwrite any default value provided in the execute_params. The results are added to execute_params property
   preprocess_data-Data Preprocessing Logic for build phase and may be used for execute phase if preprocess_data step not provided in the execute_logic property
   prepare_data-Training and test data creation logic. Verify dataset has row count greater than or equal to the value of ConfigurationService key minRowsForModelBuild.
   select_features-Feature Selection Configuration for build and may be used for execute phase if select_features step not provided in the execute_logic property. Datasets have multiple columns and not all columns are relevant or needed for the algorithm to provide good error predictions. This is code to determine irrelevant dimensions and exclude from predictor and profiler model types.
   train-Logic to train the model. Includes any algorithm parameter optimization. May add or change the execute_params property
   run_after_build-Cleanup and termination function for the build process.
build_params—Parameters that are made available to all functions in the
execute_lifecycle_engine—The type of Lifecycle Engine for the execute phase. Defaults to DAG engine.
execute_logic—Array with logic for steps in the model build process that are called in an order determined by the execute_lifecycle_engine. Each item includes a unique step name and the path to the function. Note that the execute_lifecycle_engine may use logic from the build_logic property. When this occurs the execute_logic array is checked for a step name and if available the logic provided is used, otherwise the logic from the build_logic array is used. Step names include:
   run_before_execute—Logic to run before execute phase starts
   validate_execute_params—Logic to validate execute_params property
   preprocess_data—Data Preprocessing Logic for execute phase
   select_features—Feature Selection Configuration for execute phase. Datasets have multiple columns and not all columns are relevant or needed for the algorithm to provide good error predictions. This is code to determine irrelevant dimensions and exclude from predictor and profiler model types.
   execute-Runs the model and returns results
   run_after_execute-Logic to run last and directly before the execute phase ends
execute_params-Parameters that are made available to all step in the execute_logic array

### Algorithm Packages

Algorithm packages are built, versioned and deployed to a repository. Algorithm package is a zip containing:
Manifest file containing:
   name—user-friendly name (combination of name, group, type and classifier must be unique)
   group—user-friendly group name
   type—Optional-user-friendly type name
   classifier—This is the runtime necessary to run the algorithm. One of python, c, c++, java, scala, spark, r, or javascript
   version-Version of an algorithm package
   tenant_id—Unique tenant identifier and publisher/maintainer of the algorithm
   type—one of weighted-average, predictor, rule, profiler-domain-detector, profiler-metric
   result_type—One of: binary-classification, multi-class-classification, multi-label-classification, continuous, multi-modal, any, audio, video, image, three-dimensional (3D) data, multidimensional, vector, BCI signal, or uri
Algorithm or reference to algorithm
Function to determine if algorithm complies with dataset, data profile and feature selection configuration which are parameters to the function

### Model Packages

During Model Build phase, built algorithms are downloaded from a repository based on package identifier. Data training and test selection logic is executed. Model is trained with selected data. Runtime Configuration is packaged with the built model. Then a versioned model is deployed to the Model Storage repository with the naming convention <algorithm-group>.<algorithm-name>.<modelType>.<datasetId>.<datasetTypeIdentifier>-<algorithm-version>-<major-version>.<minor-verison>.<patch-version>.<build-number> [-<runtime-calssifier>] (this is package identifier). Model package is a zip containing:
Manifest file containing:
   name—user-friendly name (combination of name, group, type and classifier must be unique)
   group—user-friendly group name
   type—Optional-user-friendly type name
   classifier—This is the runtime necessary to run the model. One of python, c, c++, java, scala, spark, r, or javascript
   version—Version of an algorithm package
   tenant_id—Unique tenant identifier and publisher/maintainer of the algorithm
Model Configuration
   Runtime Configuration

At runtime, a worker will query the model storage with a package identifier for a version of the model and execute it.

The classifier property or other properties of the Model Type Template, Model Template, and algorithm package maybe used to identify requirements to run, train, and build an algorithm or model. Requirements may include but are not limited to required hardware or software resources like hardware platform, software platform, Kuda, graphic processing units (GPUs), tensor processing units (TPUs), central processing units (CPUs), memory, storage, network, interconnects, dependencies and more.

### Infrastructure Architecture

Hyperintelligence system 300 uses a microservices based architecture with containers and a container orchestration manager for automating deployment, scaling, and management of containerized applications. All services are individually scalable, maintainable and manageable. Services include but are not limited to:
Datastore Service—the main data store for the hyperintelligence computing system
Hyperintelligence Administration System Data Store—Data store used by the hyperintelligence administration system
Usage Datastore Service—Data store used to hold usage information
Blockchain Service—Blockchain used to store inputted information, intercepted data, processing date, dataset metadata and information, model information (version, inputs, etc.), results, decisions, any available feedback, any available user information, and source of data. Provides a permanent distributed ledger of the results and decisions made by hyperintelligence system.
Request Handler—Responsible for handling and delegating requests for the hyperintelligence computing system
Queue—A queue that holds messages sent between two or more services or components. At least once delivery will be used to improve performance and throughput. Any message that is delivered twice (or in duplicate) to the same recipient should be ignored by the message recipient.
Worker—A worker reads messages from the queue. The messages contain information concerning what work to complete. A worker executes code based on the runtime it supports. See runtime property of the model template properties section.
Results Cache—A persistent cache holding temporary results and decisions
Model Test Handler—Responsible for handling and delegating test requests for the hyperintelligence computing system
Model Storage Service—repository that provides storage for different versions and types of models, algorithms, packages and other artifacts
Audit Request Handler—Responsible for handling and delegating audit (or scanning of data at rest) requests for the hyperintelligence computing system
Configuration Endpoint—REST API that provides configuration information that is queried from the Hyperintelligence Administration System Data Store
Build Worker—A worker reads messages from the queue. The messages contain information concerning what work to complete. A worker executes build code based on the runtime it supports. See runtime property of the model template properties section.

### Deployment Configuration

Referring to FIG. 3, a block diagram of a hyperintelligence system 300 and one or more networks 318 and computing environment 304, in accordance with some embodiments, is depicted. Hyperintelligence system 300 can include one or more clients 306(1)-306 (n) (also generally referred to as local machine(s) 306 or client device(s) 306) in communication with a hyperintelligence computing system 308, destination information system 310, proxy system 312, hyperintelligence administration system 314 and administrator computing system 316 via one or more networks 318. It will be appreciated that hyperintelligence system 300 is not limited to the use or need for any computing environment or network. Although the embodiment shown in FIG. 3 shows one or more networks 318, in other embodiments, hyperintelligence system 300 can be on the same network. The various networks 318 can be the same type of network or different types of networks. For example, in some embodiments, one or more networks 318 can be a private network such as a local area network (LAN) or a company Intranet, while one or more networks 318 and/or network 318 can be a public network, such as a wide area network (WAN) or the Internet. In other embodiments, network 318 can be private networks. Networks 318 can employ one or more types of physical networks and/or network topologies, such as wired and/or wireless networks, and can employ one or more communication transport protocols, such as transmission control protocol (TCP), internet protocol (IP), user datagram protocol (UDP) or other similar protocols.

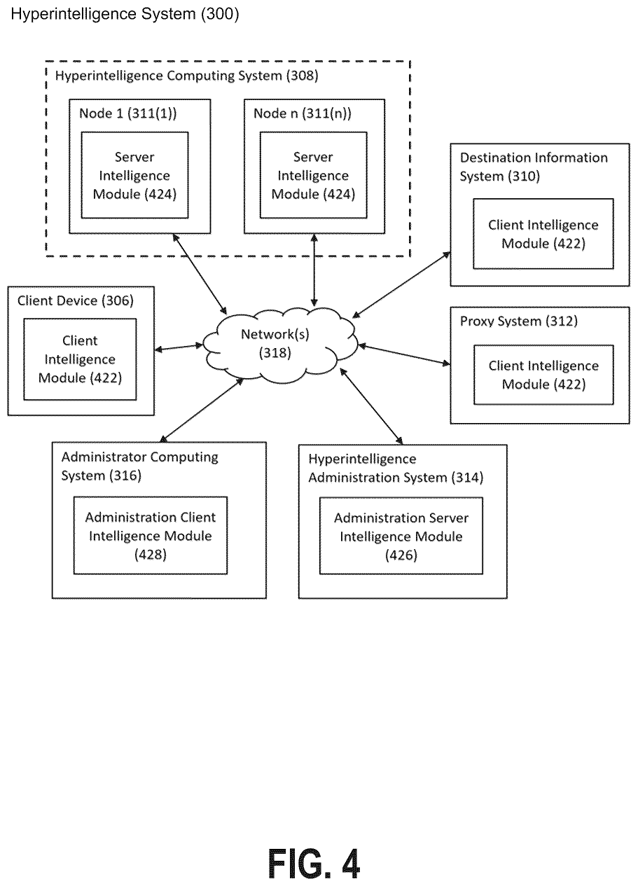

As shown in FIG. 3, hyperintelligence system 300 may include one or more servers or operate in or as a server farm. Hyperintelligence computing system 308 includes one or more nodes 311(1)-311 (n) or servers or server farm logically grouped, and can either be geographically co-located (e.g., on premises) or geographically dispersed (e.g., cloud based). In an embodiment, node(s) 311 executes methods to be described in further detail below. Hyperintelligence computing system 308 can accelerate communication with client device(s) 306 via one or more networks 318 using one or more techniques, such as: 1) transport layer connection pooling, 2) transport layer connection multiplexing, 3) transport control protocol buffering, 4) compression, 5) caching, or other techniques. Hyperintelligence computing system 308 can also provide load balancing and autoscaling of node(s) 311 to process requests from client device(s) 306 and/or Client Intelligence Module(s) 422 shown in FIG. 4. Proxy system 312 acts as a proxy or access server to provide access to the one or more nodes/servers, provide security and/or act as a firewall between a client device(s) 306 and other parts of hyperintelligence system 300.

Still referring to FIGS. 3, 4 and 5, hyperintelligence system 300 is shown having components in one deployment configuration according to the embodiments. Not all deployment configurations are shown, and it will be understood that there are many different configurations possible. FIGS. 3, 4 and 5 components are described in further detail as follows:
Client Device 306—origin or source system or device creating or providing data. Client Device 306 has a data store which may be the final destination of the data. Client device 306 may be numerous devices including but not limited to computers, tablets, mobile phones, virtual reality headsets, gaming consoles, cars, transportation equipment, manufacturing equipment, cameras, watches, human sensory devices, musical instruments, wearable devices, etc.;
Destination Information System 310—destination of the data provided by client device 306;
Hyperintelligence Computing System 308 is a cluster of one or more computing nodes or servers that processes the information or data and runs intelligence models to make a decision or prediction about the inputted information/data. Each node/server may have one or more processors, network interfaces, data stores, and memory;
Hyperintelligence Administration System 314—Provides a graphical user interface to perform administrative tasks and review hyperintelligence system 300 results, decisions, and state. The hyperintelligence administration system 314 interfaces with the hyperintelligence computing system 308;
Administrator Computing System 316—The system used by an administrative user
Client Intelligence Module 422—component that is provided inputted data from the client device and processes the data locally and remotely by interfacing with the hyperintelligence computing system 308 and/or other client intelligence modules 422;
Server Intelligence Module 424—Executable code residing on each server node in the hyperintelligence computing system 308 that processes data and requests concurrently;
Administration Server Intelligence Module 426—Executable code that provides a graphical user interface for performing administrative tasks on the hyperintelligence system 300; and
Administration Client Intelligence Module 428—Executable code that provides an interface like a command line interface (CLI) for performing administrative tasks on the hyperintelligence system 300.

### All Components

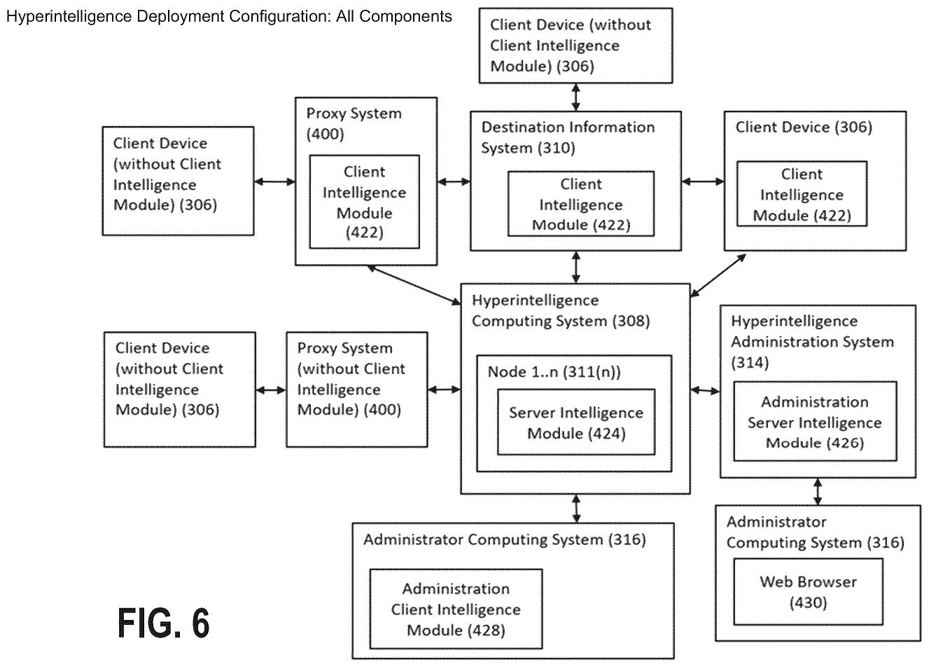

FIG. 6 illustrates possible different components and configuration combinations. It will be understood that identical reference numbers shown in FIGS. 3, 4 and 5 indicate identical components in FIG. 6. This figure is not intended to show a specific deployment configuration. A multitude of deployment configurations are possible. This figure illustrates different configurations wherein the client intelligence module may be on/in the client device, the client intelligence modules may be on/in the proxy system or wherein a proxy system having no intelligence modules forwards information to the hyperintelligence computing system 308 or the wherein the client module does not have any intelligence module but the destination system does have an client intelligence module.

### Sequence Diagrams

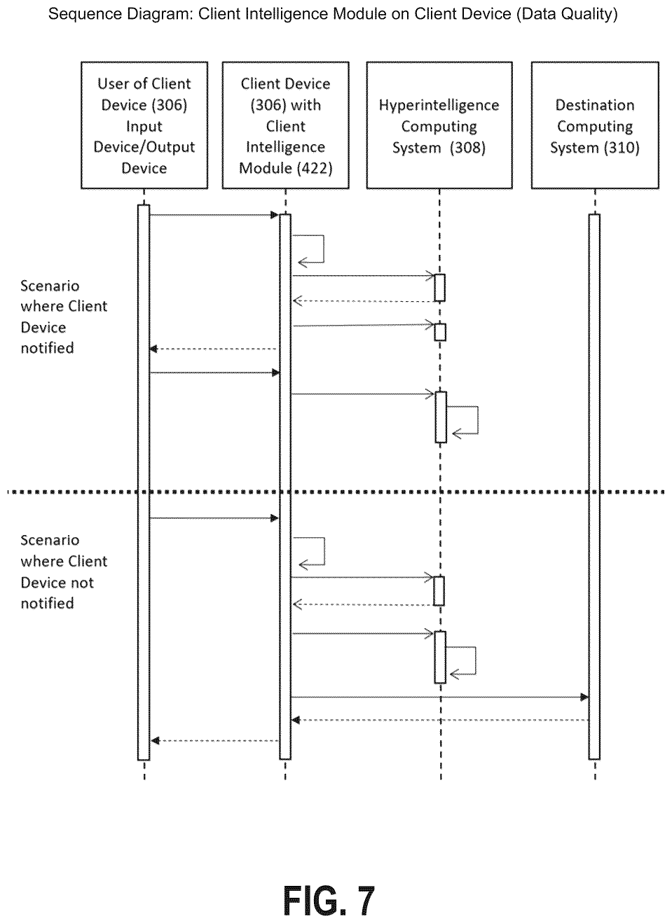

Referring now to FIGS. 7-12, sequence diagrams are shown to illustrate the methods executed in or by a hyperintelligence system and one or more networks and computing environment, in accordance with some embodiments. It will be understood that identical reference numbers shown in FIGS. 3-6 indicate identical components in FIGS. 7-12. These sequence diagrams are shown in the context of various deployment configurations as set forth and described in connections with FIGS. 1-6. While FIGS. 7-12 are shown as Object Management Group, Inc. Unified Modeling Language (UML) sequence diagrams (see https://www.uml.org/), it will be appreciated that alternative sequence, state diagrams or flowcharts could be used to illustrate the methods and systems in accordance with the embodiments.

### Client Intelligence Module On Client Device

FIG. 7 illustrates a sequence/state diagram in which the client intelligence module 422 is in/on the client device 306. FIG. 7 depicts two scenarios: 1) wherein client device 306 is notified and 2) wherein client device 306 is not notified. The sequence for wherein client device 306 is notified is shown on the top half above the dotted line with each arrow from top to bottom as follows:
1. User of one or more source system input/output device(s) submits data to client device;
2. Client device client intelligence module runs local models;
3. Client device client intelligence module sends data to hyperintelligence computing system;
4. Hyperintelligence computing system runs appropriate models concurrently on nodes and returns results and decisions to client device client intelligence module;
5. Client device client intelligence module calculates final results and decisions and sends final results and decisions to hyperintelligence computing system;
6. In this scenario the final decisions predict an error, so client device displays prediction to user;
7. User provides feedback about the prediction to client device;
8. Client device sends feedback to hyperintelligence computing system. In this scenario the feedback confirms the prediction is correct. Alternate path: If feedback confirms the prediction is incorrect then an additional step would be appended after this step wherein client device client intelligence module sends the data to the destination computing system. (This scenario is provided below); and
9. Hyperintelligence computing system learns by rebuilding and distributing models (NOTE: Based on configuration this may require communication with destination computing system data store).

Still referring to FIG. 7, the sequence for wherein client device 306 is not notified is shown on the bottom half below the dotted line with each arrow from top to bottom as follows:
1. User of one or more source system input/output device(s) submits data to client device;
2. Client device client intelligence module runs local models;
3. Client device client intelligence module sends data to hyperintelligence computing system;
4. Hyperintelligence computing system runs appropriate models concurrently on nodes and returns results and decisions to client device client intelligence module;
5. Client device client intelligence module calculates final results and decisions and sends final results and decisions to hyperintelligence computing system;
6. Hyperintelligence computing system learns by rebuilding and distributing models (NOTE: Based on configuration this may require communication with destination computing system data store);
7. In this scenario the final decisions predict not error, so prediction is not displayed to user. Instead client device client intelligence module sends the data to the destination computing system;
8. Destination computing system sends response to client device; and
9. Client device displays response on output device for user.

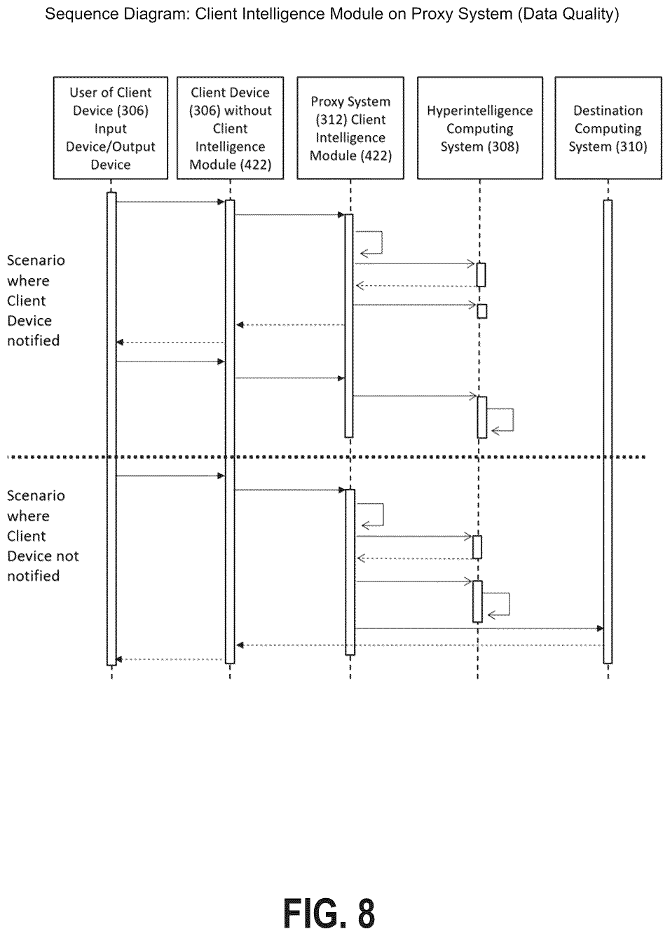

FIG. 8 illustrates a sequence/state diagram in which the client intelligence module 422 is in/on the proxy system 312. FIG. 8 again depicts two scenarios: 1) wherein client device 306 is notified and 2) wherein client device 306 is not notified. The sequence for wherein client device 306 is notified is shown on the top half above the dotted line with each arrow from top to bottom as follows:
1. User of one or more source system input/output device(s) submits data to client device;
2. Client device sends data to proxy system (where final destination of data is the destination computing system);
3. Proxy system client intelligence module runs local models;
4. Proxy system client intelligence module sends data to hyperintelligence computing system;
5. Hyperintelligence computing system runs appropriate models concurrently on nodes and returns results and decisions to proxy system client intelligence module;
6. Proxy system client intelligence module calculates final results and decisions and sends final results and decisions to hyperintelligence computing system;
7. In this scenario the final decisions predict an error, so proxy system client intelligence module sends the prediction to the client device;
8. Client device displays prediction to user via output device;
9. User provides feedback about the prediction;
10. Client device sends feedback to proxy system client intelligence module;
11. Proxy system client intelligence module sends feedback to hyperintelligence computing system. In this scenario the feedback confirms the prediction is correct. Alternate path: If feedback confirms the prediction is incorrect then an additional step would be appended after this step wherein proxy system client intelligence module sends the data to the destination computing system. (This scenario is described in further detail below); and
12. Hyperintelligence computing system learns by rebuilding and distributing models (NOTE: Based on configuration this may require communication with destination computing system data store).

Still referring to FIG. 8, the sequence for wherein client device 306 is not notified is shown on the bottom half below the dotted line with each arrow from top to bottom as follows:
1. User of one or more source system input/output device(s) submits data to client device;
2. Client device sends data to proxy system (where final destination of data is the destination computing system);
3. Proxy system client intelligence module runs local models;
4. Proxy system client intelligence module sends data to hyperintelligence computing system;
5. Hyperintelligence computing system runs appropriate models concurrently on nodes and returns results and decisions to proxy system client intelligence module;
6. Proxy system client intelligence module calculates final results and decisions and sends final results and decisions to hyperintelligence computing system;
7. Hyperintelligence computing system learns by rebuilding and distributing models (NOTE: Based on configuration this may require communication with destination computing system data store);
8. In this scenario the final decisions predict not error, so prediction is not displayed to user. Instead, proxy system client intelligence module sends the data to the destination computing system;
9. Destination computing system sends response to client device (Note: Some network configuration may require the response to go through the proxy system); and
10. Client device displays response on output device for user.

### Proxy System Forwards To Hyperintelligence Computing System

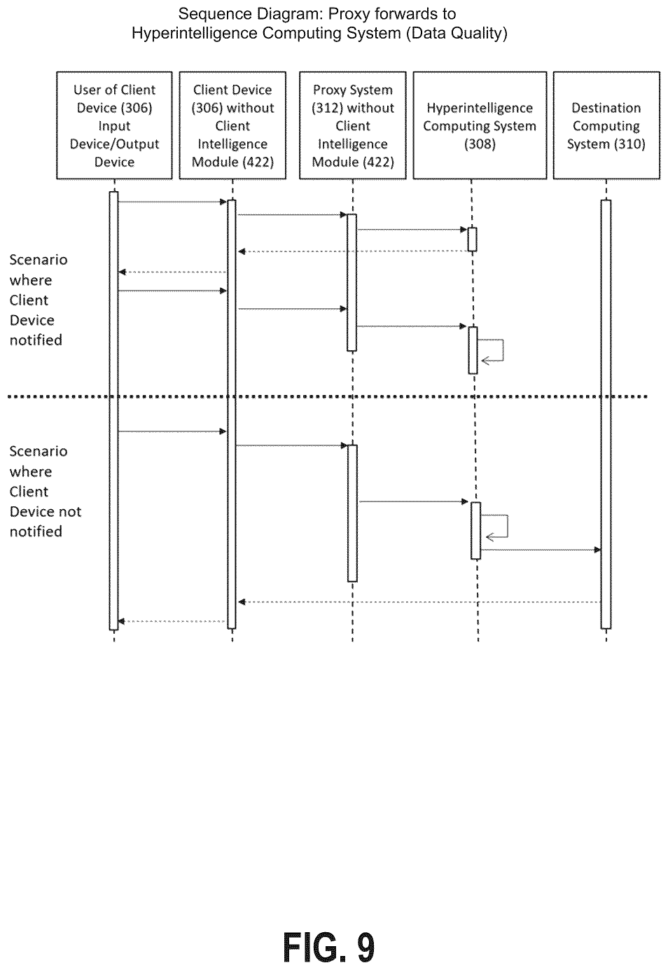

FIG. 9 illustrates a sequence/state diagram in which client intelligence module 422 is not used but instead proxy system 312 forwards inputted information/information to hyperintelligence computing system 308. Again FIG. 9 depicts two scenarios: 1) wherein client device 306 is notified and 2) wherein client device 306 is not notified. The sequence for wherein client device 306 is notified is shown on the top half above the dotted line with each arrow from top to bottom as follows:
1. User of one or more source system input/output device(s) submits data to client device;
2. Client device sends data to proxy system (where final destination of data is the destination computing system);
3. Proxy system sends data to hyperintelligence computing system;
4. Hyperintelligence computing system runs appropriate models concurrently on nodes and calculates final results and decisions. In this scenario the final decisions predict an error, so prediction response is sent to client device (Note: Some network configurations may require the response to go through the proxy system);
5. Client device displays prediction to user with output device;
6. User provides feedback about the prediction;
7. Client device sends feedback to proxy system;
8. Proxy system sends feedback to hyperintelligence computing system. In this scenario the feedback confirms the prediction is correct. Alternate path: If feedback confirms the prediction is incorrect then an additional step would be appended after this step wherein hyperintelligence computing system sends the data to the destination computing system. (This scenario is described in detail below); and
9. Hyperintelligence computing system learns by rebuilding and distributing models (NOTE: Based on configuration this may require communication with destination computing system data store).

Still referring to FIG. 9, the sequence for wherein client device 306 is not notified is shown on the bottom half below the dotted line with each arrow from top to bottom as follows:
1. User of one or more source system input/output device(s) submits data to client device;
2. Client device sends data to proxy system (where final destination of data is the destination computing system);
3. Proxy system sends data to hyperintelligence computing system;
4. Hyperintelligence computing system runs appropriate models concurrently on nodes and calculates final results and decisions. In this scenario the final decisions predict not error, so no prediction response is sent to client device. Hyperintelligence computing system learns by rebuilding and distributing models (NOTE: Based on configuration this may require communication with destination computing system data store);
5. Hyperintelligence computing system sends data to destination computing system;
6. Destination computing system sends response to client device (Note: Some network configuration may require the response to go through the proxy system); and
7. Client device displays response on output device for user.

### Client Intelligence Module On Destination Computing System

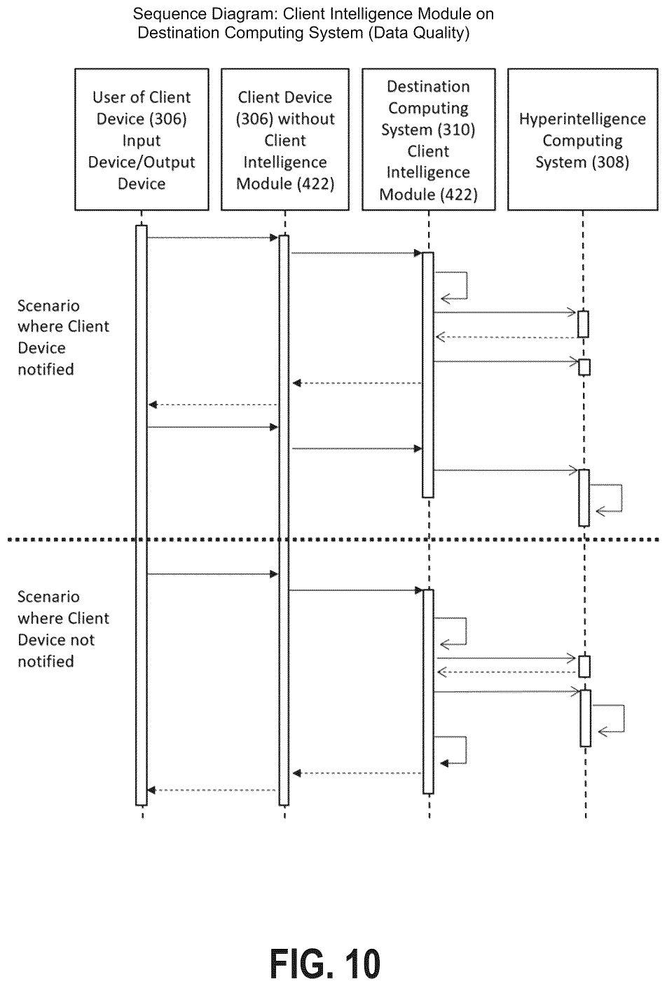

FIG. 10 Illustrates a sequence/state diagram in which client intelligence module 422 is in/on the destination computing system 310. Once again FIG. 10 depicts two scenarios: 1) wherein client device 306 is notified and 2) wherein client device 306 is not notified. The sequence for wherein Client Device 306 is notified is shown on the top half above the dotted line with each arrow from top to bottom as follows:
1. User of one or more source system input/output device(s) submits data to client device;
2. Client device sends data to destination computing system;
3. Destination computing system client intelligence module runs local models;
4. Destination computing system client intelligence module sends data to hyperintelligence computing system;
5. Hyperintelligence computing system runs appropriate models concurrently on nodes and returns results and decisions to destination computing system client intelligence module;
6. Destination computing system client intelligence module calculates final results and decisions and sends final results and decisions to hyperintelligence computing system;
7. In this scenario the final decisions predict an error, so destination computing system client intelligence module sends the prediction to the client device;
8. Client device displays prediction to user via output device;
9. User provides feedback about the prediction;
10. Client device sends feedback to destination computing system client intelligence module;
11. Destination computing system client intelligence module sends feedback to hyperintelligence computing system. In this scenario the feedback confirms the prediction is correct. Alternate path: If feedback confirms the prediction is incorrect then an additional step would be appended after this step wherein destination computing system continues processing the data. (This scenario is described in detail below); and
12. Hyperintelligence computing system learns by rebuilding and distributing models (NOTE: Based on configuration this may require communication with destination computing system data store).

Still referring to FIG. 10, the sequence for wherein client device 306 is not notified is shown on the bottom half below the dotted line with each arrow from top to bottom as follows:
1. User of one or more source system input/output device(s) submits data to client device;
2. Client device sends data to destination computing system;
3. Destination computing system client intelligence module runs local models;
4. Destination computing system client intelligence module sends data to hyperintelligence computing system;
5. Hyperintelligence computing system runs appropriate models concurrently on nodes and returns results and decisions to destination computing system client intelligence module;
6. Destination computing system client intelligence module calculates final results and decisions and sends final results and decisions to hyperintelligence computing system;
7. Hyperintelligence computing system learns by rebuilding and distributing models (NOTE: Based on configuration this may require communication with destination computing system data store);
8. In this scenario the final decisions predict not error, so prediction is not displayed to user. Instead destination computing system client intelligence module allows destination computing system to continue processing the data;
9. Destination computing system sends response to client device; and
10. Client device displays response on output device for user.

### Feedback From User Of Administration System & Real-Time Learning

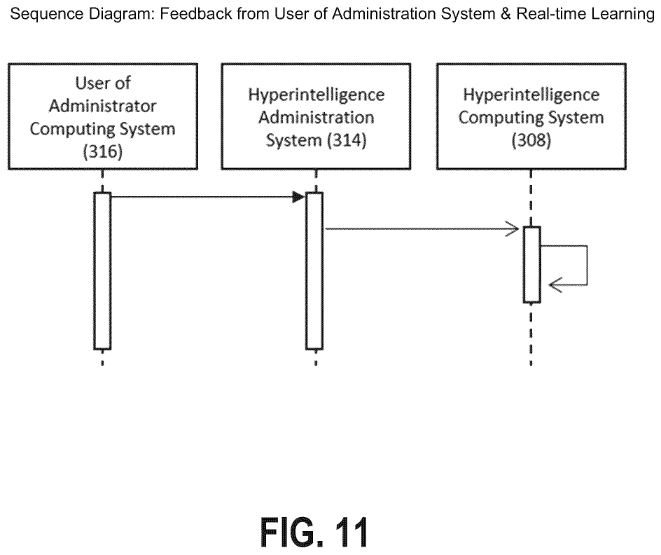

FIG. 11 illustrates a sequence/state diagram in feedback from a user of administrator computing system 316 and real-time learning is executed as follows:
1. User of administrator computing system provides feedback on a prediction to the hyperintelligence administration system;
2. Hyperintelligence administration system sends feedback to hyperintelligence computing system; and
3. Hyperintelligence computing system learns by rebuilding and distributing models (NOTE: Based on configuration this may require communication with destination computing system data store).

### Client Intelligence Module On Client Device

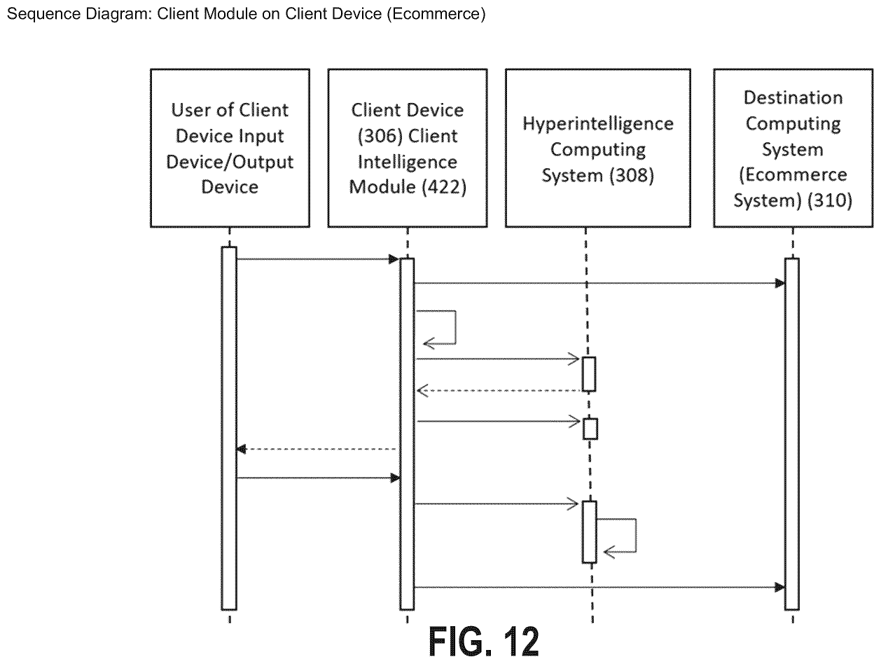

Referring now to FIG. 12, hyperintelligence system 300 ecommerce application/use case will be described. FIG. 12 illustrates a sequence/state diagram in which client intelligence module 422 is in/on client device 306 wherein client device 306 is notified as follows:
1. User of one or more source system input/output device(s) submits addition of item in ecommerce shopping cart to client device;
2. Client device client intelligence sends addition of item in ecommerce shopping cart to destination computing system;
3. Client device client intelligence module runs local models;
4. Client device client intelligence module sends data to hyperintelligence computing system;
5. Hyperintelligence computing system runs appropriate models concurrently on nodes and returns results and decisions to client device client intelligence module;
6. Client device client intelligence module calculates final results and decisions and sends final results and decisions to hyperintelligence computing system;
7. In this scenario the final decisions predict user may also like two more items, so client device displays prediction to user;
8. User provides feedback about the prediction to client device by adding the two items to the ecommerce shopping cart;
9. Client device client intelligence module sends feedback to hyperintelligence computing system. In this scenario the user feedback confirms the prediction is correct since user added both items to shopping cart;
10. Hyperintelligence computing system learns by rebuilding and distributing models (NOTE: Based on configuration this may require communication with destination computing system data store); and
11. Client device client intelligence module sends addition of two items in shopping cart to the destination computing system.

### Intelligence Model(s) Learning & Optimization

Models are trained with data (called training data). This training allows the model to learn and then make sound decisions/predictions (or the best decisions/predictions that the model algorithm can). During the collect feedback phase of the hyperintelligence lifecycle, model performance is tracked by user responses during data in motion inspection and responses from administrators while using the administration server intelligence module to review and provide feedback in the form of labels for hyperintelligence system results. The former responses are called user labels and the latter are called admin labels. Users can be systems or non-human. Labels are feedback about hyperintelligence system results and decisions. When labels are used with training data, this data is referred to as labeled training data. Labels can be provided for all four possibilities of a decision (false negative, false positive, true negative, true positive) but the number of admin labels is expected to be very low because this is a tedious task. It is human nature to identify a wrong result and not confirm a correct result. In the case of false labels, an administrator or user can provide other labels and feedback like the correct value or decision. The goal of learning & optimization is to decrease false positives and negatives while increasing true positives and negatives.

In the case of TYPO (IS A TRADEMARK/SERVICEMARK OF QUATRO CONSULTING LLC), user labels do not provide false negatives because when model predicts that a row is error free then there is no reason to burden the user and inform the user of the decision. User labels only provide false positives. Admin labels provide all four possibilities.

The following assumptions are made to simplify optimization approaches outlined below. Data requirements change overtime; therefore, more recent labels are more accurate than older labels more recent training data will lead to better prediction accuracy than older training data. Neural Networks and genetic algorithms can be used to optimize inputs for a known output, but the first optimization implementations will be simple. The advantage is minimal resource (processors, memory, etc.) usage to enable fastest inclusion of feedback for future model executions.

### Rapid Optimization

Rapid Optimization (also known as Label History Check) is the process of enabling a model to learn from feedback (labels) without the need to rebuild (and retrain) the model. This is achieved by using Label History and checking recent labels prior to executing a model. If a label exists that substantially matches the current row being processed, then the appropriate decision and/or results for the label is returned. Otherwise, execute the model. Label data includes the entire row of data to which a label applies. Labels can be for one cell, a set of cells or the entire row. The aforementioned are the three label levels. The same cell, cell set, or row could be used in multiple labels. Labels that exceed a label expiration time will not be included in Rapid Optimization. Default Label Selection Logic (see Default Label Selection Logic section below) includes logic used to match a row under processing to a previous row that has labels. The default logic compares the value of every column except any unique key columns in the row under processing to each row with labels. Since this matching logic is expected to be the most commonly used matching logic, upon the creation of labels, a hash (called the Default Row Hash) will be created and saved to the Datastore Service and/or cache. During interception of data in motion or scanning of data at rest, a Default Row Hash for the row under processing will be created and saved to the Datastore Service (and/or cache) if it does not already exist in the case of scanning data at rest. Then Default Row Hash for the row under processing is compared to existing Default Row Hashes of rows with labels. There are two levels of Rapid Optimization. The first is row level which is executed first and only uses row level labels. The second is model level which uses cell and cell set labels. If the row level Rapid Optimization returns a decision, then there is no need to execute the model level Rapid Optimization which returns a result.

The distinction between a decision and result is important. Users see and respond to decisions with feedback. A result is the output from running a model. One or more model results of the same model type are used to calculate a final result for the model type. Then the final result is used to make a decision. The hyperintelligence system must save each model result, the final result, and the decision. In many cases the final result and the decision will be the same. Cases where they are different must be considered and supported. The hyperintelligence system must support a decision plan which defines workflow that is controlled by the results of models, the final result and/or decision. In a decision plan the results of models, the final results and/or decisions are used to choose the next set of models to execute. The workflow continues until a terminating decision is reached. The results of models, the final results and/or decisions must be used as input for the next set of models and/or behavior in the workflow.

Consider the case of TYPO (IS A TRADEMARK/SERVICEMARK OF QUATRO CONSULTING LLC), where the result type (see Model Type Template Properties section) of predictor-error model type is probability. Therefore, the models return a result in the range of 0-1. Then the final result is computed with a weighted averaging algorithm with all model results as input to the algorithm. The final result is compared to a threshold to decide if the input data to the model is an error or not an error. When performing row level Rapid Optimization, the decision is returned. Attempting to return the final result from the label and then performing the current decision logic is a flawed approach because the current decision logic might be different from the decision logic that was used at the time the labeled row was processed. For model level Rapid Optimization, a result needs to be returned because the weighted averaging is necessary to reach a final decision. For all result types, the final result produced from weighted averaging is assumed by the Default Rapid Optimization Logic to be the decision.

Rapid Optimization Logic is customizable by a platform user and by model type. In the case of TYPO (IS A TRADEMARK/SERVICEMARK OF QUATRO CONSULTING LLC) customization is needed. A modified result is returned from model level Rapid Optimization. The result type is probability and the result is modified because a label has removed all uncertainty about the input data. There is no probability to consider because the label has provided the result. So, the result returned by the model level Rapid Optimization should be either 0 or 1.

The steps for the default Rapid Optimization Logic are:
1. Run Label Selection Logic—see Default Label Selection Logic section; and
2. Run Result Generation Logic—this determines the result based on all the labels that matched. See Default Result Generation Logic.

### Model Optimization

Model Optimization includes changes to Model Configuration via changes to Model Template such as:
1. Training Data—which data is selected including labels (see Default Label Selection Logic). The data selected for training will typically change due to the addition or change of data in the dataset. The addition or change can be the same data that was intercepted. The addition or change may be made to a customer database. This will typically cause the data selected for training to change. The Model Template Properties determine what data is selected;
2. Build Configuration-changes to input parameters to the training functions of the algorithm and/or changes to build_params and build_logic Model Template properties; and
3. Runtime Configuration-changes to input parameters to execute the model.

### Weight Optimization

Weight Optimization is changes to model weights (Model Level) or changes to how the final decision (or result) is calculated from multiple models (Aggregate Level). See Weighted Averaging Algorithm section for details about creating a final decision.

### Default Label Selection Logic

The default queries for labeled data which is used by Rapid Optimization and Model Optimization are outlined in this section. It is common for a dataset to have multiple audits (or point in time scans of data at rest) with labels in each audit. Therefore, it is possible for the same row in the dataset to have conflicting labels (at the row, column or column set level) in multiple audits. It is possible for the same row in a dataset to have labels for different result types from different model types.

### The Default Label Selection Logic

1. Query for labeled data for the matching rows where Default Row Hash of row under processing equals the Default Row Hash saved in the Datastore Service (and/or cache) and (current date in milliseconds-update date of label in milliseconds)<value of ConfigurationService key labelExpirationMillis. Then sort by update date in descending order. Note: Since data requirements change over time, this will allow current data requirements to apply in models.
2. Create an empty Map (like java.util.Map interface) for model types called modelTypeLabelMap. Note: Other Maps, Label Maps, will be created for each model type. The Label Map will hold the selected labels for a specific model type. Then the Label Map is used as a value entry in the modelTypeLabelMap.
3. For each label record in query results:
   a. Create a Map keys based on the level of the label and the model type. Key for the modelTypeLabelMap will be the model type (see type attribute of the Model Template Properties section). The key for the Label Map will be column name for column level, set of column names appended in alphabetical order with delimiter of “%” for column set level, or “row” for row level label. Check if key for modelTypeLabelMap exists in modelTypeLabelMap.
      i. If no, then create new Label Map. Add entry with label (which includes all data in row and the results of all model decisions for this row with key, for Label Map that was created in Step a. above, to the Label Map. Add the Label Map to the modelTypeLabelMap with the appropriate key for the model type that was created in Step a. above. Continue to next label record.
      ii. Otherwise, use key for modelTypeLabelMap, that was created in Step a. above, to retrieve Label Map from modelTypeLabelMap. Check if key for Label Map, that was created in Step a. above, exists in Label Map. If no, add label (which includes all data in row and the results of all model decisions for this row) with key to the Label Map. (Note: This Logic assumes a runtime of java and the Label Map is modified by a reference or pointer which does not require the Label Map entry in the modelTypeLabelMap to be overwritten or updated separately. Other programming languages and runtimes may require the Label Map entry in the modelTypeLabelMap to be overwritten or updated separately.)

For performance enhancement, the Maps may be stored in a cache for faster lookup. Cache will be updated as soon as possible when labels are added, edited or deleted.

Decisions made by the hyperintelligence system may require multiple models of different result types (see type property in Model Template Properties section). A decision may be a binary classification or a predicted continuous value like the temperature tomorrow. Labeled data may or may not include feedback which provides the correct decision. Labeled data may only provide feedback that the decision was accurate or inaccurate. When a label only provides feedback that a decision is inaccurate and no other feedback, then the best that the Default Result Generation Logic can provide is a result that says “not X” where X is the inaccurate decision. In the case where the decision is a binary classification, then result can be determined. Since it is “not X” then is must be the other classifier.

### The Default Result Generation Logic

1. Check parameters to determine if the Rapid Optimization is Row Level Rapid Optimization. If no, then continue to step 2 below. If yes, then query modelTypeLabelMap created by Label Selection Logic with a key equal to the model type parameter. If Label Map not found, return null. Note: Parameters to Rapid Optimization include level of rapid optimization, model type and set of one or more column names.
   a. Query Label Map with key “row”. If label not found, then return null and end processing.
   b. Otherwise,
      i. If label indicates an accurate decision, then return the decision from the label data.
      ii. Else if the label indicates an inaccurate decision and a correction is available, then return the correction.
      iii. Else if the label indicates an inaccurate decision and model type is equal to binary-classification, then return the other decision (not the inaccurate decision) classifier. Other decision classifier can be found by querying the model type object from the Datastore Service or cache.
      iv. Else return null.
2. Otherwise, perform model level Rapid Optimization result generation
   a. Query modelTypeLabelMap created by Label Selection Logic with a key equal to the model type parameter. If Label Map not found, then return null. Note: Parameters to Rapid Optimization include level of rapid optimization, model type and set of one or more column names.
   b. Create Label Map key from Rapid Optimization parameters by alphabetically sorting set of column names and then appending each column name in alphabetical order with a delimiter of “%”. Key should not have the delimiter at the end. “%” may be at the end of the key if the last column name ends with “%”.
   c. Query Label Map with key. If no label found, then return null. Otherwise,
      i. If label indicates an accurate result, then return the result from the label data.
      ii. Else if the label indicates an inaccurate result and a correction is available, then return the correction.
      iii. Else if the label indicates an inaccurate result and model type is equal to binary-classification, then return the other result (not the inaccurate decision) classification. The other result classification can be found by querying the model type object from the Datastore Service or cache.
      iv. Else return null.

### Weighted Averaging Algorithm

Weighted Averaging Algorithm (WAA) packages are built, versioned and deployed to a repository as an algorithm package. WAAs are customizable by platform users. Weighted Averaging Algorithms may use generative AI or generative AI may create new weighted averaging algorithm based on feedback. Anytime new feedback is provided, or feedback is processed the hyperintelligence system may update the weighted averaging algorithm in use. The Configuration Service may store a property with the key of generate WeightedAveragingAlgorithm to enable this feature. The logic to determine if the weighted averaging algorithm should be updated is configurable and stored by the Configuration Service. The default logic to determine if a new weighted averaging algorithm should be generated will: 1) query the Datastore Service for model results and final prediction or decision results for a time range that is configured in the Configuration Service, 2) compare the accuracy of the individual model results to the accuracy of the final prediction or decision produced by the weighted averaging algorithm, 3) if the average accuracy of the individual model results exceeds the accuracy of the final prediction or decision produced by the weighted averaging algorithm by a threshold that is configured in the Configuration Service, then the weighted averaging algorithm is generated and deployed. The term “weighted averaging algorithm” is considered to include an algorithm that does not perform averaging to produce a final prediction or decision. The system or users of the hyperintelligence system may prompt a foundation model, LLM, or other model to create and then deploy a weighted averaging algorithm. This can be achieved by providing any data, results, feedback, or inputted information stored in the hyperintelligence system, such as existing WAA packages, algorithm packages, descriptions, documentation, configuration, or information created by the Prepare Model Build DAG, to a foundation model, LLM or other model. Then the hyperintelligence system may engineer multiple prompts to create many WAAs, engineer multiple prompts to create tests of the WAAs, run tests of newly generated WAAs and any existing WAAs with labeled data or known results/decisions of inputted information or input data, track the accuracy of each WAA during testing, and deploy the most accurate WAA.

### Default Weighted Averaging Algorithm for Binary Classification and Multi-class Classification Return Types

Below is the default weighted averaging algorithm for binary-classification and multi-class-classification return types in Java pseudo code. Other code implementations may achieve the same or similar behavior.

Assumes set of n items of the same Model Type and return_type (see Model Type Template Properties section). Each item has model unique identifier (modelId), model result (rₙ) and model weight (wₙ), where 0<=wₙ<=1 and where In is one of multiple possible values. For binary-classification return types, rₙ is one of two possible values. For multi-class-classification return types, rₙ is one of three or more possible values.

```
import java.util.*;
Map<String, Collection<Double>> weightedVoteMap = new HashMap<String,
Collection<Double>>( );
double defaultMinWeight = Double.parseDouble(ConfigurationService.get(“defaultMinWeight”,
“0”, tenantId, repositoryName, datasetName));
for (int i = 0; i < items.length; i++) {
  double defaultMinWeightModel = ConfigurationService.get(“defaultMinWeight.” +
items[i].modelId, defaultMinWeight, tenantId, repositoryName, datasetName);
  if (defaultMinWeightModel <= items[i].weight) {
    Collection<Double> weights = weightedVoteMap.get(items[i].result);
    if (weights == null) {
      weights = new ArrayList<Double>( );
      weightedVoteMap.put(items[i].result, weights);
    }
    weights.add((Double) items[i].weight);
  }
}
Double highestAverage = null;
String selectedClass = null;
Iterator entrySetIterator = weightedVoteMap.entrySet( ).iterator( );
while (entrySetIterator.hasNext( )) {
  Map.Entry pair = (Map.Entry) entrySetIterator.next( );
  // average the weights for each class then find highest average
  Collection<Double> weights = (Collection<Double>) pair.getValue( );
  Iterator weightsIterator = weights.iterator( );
  double weightSum = 0;
  int counter = 0
  while (weightsIterator.hasNext( ) {
    weightSum += ((Double) weightsIterator.next( )).doubleValue( );
    counter++;
  }
  double average = (counter != 0 ? weightSum/counter : 0);
  if (highestAverage == null || highestAverage.doubleValue( ) < average) {
    // note in case of tie for highest average the first class
// set is the class returned
    highestAverage = new Double(average);
    selectedClass = (String) pair.getKey( );
  }
}
return selectedClass;
```

### Default Weighted Averaging Algorithm for Multi-label Classification Return Types

Below is the default weighted averaging algorithm for multi-label-classification return types in Java pseudo code. Other code implementations may achieve the same or similar behavior.

Assumes set of n items of the same Model Type and return_type (see Model Type Template Properties section). Each item has model unique identifier (modelId), model result (rₙ) and model weight (wₙ), where 0<=wₙ<=1 and where In is an array of one or more of multiple possible values.

```
import java.util.*;
Map<String, Collection<Double>> weightedVoteMap = new HashMap<String,
Collection<Double>>( );
double defaultMinWeight = Double.parseDouble(ConfigurationService.get(“defaultMinWeight”,
“0”, tenantId, repositoryName, datasetName));
for (int i = 0; i < items.length; i++) {
  double defaultMinWeightModel = ConfigurationService.get(“defaultMinWeight.” +
items[i].modelId, defaultMinWeight, tenantId, repositoryName, datasetName);
  if (defaultMinWeightModel <= items[i].weight) {
    for (int j = 0; i < items[i].result.length; j++) {
      Collection<Double> weights = weightedVoteMap.get(items[i].result[j]);
      if (weights == null) {
        weights = new ArrayList<Double>( );
        weightedVoteMap.put(items[i].result[j], weights);
      }
      weights.add((Double) items[i].weight);
    }
  }
}
double defaultMultiLabelDiscriminationThreshold =
Double.parseDouble(ConfigurationService.get(“defaultMultiLabelDiscriminationThreshold ”,
“0.5”, tenantId, repositoryName, datasetName));
Collection<String> classes = new ArrayList<String>( );
Iterator entrySetIterator = weightedVoteMap.entrySet( ).iterator( );
while (entrySetIterator.hasNext( )) {
  Map.Entry pair = (Map.Entry) entrySetIterator.next( );
  // average the weights for each class then compare average to threshold
  Collection<Double> weights = (Collection<Double>) pair.getValue( );
  Iterator weightsIterator = weights.iterator( );
  double weightSum = 0;
  int counter = 0
  while (weightsIterator.hasNext( ) {
    weightSum += ((Double) weightsIterator.next( )).doubleValue( );
    counter++;
  }
  double average = (counter != 0 ? weightSum/counter : 0);
  if (defaultMultiLabelDiscriminationThreshold <= average) {
    classes.add((String) pair.getKey( ));
  }
}
return classes;
```

### Default Weighted Averaging Algorithm for Probability and Continuous Return Types

Below is the default weighted averaging algorithm for probability and continuous return types in Java pseudo code. Other code implementations may achieve the same or similar behavior.

Assumes set of n items of the same Model Type and return_type (see Model Type Template Properties section). Each item has model unique identifier (modelId), model result (rₙ) and model weight (wₙ), where 0<=wₙ<=1 and where, for probability return types, 0<=rₙ<=1.

```
double resultProductSum = 0;
int counter = 0;
double defaultMinWeight = Double.parseDouble(ConfigurationService.get(“defaultMinWeight”,
“0”, tenantId, repositoryName, datasetName));
for (int i = 0; i < items.length; i++) {
  double defaultMinWeightModel =
Double.parseDouble(ConfigurationService.get(“defaultMinWeight.” + items[i].modelId,
defaultMinWeight, tenantId, repositoryName, datasetName));
  if (defaultMinWeightModel <= items[i].weight) {
    counter++;
    resultProductSum += (items[i].weight * items[i].result);
  }
}
return (counter != 0 ? resultProductSum/counter : 0);
```

### Directed Acyclic Graphs

The directed acyclic graphs (DAGs) detailed in this section show stages that must be completed before starting the next stage. Stages at the same indention (or hierarchy) will run concurrently. Details of stages are provided in subsections matching the stage name under the Model Build Lifecycle for Dataset section.

Execute Predictor Model for Data at Rest DAG has steps that are detailed in Scanning of Data at Rest section below.

Execute Predictor Model for Data in Motion DAG has steps that are detailed in Real-time Interception of Data in Motion section below.

The Build phase of the lifecycle is composed of two DAGs, Prepare Model Build DAG and either Build Predictor Model DAG or Build Profiler Model DAG. Upon completion of the Build phase, models are built and available in the Model Storage Service for use during the Execute phase. A Profiler Model is a model that provides one or more data profile metrics as output. A Predictor Model is a model that is directly used to make decisions. Metrics are included in the Data Profile which are used by Predictor Models. In addition to the default set of metrics discussed below, custom metrics can be created by a user. A Profiler Model enables a user to add custom metrics to the Data Profile. Custom metrics (including calculation algorithm) created by user. Custom Profiler Model package is versioned and deployable to the Model Storage Service. Profiler Model is executed by Workers like Predictor Model execution.

The hyperintelligence system will provide these default Data Profile metrics:
1. Normality metrics-provided from a Shapiro-Wilk test on all dataset types. Shapiro-Wilk test is detailed in “An analysis of variance test for normality (complete samples)” by Shapiro, S. S.; Wilk, M. B. and published in 1965.
2. Correlation coefficients matrix-created by computing the Pearson correlation coefficient (https://en.wikipedia.org/wiki/Pearson_correlation_coefficient) for each possible numeric pair of columns in the dataset.
   a. Compute the correlation matrix for each dataset type
   b. Mark the pairs of columns that are correlated based on a configured correlation minimum threshold (default of 0.98)
3. Deep Feature Synthesis-Create the metrics detailed below by running Deep Feature Synthesis, as described in “Deep Feature Synthesis: Towards Automating Data Science Endeavors” by James Max Kanter and Kalyan Veeramachaneni, for each dataset type.
   a. Minimum value of each numeric column
   b. Maximum value of each numeric column
   c. Average value of each numeric column

For detailed steps in the Execute Profiler Model DAG see Data Profile subsection of the Prepare Model Build subsection in the Model Build Lifecycle for Dataset section.

Data Preprocessing Logic and the Prepare Data and Test & Optimize Model steps of the Build Predictor Model DAG and Build Profiler Model DAG may use LLMs and generative AI for a multitude of purposes including but not limited to generating and analyzing synthetic data, metadata, data profiles, and data stored in the hyperintelligence system.

Schema Inference and the creation of the Relationship Configurations, Data Subset Configurations, Join Configurations, and Data Profiles in the Prepare Model Build DAG may be performed by generative AI.

### Prepare Model Build DAG

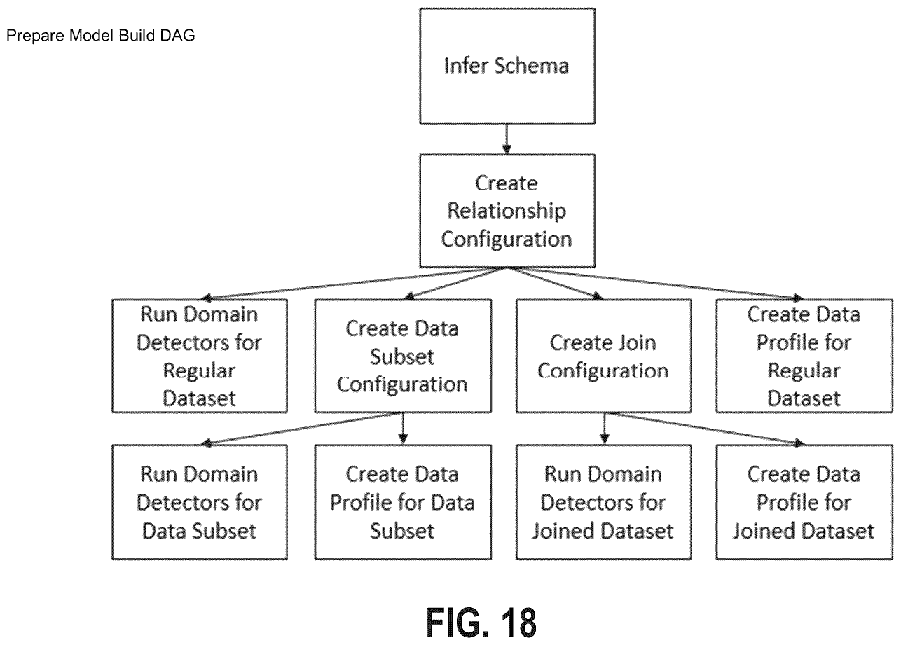

Refer now to the flow chart in FIG. 18 for the Prepare Model Build DAG.

### Stages:

Infer Schema (see Schema Inference subsection of the Prepare Model Build subsection in the Model Build Lifecycle for Dataset section)
   Create Relationship Configuration (see Relationship Configuration subsection of the Prepare Model Build subsection in the Model Build Lifecycle for Dataset section).
      Run Domain Detectors for Regular Dataset (see Data Domain Detection subsection of the Prepare Model Build subsection in the Model Build Lifecycle for Dataset section)
      Create Data Subset Configuration (see Data Subset Configuration subsection of the Prepare Model Build subsection in the Model Build Lifecycle for Dataset section).
         Run Domain Detectors for Regular Dataset (see Data Domain Detection subsection of the Prepare Model Build subsection in the Model Build Lifecycle for Dataset section).
         Create Data Profile for Data Subset (see Data Profile subsection of the Prepare Model Build subsection in the Model Build Lifecycle for Dataset section).
      Create Join Configuration (optional) (see Join Configuration subsection of the Prepare Model Build subsection in the Model Build Lifecycle for Dataset section).
         Run Domain Detectors for Joined Dataset (see Data Domain Detection subsection of the Prepare Model Build subsection in the Model Build Lifecycle for Dataset section)
         Create Data Profile for Joined Dataset (see Data Profile subsection of the Prepare Model Build subsection in the Model Build Lifecycle for Dataset section).
      Create Data Profile for Regular Dataset (see Data Profile subsection of the Prepare Model Build subsection in the Model Build Lifecycle for Dataset section)

### Build Predictor Model DAG

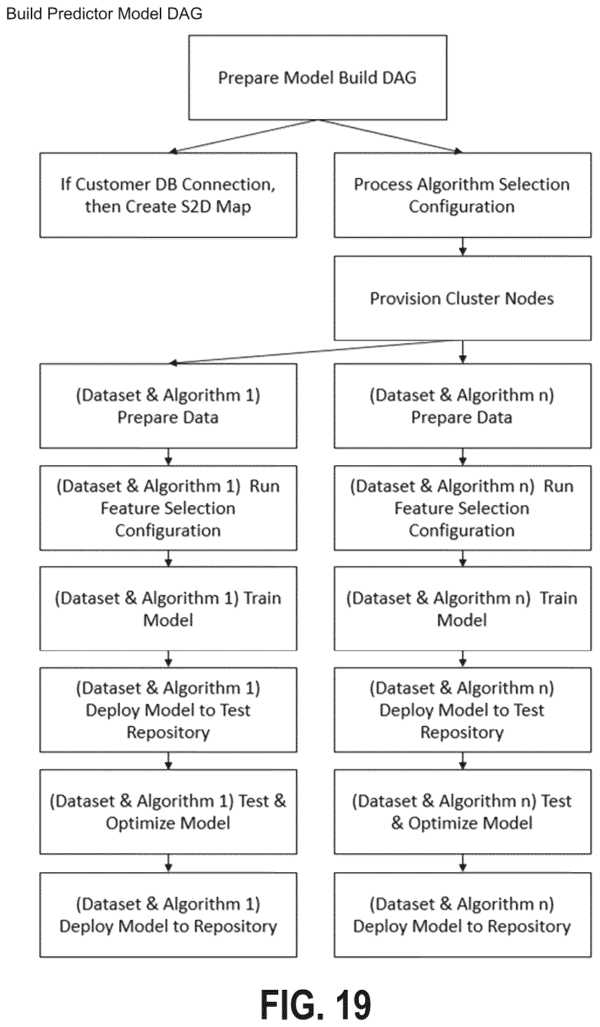

Refer now to the flow chart in FIG. 19.

### Stages:

Prepare Model Build DAG
   Process Algorithm Selection Configuration (see Process Algorithm Selection Configuration subsection of the Build Predictor Models subsection in the Model Build Lifecycle for Dataset section)
      Steps 3-6 in Build Predictor Models subsection of Model Build Lifecycle for Dataset section

### Build Profiler Model DAG

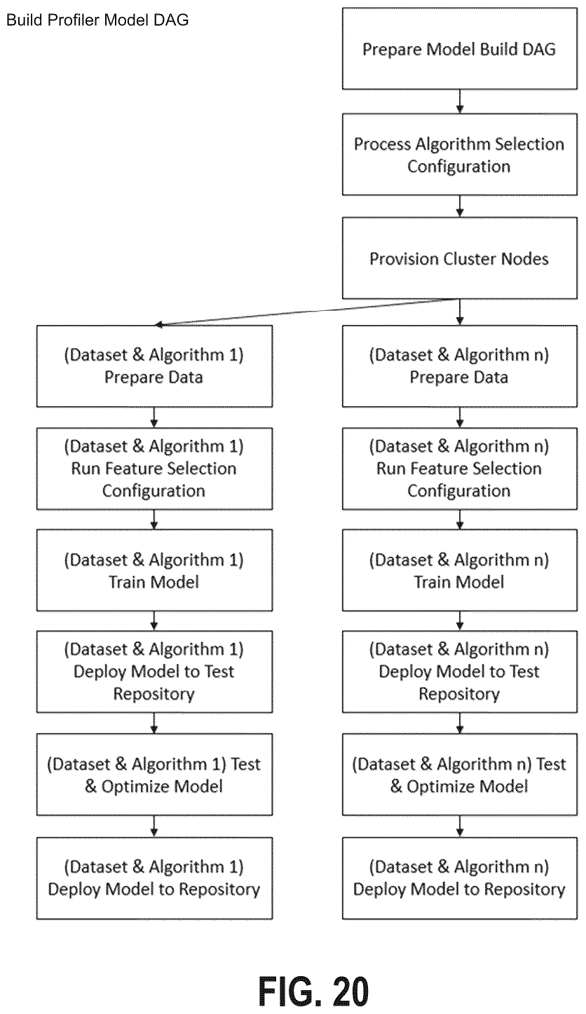

Refer now to the flow chart in FIG. 20.

### Stages:

Prepare Model Build DAG
   Process Algorithm Selection Configuration (see Process Algorithm Selection Configuration subsection of the Build Profiler Models subsection in the Model Build Lifecycle for Dataset section)
      Steps 3-6 in Build Profiler Models subsection of Model Build Lifecycle for Dataset section

### Decision Logic

Decision Logic is used to provide a final decision from multiple model results of the same model type. Input to Decision Logic is the final result of the weighted average algorithm and results of all models executed with a model type that matches the model type for this Decision Logic. Decision Logic provides model output as a decision. Decision Logic is included in the Model Type package (see Template & Configurations section). Decision Logic is written in different programming languages to support different runtimes. The Intelligence Module will choose the Decision Logic to execute based on the runtime of the Intelligence Module. Decision Logic is customizable by a customer or user.

The result_type property of the Model Type Template determines the return value that should be returned. Default Decision Logic varies based on return type. Below is a summary of return types and the expected return values:

| Return Type | Return Value | Default Decision Logic Return Value |
|---|---|---|
| binary- | One of two classes | Class with the highest weighted average score |
| classification | | from individual classifiers (the models with |
| | | return_type of binary-classification) |
| multi-class- | One of many classes | Class with the highest weighted average score |
| classification | | from individual classifiers (the models with |
| | | return_type of multi-class-classification) |
| multi-label- | One or more of | List of classes. List is created with a voting |
| classification | many classes | scheme where every class from individual |
| | | classifiers (the models with return_type of |
| | | multi-label-classification) that receives a |
| | | weighted average percentage of votes greater |
| | | than the value of ConfigurationService key |
| | | defaultMultiLabelDiscriminationThreshold is |
| | | added to the list of classes returned. |
| probability | Range of 0-1 | Weighted average probability of all model |
| | | probabilities |
| continuous | No restrictions. | Collection of all model results |
| | Any value | |
| multi-modal | No restrictions. | Collection of all model results |
| | Any value | |
| any | No restrictions. | Collection of all model results |
| | Any value | |
| audio | Audio file | Collection of all model results |
| video | Video file | Collection of all model results |
| image | Image file | Collection of all model results |
| 3d | Three-dimensional | Collection of all model results |
| | file | |
| multidimensional | Multidimensional | Collection of all model results |
| | file | |
| vector | Vector data | Collection of all model results |
| | structure | |
| bci-signal | Byte array | Collection of all model results |
| uri | Uniform resource | Collection of all model results |
| | identifier (URI) | |

In the case of TYPO (is a trademark/servicemark of Quatro Consulting LLC), the return type is probability and the decision is either error or not error. The TYPO (is a trademark/servicemark of Quatro Consulting LLC) decision is made by comparing the final result of the weighted average algorithm to a threshold probability value which was queried from the ConfigurationService. If the final result is greater than the threshold, then the decision is error. Otherwise, the decision is not error (also known as ok).

### Data Preprocessing Logic

Structured information is comprised of clearly defined data types whose pattern makes them easily searchable. Relational database management systems store structured information. Unstructured information is comprised of data that is usually not as easily searchable, including formats like audio, video, and free form text. Data Preprocessing Logic is logic that is provided by a user to preprocess the data prior to sending it through further processing, analysis and use in models. Processing unstructured data into structured data that can be easily used by the hyperintelligence system is a common use for Data Preprocessing Logic. Data Preprocessing Logic can be used at the model build phase or the execute phase of the lifecycle.

### Security

There are security concerns for any scenario where a customer or other external entity is providing code. The code could contain malicious actions that attempt to do things like access the OS, filesystem or another tenant's data. The code could attempt unauthorized behavior or attempt to crash the Hyperintelligence Computing System, Nodes, Server Intelligence Module, Client Intelligence Module, Client Device, one or more Networks or other component in the hyperintelligence system. Malicious and unauthorized behavior includes attempting to read any data from the cluster DB, read/write on the cluster filesystem, etc. Security settings will be managed with the Hyperintelligence Administration System by Administrator Computing System or Administration Client Intelligence Module.

Security Checks and Requirements:
All code/packages provided by customers/tenants must be digitally signed via code signing to confirm the software author and guarantee that the code has not been altered or corrupted since it was signed. Code signing uses a cryptographic hash to validate authenticity and integrity of code/packages provided by customers. Most code signing implementations will provide a digital signature mechanism to verify the identity of the author or publisher, and a checksum to verify that the code/package has not been modified. Code signing can also provide versioning information or other meta data about an object, code, and/or package. Code signing is based on public key infrastructure (PKI) technologies. A customer will sign code/packages with a private key. Then customer will provide the public key to the hyperintelligence system which will use the public key to verify authenticity of publisher and verify that the code/package has not been modified since signing. The integrity of the PKI system relies on publishers securing their private keys against unauthorized access. The public key used to authenticate the code signature should be linked to a trusted root certification authority (CA), preferably using a secure public key infrastructure (PKI). Code signing does not ensure that the code itself can be trusted. It provides a system to confirm what private key was used to sign the code and therefore who the code is from based on the entity named in the private key. A CA provides a root trust level and is able to assign trust to others by proxy. If a user/system trusts a CA, then the user/system can presumably trust the legitimacy of code that is signed with a key generated by that CA or one of its proxies. The hyperintelligence system shall trust certificates and keys generated by Entrust Datacard, VeriSign/Symantec, DigiCert, Comodo, GoDaddy and GlobalSign.
Check that code/package is authentic and from a known publisher. Tenant build packages must be signed with private key held by the tenant. Public key will be uploaded to Hyperintelligence Administration System by Administrator Computing System or Administration Client Intelligence Module. Public key viewable in Hyperintelligence Administration System.
Check that code/package has not been altered after code signing. Tenant builds packages must be signed with private key held by the tenant.
Platform user may select the use of either 1) a whitelist of approved publishers of code or 2) a blacklist of unapproved publishers of code. If using whitelist, then only code or packages published by publishers on the whitelist will be allowed to execute. If using blacklist, then only code or packages published by publishers on the blacklist will be blocked from execution and/or download.
For any tenant/customer using custom code, isolated tenancy is required. Isolated tenancy is a deployment where a tenant has its own separate infrastructure including but not limited to clusters, data stores, databases, and networks. This is necessary because code signing does not ensure the code can be trusted or that the code is free of bugs and defects.
When accessing any model or service hosted by a third party or accessing any model or service over a network connection, the access should be secured with industry best practices. This includes but is not limited to implementing HTTPS (Hypertext Transfer Protocol Secure) to encrypt communication between clients and servers, utilizing TLS (Transport Layer Security) protocols to ensure secure data transmission, implementing robust authentication mechanisms such as multi-factor authentication (MFA) and OAuth, enforcing strong authorization controls to restrict access to sensitive resources based on user roles and permissions, adopting zero-trust security models that assume no trust between any systems or components by default and verify every access request.
Inter-process communication (IPC) is a mechanism that allows processes to exchange data and signals with each other. This exchange can occur both within the same computer system (between processes running on the same operating system) or across different systems connected through a network. The primary goal of IPC is to enable collaboration and data sharing between processes to achieve a common objective, thereby facilitating the modularization of complex software systems into more manageable, isolated components. IPC is critical for building distributed systems, multitasking operating systems, and applications that require interaction between separate software modules. When accessing any model, service, or process over inter-process communication. The flow of data or requests from a source process to a destination process is prohibited if the source process does not have authorization that meets or exceeds the authorization of the destination process. For example, if a destination process is running with the authorization of an administrator and the source process that is attempting to send data is not running as an administrator or has not elevated to an administrator and is running with standard, the authorization, then IPC will be denied.

### Configuration Service

The Configuration Service is a key-value store with hyperintelligence system configuration information. It will use the Datastore Service and/or cache on the hyperintelligence computing system. The configuration information can be visualized as a tree. See below:

```
Root (Global key-values)
  | - maxPredictionTimeMillis=300
  | - workerTimePercent=0.75
  Tenant (id=101)
    | - maxPredictionTimeMillis=400
    Repository (name=”hyintel-test”)
      | - maxPredictionTimeMillis=500
      Dataset (name=”shuttle-demo”)
        | - maxPredictionTimeMillis=200
  Tenant (id=102)
    | - maxPredictionTimeMillis=700
    Repository (name=”finance”)
      | - maxPredictionTimeMillis=500
      Dataset (name=”invoice”)
        | - maxPredictionTimeMillis=100
      Dataset (name=”purchase-order”)
        | - maxPredictionTimeMillis=800
```

Configuration Service will have the following interfaces ConfigurationService.set (key, value, tenantId, repositoryName, datasetName) ConfigurationService.get (key, defaultValue, tenantId, repositoryName, datasetName) The get logic is:
1. If key null, throw exception with message “Key parameter cannot be null.”
2. If datasetName does not equal null AND repository does not equal null AND tenantId does not equal null, search tree for node of/tenantId=tenantIdParam/repositoryName=repositoryNameParam/datasetName=datasetNameParam. If node does not exist, continue to next step. Otherwise search node for key. If key found then return value, otherwise continue to next step.
3. If repository does not equal null AND tenantId does not equal null, search tree for node of/tenantId=tenantIdParam/repositoryName=repositoryNameParam. If node does not exist, continue to next step. Otherwise search node for key. If key found then return value, otherwise continue to next step.
4. If tenantId does not equal null, search tree for node of/tenantId=tenantIdParam. If node does not exist, continue to next step. Otherwise search node for key. If key found then return value, otherwise continue to next step.
5. Search root node for key. If key found then return value, otherwise return default Value parameter value.

### Potential Scenarios for Automated Analysis

1. Real-time interception of data in motion without connection to Customer database (DB): Intercept data and save to data store (Stream of data from client intercepting data, Talend component, Singer tap, etc). as a dataset. Dataset name is determined by the Client Intelligence Module or Server Intelligence Module.
2. Real-time interception of data in motion with connection to Customer DB: Intercept and use source to destination (S2D) map that provides mapping of each data field in the intercepted data to a field in the customer DB. Ability to create connection to customer DB is provided by Administration Server Intelligence Module via REST API that is used by Administration Client Intelligence Module.
3. Scanning of data at rest with connection to customer DB-Directly read customer DB for point in time (batch) audit.
   For all the potential scenarios above, if the row count of the dataset exceeds a configured minimum row count (check needed to ensure hyperintelligence system can provide statically significant results) then proceed with Steps for Automated Analysis detailed below.

### Edge Cases for Automated Analysis

What happens when customer DB schema changes (delete column, add column, rename column, normalize, denormalize, rename table, etc.)?

For audits of live connections or imported/intercepted data, a full scan is done. The concern is labeled data when changes have occurred to the data model. Labeled data form an old schema should be used when a column is deleted. If a column is added, then labeled data cannot be used for models that require the column. A renamed column will be detected as a delete and new column. Data in motion with customer DB: The concern is labeled data when changes have occurred to the data model. Labeled data form an old schema should be used when a column is deleted. If a column is added, then labeled data cannot be used for models that require the column. A renamed column will be detected as a delete and new column. When displaying results, deleted columns will be shown and if values are available, they are shown, otherwise the cell is empty. During model build, only data from the customer DB and labeled data as previously described can be used.

NOTE: Keep a copy of the schema for comparing between audit runs.
What happens when the schema of intercepted data changes (delete column, add column, rename column)?

In the case of data in motion and no customer DB, the concern is labeled data when changes have occurred to the data model. Labeled data from an old schema should be used when a column is deleted. If a column is added, then labeled data cannot be used for models that require the column. A renamed column will be detected as a delete and new column. When displaying results, deleted columns will be shown and if values are available, they are shown, otherwise the cell is empty. During model build, only data from newest schema and labeled data as previously described can be used.

### Model Build Lifecycle for Dataset

### Prepare Model Build

### Schema Inference

Query model template. If available, run the run_before_build step from the build_logic property. Then if available, run the validate_build_params step from the build_logic property.

When customer database connection provided, create Source to Destination (S2D) Map by asynchronously mapping intercepted data fields to the customer database fields and saving to Datastore Service. The S2D Map maybe created by fine-tuning with or providing to a foundation model, LLM, or other model the intercepted data fields, inputted information, and schema of the customer database as queried from the customer database. Then prompt the foundation model, LLM, or other model to create the S2D Map. Once created the system may prompt the foundation model, LLM, or other model to create test data fields and inputted information and then test the mapping to ensure successful linkage of the data fields and inputted information to the customer database by creating a test tables in the customer database with the same schema as the actual tables and then inserting and updating in the test table. Finally drop the test table to cleanup all testing data.

Tests would include attempting to store previously provided inputted information to the test table. Any attempt to store the previously provided inputted information that fails due to data type or schema related problems is considered a test failure.

If the tests fail then the foundation model, LLM, or other model can be provided with additional prompts that include the fails and a request to create a new or different S2D Map. At this point the testing would repeat, and a test counter would be incremented. If additional test failure then the process would repeat until a configured test count threshold is reached. If threshold reached then the hyperintelligence system can notify a user of the Hyperintelligence Administration System 314 that a S2D Map needs to be created.

Consider the scenario where client device not notified in FIG. 7. In this scenario where client device 306 intercepts inputted information with a destination of destination computing system 310. Consider that the client device is running a web browser that is accessing a web application with a web form that allows inputted information submission by the user of client device 306. The destination computing system may a have one or more schemas for storing, updating, deleting and/or reading the inputted information in the data store 206. An algorithm package may be deployed to the hyperintelligence system that creates a S2D Map by querying the schema information from the destination computing system 310, then prompt the foundation model, LLM, or other model to create the S2D map in a desired format such as a table or JavaScript Object Notation. The prompt would include the schema information, intercepted inputted information including field names and field values, the source of the inputted information such as URL of web form, the World Wide Web Consortium document object model of the web page at the time of submission, the HTML of the web page, the HTML page name, HTML form tag id and name attributes of the submitting form, and HTTP method, payload, and headers. An example of a S2D Map is provided below:

| | | | Destination |
|---|---|---|---|
| Source | Source Field | Destination | Data Type |
| https://www.typo.ai/customer | query_string.name | postgresql://db01:5432/crm\|public.customer.name | varchar(255) |
| https://www.typo.ai/customer | query_string.date | postgresql://db01:5432/crm\|public.customer.date | timestamp |

When customer database connection provided and Data Preprocessing Logic available (see preprocess_data step of build_logic Model Template property), run Data Preprocessing Logic.

Asynchronously perform schema inference to detect data types of each field and save this meta data to the Datastore Service.

### Relationship Configuration

Asynchronously create Relationship Configuration-Includes referential integrity (relationship) detection. Build a dependency tree to check which tables work as children and which as parents or both. Relationship Configuration is saved by Datastore Service.

Without connection to Customer DB-attempt to detect foreign keys by counting number of unique values. If percentage of unique values exceeds configured threshold then assume column is a foreign key. This will allow subsets to be created. The system may prompt a foundation model, LLM, or other model to create and then execute the aforementioned logic.

With connection to Customer DB-read the schema information provided by database to create Relationship Configuration. The system may prompt a foundation model, LLM, or other model to create and then execute the aforementioned logic.

All cases, support manual configuration of Relationship Configuration by a user

User validation/modification of Relationship Configuration must be supported.

### Data Domain Detection

When Relationship Configuration complete, asynchronously detect data domain/format—detect email, time series, address, categories/groups, codes, names, salutations, date formats, etc. and add to meta data. Domain detectors are models which are executed by delegating the work to the Request Handler which performs these steps. (NOTE: There are different model types. One type of model might be profiler-domain-detector-address and there could be multiple address detector algorithms and associated models. During execution the models are executed concurrently for one type of model. Then the weighted average result by model type is calculated from all the model results.)

Asynchronously writes the usage data to Usage Datastore Service to track number of requests processed.

Query metadata for the dataset which includes available models and recent average execution times of each model.

Query Model Group Configuration from in-memory cache for domain detectors. If not available or cache expired based on domainDetectorModelGroupConfigurationTimeoutMillis or expiration event triggered by model build, then run grouping algorithm as shown in Model Grouping Logic and create Message Items which are groups of models/rules that are executed by the same worker instance. Save Model Group Configuration to cache.

For each Message Item, send message to Queue for models/rules execution by Workers. Each Worker will do the following:
a. For each model/rule in message:
   1. Lookup Model or Rule from in-memory cache. If not found, lookup model/rule from Model Storage Service and save to in-memory cache. [Must have capability to download a specific version of model, but the default behavior is to download newest version]
   2. If all security checks pass as described in the Security section, then execute model
   3. Put results on Results Cache;
b. Asynchronously waits a configured time to receive all worker results from Results Cache. If Request Handler does not receive all results and complete remaining processing in the configured time, then response is returned to client informing that work is not complete and update metadata record for dataset in Datastore Service with result of timeout;
c. Calculate weighted average for each profiler model type (profiler-domain-detector-email, etc.) using the default WAA for dataset/repository/tenant;
d. Compare configured threshold (queried form configuration service) to weighted average to determine if result is true or false;
e. Asynchronously update metadata record for dataset in Datastore Service with results.

Hyperintelligence system provides REST API for domain tags. Data domain tags will be shown in the metadata view of a dataset by the Hyperintelligence Administration System. This will enable out-of-the-box rules to be automatically applied to a column(s) with a specific data domain. User validation of data domain/format. This is an optional opportunity for a data steward/admin to review and confirm the data domain and format. User may thumb up (true positive) or thumb down (false positive) each data domain tag prediction which is saved in the metadata record for dataset in Datastore Service. User may user add a domain tag to a column or set of columns (false negative). When thumb down then this data domain tag is removed which causes the related models/rules to no longer be automatically executed on this dataset during data in motion or data at rest inspection. When a domain tag is added by user then models/rules associated with this domain tag will be automatically executed on this dataset during data in motion or data at rest inspection. Domain detector models continue to run during the model build phase. Labeled data for domain detector results will be used for weight optimization and training of domain detector models. When a domain tag for a specific dataset, column or column set was marked by a user as a false positive, if in the future the hyperintelligence system predicts that this data domain may apply then the tag will appear in the UI again but with a different color which indicates that the hyperintelligence system predicts the data domain but the associated error checking models for this domain are not being automatically executed. The user must thumb up the domain tag to enable the automatic checking again. Save all results to Datastore Service

### Join Configuration

When Relationship Configuration is created and customer database (DB) is used, asynchronously create Join Configuration by joining each foreign key in the dataset (child) with data from the row referenced by the foreign key (parent table).
a. For scanning of data at rest with connection to customer DB, use Relationship Configuration to create a Join Configuration based on a configured join depth. Each foreign key in the dataset (child) specify the key to child table as well as the columns to include from the parent table. By default, include all parent tables. Parent table might also have foreign keys to join to its parent tables. A configured join depth will determine the levels. Depth of 1 means child (dataset) table->parent table, 2 means child (dataset)->all parent tables->all grandparent tables, etc. User validation/editing of join configuration is required. A join configuration may specify any desired join depth for any table and any desired columns to include in the join. [UI Note for Hyperintelligence Administration System: When displaying error results of audit/scan and when joined data is predicted as an error, the foreign key in the parent will be marked as bad. The foreign key will be clickable to view the data in the child that is predicted as erroneous];
b. For Real-time interception of data in motion with connection to Customer DB, the data that is joined to the dataset is determined by the S2D map after the creation of S2D map is complete. The map contains information to determine the join depth; and
c. For real-time interception of data in motion without connection to Customer DB, joinConfigurationActive flag will be set to false (in other words skip joined dataset).

The system may prompt a foundation model, LLM, or other model to create and then execute the aforementioned logic. This can be achieved by providing the Join Configuration or S2D Map, a detailed description of the Join Configuration or S2D Map to the foundation model, LLM, or other model.

### Data Subset Configuration

When Relationship Configuration is created, asynchronously create Subset Configuration based on Relationship Configuration by looping through each foreign key. For each foreign key and then each foreign key value (nested loop), create a subset query that filters the dataset by each value of a foreign key column. Save to Subset Configuration with Datastore Service. Optional user validation of subset configuration.

The system may prompt a foundation model, LLM, or other model to create and then execute the aforementioned logic. This can be achieved by providing the Relationship Configuration, a detailed description of Relationship Configuration to the foundation model, LLM, or other model.

### Data Profile

1. For each dataset (regular, subset and joined), create a data profile. This is repeated at configured interval or before each model build because data can be added or changed. [Note: Most of the regular dataset profile will be viewable in the Intelligence Administration Server Module]
2. Query profile metadata from cache. If not found query profile metadata from Datastore Service and save to cache. Metadata includes available profiler models (and optional Model Configuration that overrides the default in the model package for each), recent average execution times of each model, etc.
3. For each dataset
   a. Asynchronously writes the usage data to Usage Datastore Service to track number of requests processed
   b. Query Model Group Configuration from in-memory cache. If not available or cache expired based on value of ConfigurationService key modelGroupConfigurationTimeoutMillis, then run grouping algorithm as shown in Model Grouping Logic and create Message Items which are groups of models/rules that are executed by the same worker instance. Save Model Group Configuration to cache.
   c. As necessary, provision cluster nodes for execution based on execution counters and node sizes in Runtime Configuration. If unutilized nodes matching node size are available, then use unutilized nodes.
   d. For each Message Item, send message to Queue for models/rules execution by Workers. Each Worker will do the following:
      i. For each model/rule in message:
         1. Lookup Model or Rule from in-memory cache. If not found, lookup model/rule from Model Storage Service and save to in-memory cache.
         2. If all security checks pass as described in the Security section, then execute model
         3. Put results on Results Cache
   e. Asynchronously waits to receive all worker results from Results Cache
   f. Lookup default weighted averaging algorithm from Configuration Service: ConfigurationService.get (“waa.server.default”, “waa.simple-python.latest”, tenantId, repositoryName, datasetName);
   g. Calculate weighted average for each type of profiler model (profiler-domain detector-email, profiler-domain-detector-zipcode, etc.)
   h. Execute Decision Logic of correct runtime for each type of profiler model to determine final decision
   i. Asynchronously update dataset metadata in Datastore Service with results and decisions
4. For each dataset
   a. For each row send row to the Request Handler which does the following:
      i. Asynchronously writes the usage data to Usage Datastore Service to track number of requests processed
      ii. If value of ConfigurationService key saveRawDataFlag is true, then asynchronously write the data to Datastore Service
      iii. Run grouping algorithm as shown in Model Grouping Logic for Concurrent to create Message Items which are groups of models/rules that are executed by the same worker instance.
      iv. As necessary, provision cluster nodes for execution based on execution counters and node sizes in Runtime Configuration of each model. If unutilized nodes matching node size are available, then use.
      v. For each Message Item, send message to Queue for models/rules execution by Workers. Each Worker will do the following:
         1. For each model/rule in message:
         a. Lookup Model or Rule from in-memory cache. If not found, lookup model/rule from Model Storage Service and save to in-memory cache.
         b. If all security checks pass as described in the Security section, then execute model
         c. Put results on Results Cache
      vi. Asynchronously waits to receive all worker results from Results Cache
      vii. Lookup default weighted averaging algorithm from Configuration Service: ConfigurationService.get (“waa.server.default”, “waa.simple-python.latest”, tenantId, repositoryName, datasetName);
      viii. Calculate weighted average for each type of profiler model (profiler-domain detector-email, profiler-domain-detector-zipcode, etc.)
      ix. Execute Decision Logic of correct runtime for each type of profiler model to determine final decision
      x. Asynchronously update dataset metadata in Datastore Service with results and decisions
5. For each dataset
   a. For each row
      i. For each column send column to the Request Handler which does the following:
         1. Asynchronously writes the usage data to Usage Datastore Service to track number of requests processed
         2. If value of ConfigurationService key saveRawDataFlag is true, then asynchronously write the data to Datastore Service
         3. Run grouping algorithm as shown in Model Grouping Logic for Concurrent to create Message Items which are groups of models/rules that are executed by the same worker instance.
         4. As necessary, provision cluster nodes for execution based on execution counters and node sizes in Runtime Configuration of each model. If unutilized nodes matching node size are available, then use.
         5. For each Message Item, send message to Queue for models/rules execution by Workers. Each Worker will do the following:
         a. For each model/rule in message:
         i. Lookup Model or Rule from in-memory cache. If not found, lookup model/rule from Model Storage Service and save to in-memory cache.
         ii. If all security checks pass as described in the Security section, then execute model
         iii. Put results on Results Cache
         6. Asynchronously waits to receive all worker results from Results Cache
         7. Lookup default weighted averaging algorithm (WAA) from Configuration Service: ConfigurationService.get (“waa.server.default”, “waa.simple-python.latest”, tenantId, repositoryName, datasetName);
         8. Calculate weighted average for each type of profiler model (profiler-domain detector-email, profiler-domain-detector-zipcode, etc.) using the default WAA for dataset/repository/tenant
         9. Execute Decision Logic of correct runtime for each type of profiler model to determine final decision
         10. Asynchronously update dataset metadata in Datastore Service with results and decisions

### Algorithm Selection Configuration

1. Lookup algorithm list (which includes algorithm matching criteria), if not found then download from repository and save to cache.
2. Create Algorithm Selection Configuration by looping through each dataset (regular, subset and joined) and do the following
   a. Check if metadata and Data Profile match the algorithm matching criteria. The algorithm matching criteria is provided in the algorithm package. If yes, add most recent version of algorithm (version maybe changed via Configuration Service key) and add default model level Rapid Optimization Logic (see Intelligence Model(s) Learning & Optimization section) for the algorithm to Algorithm Selection Configuration.
   b. Note: In the case of TYPO (is a trademark/servicemark of Quatro Consulting LLC) for example, select zscore algorithm when the column has a normal distribution as defined by Data Profile. Select Ransac algorithm for correlated pairs as defined by Data Profile.
   c. Create default row level Rapid Optimization Logic (see Intelligence Model(s) Learning & Optimization section) for the dataset
3. Save Algorithm Selection Configuration in dataset metadata in Datastore Service
4. User validation and editing Algorithm Selection Configuration is provided by the Hyperintelligence Administration System.

### Build Predictor Models

1. These are the events that can trigger predictor models to be built for a dataset when a configured minimum record count is met
a. Configured threshold is met for changes (create/update) to admin labels
b. Configured threshold is met for changes (create/update) to dataset
c. Configured model expiration is met
d. Configured model building interval or schedule is met and changes to admin labels or dataset have occurred

2. Loop through items (dataset & selected algorithm & predictor model type combination) in Algorithm Selection Configuration. For each item (dataset & selected algorithm & predictor model type combination) in Algorithm Selection Configuration do following:
e. Query Model Template based on version of the algorithm
f. If available, then run determine_training_resources logic of build_logic property (see Model Template Properties) to determine the preferred node size and node number for training. Add to counter for the training node size.
g. If available, then run determine_test_resources logic of build_logic property (see Model Template Properties) to determine the preferred node size and number for testing. Add to counter for the test node size.
h. If available, then run determine_execute_resources logic of build_logic property (see Model Template Properties) to determine the preferred node size and number for model execution. Add to counter for the execution node size.

3. As necessary, provision cluster nodes for training based on training counters. If unutilized nodes matching node size are available, then use unutilized nodes.

4. As necessary, provision cluster nodes for testing based on testing counters. If unutilized nodes matching node size are available, then use unutilized nodes.

5. Add the preferred node sizes and number for model execution to the Runtime Configuration

6. Use Algorithm Selection Configuration to build each model for each dataset (regular, subset, joined). For each item (dataset & selected algorithm & predictor model type combination) in Algorithm Selection Configuration by sending each item to a Build Worker that will do following:
i. Check in-memory cache for version of algorithm. If not found download version of algorithm package from Model Storage Service and unzip, then save to cache.
j. Check preferred node size in Build Configuration and then use appropriate node for remaining steps
k. Prepare initial data
l. If available, then run preprocess_data logic of build_logic property (see Model Template Properties)
m. If dataset type is joined and value of ConfigurationService key joinConfigurationActive is not false, then use Join Configuration to query data, otherwise continue loop at next item
n. If dataset type regular, query data
o. If dataset type is subset, then use Subset Configuration to query data.
p. If available, then run prepare_data logic of build_logic property (see Model Template Properties)
q. If available, then run select_features logic of build_logic property (see Model Template Properties) based on Feature Selection Configuration. NOTE: Use Relationship Configuration to exclude foreign keys, primary/unique keys from univariate models, etc. Feature Selection Configuration may decrease features or add features.
r. Run train logic of build_logic property (see Model Template Properties). Could be fine-tuning a foundation model, LLM, or other model in this step.
s. Package the model and Model Configuration with version then deploy package to Model Storage Service
t. Add model test details to the metadata for the dataset. This will be queried by the Model Test Handler to determine the available models and what messages to put on the worker Queue.
u. Perform model optimization. Default logic which may be overridden/changed is to perform weight optimization (NOTE: Logic is executed here is completely customizable; therefore, deep learning, input optimization or other approaches may be implemented. Test model deployment, testing and other steps may be repeated): For each row of test data send to Model Test Handler which does the following:
   i. Query model from the Model Storage Service
   ii. Execute the newly built model
   iii. Calculate running average prediction accuracy (number of correction predictions/total predictions)
   iv. Set the weight for model to its average prediction accuracy and save this as part of the dataset metadata in the Datastore Service.
   v. Note: Model optimization may change Model Configuration like the Runtime Configuration parameters
v. Package the model and Model Configuration with version then deploy package to Model Storage Service
w. Add model details to the metadata for the dataset and save to Datastore Service. This will be queried by the Request Handler or Model Test Handler to determine the available models and what messages to put on the worker Queue. (Note: Querying this information during the model execution phase allows the Model Configuration and metadata to change without rebuilding the model. Model Configuration should only be added to the dataset metadata when the Model Configuration differs from the Model Configuration in the deployed model package. Otherwise unnecessary additional processing occurs.)
x. Fire event to expire Model Group Configuration for this dataset
y. If available, then run run_after_build logic of build_logic property (see Model Template Properties)

### Build Profiler Models

1. These are the events that can trigger profiler models to be built for a dataset when a configured minimum record count is met
a. Configured threshold is met for changes (create/update) to admin labels for profile
b. Configured threshold is met for changes (create/update) to dataset
c. Configured model expiration is met
d. Configured model building interval or schedule is met and changes to admin labels or dataset have occurred

2. Query Algorithm Selection Configuration for dataset from the Datastore Service. Loop through items (dataset & selected algorithm & profiler type combination) in Algorithm Selection Configuration. For each item (dataset & selected algorithm & profiler type combination) in Algorithm Selection Configuration do following:
a. Query Model Template based on version of the algorithm
b. If available, then run determine_training_resources logic of build_logic property (see Model Template Properties) to determine the preferred node size and node number for training. Add to counter for the training node size.
c. If available, then run determine_test_resources logic of build_logic property (see Model Template Properties) to determine the preferred node size and number for testing. Add to counter for the test node size.
d. If available, then run determine_execute_resources logic of build_logic property (see Model Template Properties) to determine the preferred node size and number for model execution. Add to counter for the execution node size.

3. As necessary, provision cluster nodes for training based on training counters. If unutilized nodes matching node size are available, then use unutilized nodes.

4. As necessary, provision cluster nodes for testing based on testing counters. If unutilized nodes matching node size are available, then use unutilized nodes.

5. Add the preferred node size and number for model execution to the Runtime Configuration

6. Use Algorithm Selection Configuration to build each model for each dataset (regular, subset, joined). For each item (dataset & selected algorithm & profiler model type combination) in Algorithm Selection Configuration by sending each item to a Build Worker that will do following:
a. Check in-memory cache for version of algorithm. If not found download version of algorithm package from Model Storage Service and unzip, then save to cache.
b. Check preferred node size in Build Configuration and then use appropriate node for remaining steps
c. Prepare initial data
d. If available, then run preprocess_data logic of build_logic property (see Model Template Properties)
e. If dataset type is joined and value of ConfigurationService key joinConfigurationActive is not false, then use Join Configuration to query data, otherwise continue loop at next item
f. If dataset type regular, query data
g. If dataset type is subset, then use Subset Configuration to query data.
h. If available, then run prepare_data logic of build_logic property (see Model Template Properties)
i. If available, then run select_features logic of build_logic property (see Model Template Properties) based on Feature Selection Configuration. NOTE: Use Relationship Configuration to exclude foreign keys, primary/unique keys from univariate models, etc. Feature Selection Configuration may decrease features or add features.
j. Run train logic of build_logic property (see Model Template Properties). Could be fine-tuning a foundation model, LLM, or other model in this step.
k. Package the model and Model Configuration with version then deploy package to Model Storage Service
l. Add model test details to the metadata for the dataset. This will be queried by the Model Test Handler to determine the available models and what messages to put on the worker Queue.
m. Perform model optimization. Default logic which may be overridden/changed is to perform weight optimization (NOTE: Logic is executed here is completely customizable; therefore, deep learning, input optimization or other approaches may be implemented. Test model deployment, testing and other steps may be repeated): For each row of test data send to Model Test Handler which does the following:
   i. Query model from the Model Storage Service
   ii. Execute the newly built model
   iii. Calculate running average prediction accuracy (number of correction predictions/total predictions)
   iv. Set the weight for model to its average prediction accuracy and save this as part of the dataset metadata in the Datastore Service.
   v. Note: Model optimization may change Model Configuration like the Runtime Configuration parameters
n. Package the model and Model Configuration with version then deploy package to Model Storage Service
o. Add model details to the metadata for the dataset and save to Datastore Service. This will be queried by the Request Handler or Model Test Handler to determine the available models and what messages to put on the worker Queue. (Note: Querying this information during the model execution phase allows the Model Configuration and metadata to change without rebuilding the model. Model Configuration should only be added to the dataset metadata when the Model Configuration differs from the Model Configuration in the deployed model package. Otherwise unnecessary additional processing occurs.)
p. Fire event to expire Model Group Configuration for this dataset
q. If available, then run run_after_build logic of build_logic property (see Model Template Properties)

### Model Execution Lifecycle

### Execute Predictor Model

### Scanning of Data at Rest

1. For selected dataset or database, confirm current models are available if not then, execute Build Profiler Model DAG and Build Predictor Model DAG.

2. For each selected table
a. Query metadata from cache. If not found query metadata from Datastore Service and save to cache. Metadata for the dataset includes available models (and optional Model Configuration that overrides the default in the model package for each), recent average execution times of each model, Data Preprocessing Logic (this is logic that is executed prior to executing models and is an opportunity to transform the data), etc.
b. For each row and model type (see type property of Model Template Properties section) found in dataset metadata:
   i. Query Model Template for model. If available, run the run_before_execute step from the execute_logic property. Then if available, run the validate_execute_params step from the build_logic property.
   ii. If available, then run preprocess_data logic of execute_logic property (see Model Template Properties)
   iii. If not created, create Default Row Hash
   i. Execute row level Rapid Optimization Logic (see Intelligence Model(s) Learning & Optimization section) and if non-null result provided, then:
      1. Asynchronously writes the usage data to Usage Datastore Service to track number of requests processed
      2. If value of ConfigurationService key saveRawDataFlag is true, then asynchronously write data in Datastore Service. Otherwise, in the case of TYPO ((is a trademark/servicemark of Quatro Consulting LLC) save only data in Datastore Service if decision is error.
      3. Asynchronously save results and decisions in Datastore Service. Note: Result should include result type of rapid optimization so calculation of mean model execution time (as described in Model Grouping Logic for Concurrent Execution by Workers section) can exclude this execution time.
      4. If value of ConfigurationService key saveToBlockchain is true, then asynchronously save data, dataset metadata and information, model information (version, inputs, etc.), results, decisions, any available feedback, any available user information, and source of data to Blockchain Service.
      5. Continue to next row and do not process remaining steps for current row
   ii. Send row to the Audit Request Handler which does the following:
      1. Asynchronously writes the usage data to Usage Datastore Service to track number of requests processed
      2. If value of ConfigurationService key saveRawDataFlag is true, then asynchronously write the data to Datastore Service
      3. Run grouping algorithm as shown in Model Grouping Logic for Concurrent to create Message Items which are groups of models/rules that are executed by the same worker instance.
      4. As necessary, provision cluster nodes for execution based on execution counters and node sizes in Runtime Configuration of each model. If unutilized nodes matching node size are available, then use unutilized nodes.
      5. For each Message Item (which contains all necessary dataset metadata to run model like S2D map, Model Configuration, Feature Selection Configuration, Row Hash, etc.), send message to Queue for models/rules execution by Workers. Each Worker will do the following:
         a. For each model/rule in message:
         i. Lookup Model or Rule from in-memory cache. If not found, lookup model/rule from Model Storage Service and save to in-memory cache. [Must have capability to download a specific version of model, but the default behavior is to download newest version]
         ii. Execute model level Rapid Optimization Logic and if non-null result provided, then:
         1. Put result on Results Cache. Note: Result should include result method type of rapid optimization so calculation of mean model execution time (as described in Model Grouping Logic for Concurrent Execution by Workers section) can exclude this execution time.
         2. Worker exits because work is complete
         iii. If all security checks pass as described in the Security section, then execute model. Run the execute step from the execute_logic property (see Model Template Properties). Then if available, run the run_after_execute step from the execute_logic property (see Model Template Properties).
         iv. Put results on Results Cache
      6. Asynchronously waits to receive all worker results from Results Cache
      7. Lookup default weighted averaging algorithm (WAA) from Configuration Service: ConfigurationService.get (“waa.server.default”, “waa.simple-python.latest”, tenantId, repositoryName, datasetName);
      8. Calculate weighted average final result for each type of model (predictor-duplicate, predictor-error, etc.) using the default WAA for dataset/repository/tenant
      9. For each type of model run the Decision Logic to generate a decision.
      10. Asynchronously update record in Datastore Service with results and decisions. In the case of TYPO ((is a trademark/servicemark of Quatro Consulting LLC), if value of ConfigurationService key saveRawDataFlag is not true, and result is error, then save data in Datastore Service.
      11. If value of ConfigurationService key saveToBlockchain is true, then asynchronously save data, dataset metadata and information, model information (version, inputs, etc.), results, decisions, any available feedback, any available user information, and source of data to Blockchain Service.

3. For each table
a. Asynchronously writes the usage data to Usage Datastore Service to track number of requests processed
b. Query metadata from cache. If not found query metadata from Datastore Service and save to cache. Metadata for the dataset includes available models (and Model Configuration for each), recent average execution times of each model, etc.
c. Query Model Template for model. If available, run the run_before_execute step from the execute_logic property. Then if available, run the validate_execute_params step from the build_logic property.
d. If available, then run preprocess_data logic of execute_logic property (see Model Template Properties)
e. Query Model Group Configuration from in-memory cache. If not available or cache expired based on modelGroupConfigurationTimeoutMillis, then run grouping algorithm as shown in Model Grouping Logic and create Message Items which are groups of models/rules that are executed by the same worker instance. Save Model Group Configuration to cache.
f. As necessary, provision cluster nodes for execution based on execution counters and node sizes in Runtime Configuration. If unutilized nodes matching node size are available, then use unutilized nodes.
g. For each Message Item, send message to Queue for models/rules execution by Workers. Each Worker will do the following:
   i. For each model/rule in message:
      1. Lookup Model or Rule from in-memory cache. If not found, lookup model/rule from Model Storage Service and save to in-memory cache. [Must have capability to download a specific version of model, but the default behavior is to download newest version]
      2. If all security checks pass as described in the Security section, then execute model (MessageItem contains all necessary dataset metadata to run model like S2D map, Model Configuration, Feature Selection Configuration, etc.). Run the execute step from the execute_logic property (see Model Template Properties). Then if available, run the run_after_execute step from the execute_logic property (see Model Template Properties).
      3. Put results on Results Cache
   h. Asynchronously waits to receive all worker results from Results Cache
   i. Lookup default weighted averaging algorithm from Configuration Service: ConfigurationService.get (“waa.server.default”, “waa.simple-python.latest”, tenantId, repository Name, datasetName);
   j. Calculate weighted average for each type of model (predictor-duplicate, predictor-error, etc.) using the default WAA for dataset/repository/tenant
   k. For each type of model run the Decision Logic to generate a decision.
   l. Asynchronously update record in Datastore Service with results and decisions
   m. If value of ConfigurationService key saveToBlockchain is true, then asynchronously save data, dataset metadata and information, model information (version, inputs, etc.), results, decisions, any available feedback, any available user information, and source of data to Blockchain Service.

### Real-time Interception of Data in Motion

1. Intelligence Client Module does the following:
a. [Initialization] Download configuration (including the threshold for comparing to final weighted average result in later step, S2D Map, Model Templates, Feature Selection Configuration, Security information, etc.) from Configuration Endpoint then apply configuration
b. [Initialization] Asynchronously check Datastore Service for labeled data to create the labeled data cache, client-side models and default WAA for runtime of client and download all client-side models, metadata of datasets, and WAAs to cache (browser local storage). NOTE: Browser local storage has 10 MB per origin (aka domain) limit so a single model cannot exceed 10 MB and when multiple models exceed 10 MB then multiple origins are used.
c. [Initialization] Check local cache for data, results and decisions that need to be sent to Request Handler Service. If they exist, then asynchronously send them to the Request Handler Service.
d. Asynchronously, perform all [Initialization] steps on a configured interval
e. Intercept data
f. Create Default Row Hash (see Intelligence Model(s) Learning & Optimization section)
g. Execute Data Preprocessing Logic
h. For each model type (see type property of Model Template Properties section) found in configuration, execute row level Rapid Optimization Logic (see Intelligence Model(s) Learning & Optimization section) and if non-null result provided, then:
   i. If configured and feature supported by client, take screenshots at configured interval
   ii. Sends data, results, and decisions to Request Handler Service that does the following (NOTE: If the Request Handler Service is unavailable, then cache the data, results, and decisions and send to Request Handler Service when available):
      1. Asynchronously writes the usage data to Usage Datastore Service to track number of requests processed
      2. Asynchronously writes the intercepted data, results, and decisions to Datastore Service
      3. If value of ConfigurationService key saveToBlockchain is true, then asynchronously save data, dataset metadata and information, model information (version, inputs, etc.), results, decisions, any available feedback, any available user information, and source of data to Blockchain Service.
   iii. Asynchronously fire appropriate event based on result
   iv. If user or system consuming results provides feedback, asynchronously send feedback to Request Handler
   v. Asynchronously, perform real-time learning by updating models and client cache of labeled data for the dataset with feedback.
   vi. If configured and feature supported by client, asynchronously send screenshots to Hyperintelligence Computing System to be saved by the Datastore Service
   vii. Client stops any further processing of intercepted data (It does not continue to 2.e. or 3.)
i. Asynchronously check cache for all applicable client-side models for the intercepted data. If one or more not found, then download from Model Storage Service and add to cache.
j. Wait asynchronously and when each model is downloaded, if all security checks pass as described in the Security section, then execute model. Run the execute step from the execute_logic property (see Model Template Properties). Then if available, run the run_after_execute step from the execute_logic property (see Model Template Properties).
k. For each current model in cache, if all security checks pass as described in the Security section, then execute model. Run the execute step from the execute_logic property (see Model Template Properties). Then if available, run the run_after_execute step from the execute_logic property (see Model Template Properties).
l. In the case of TYPO (is a trademark/servicemark of Quatro Consulting LLC), run client-side rules in configuration. If rules do not pass then fire event and stop, otherwise continue

2. Intelligence Client Module sends data to Request Handler Service that does the following (NOTE: If the Request Handler Service is unavailable, then cache the data, results, and decisions and send to Request Handler Service when available):
a. Asynchronously writes the usage data to Usage Datastore Service to track number of requests processed
b. Query metadata for the dataset which includes available models (and Model Configuration for each), recent average execution times of each model, S2D map if customer DB connection scenario, Model Template, Data Preprocessing Logic (this is logic that is executed prior to executing models and is an opportunity to transform the data), Feature Selection Logic, etc.
c. Asynchronously writes the intercepted data to Datastore Service
d. If row hash not provided by Intelligence Client Module, create Default Row Hash
e. Query Model Group Configuration from in-memory cache. If not available or cache expired based on modelGroupConfigurationTimeoutMillis or expiration event triggered by model build, then run grouping algorithm as shown in Model Grouping Logic and create Message Items which are groups of models/rules that are executed by the same worker instance. Save Model Group Configuration to cache.
f. As necessary, provision cluster nodes for execution based on execution counters and node sizes in Runtime Configuration. If unutilized nodes matching node size are available, then use unutilized nodes.
g. For each Message Item (which contains all necessary dataset metadata to run model like S2D map, Model Configuration, Model Template, Feature Selection Configuration, Row Hash, etc.), send message to Queue for models/rules execution by Workers. Each Worker will do the following:
   i. For each model/rule in message:
      1. Lookup Model or Rule from in-memory cache. If not found, lookup model/rule from Model Storage Service and save to in-memory cache. [Must have capability to download a specific version of model, but the default behavior is to download newest version]
      2. If available, run the run_before_execute step from the execute_logic property (see Model Template Properties). Then if available, run the validate_execute_params step from the build_logic property (see Model Template Properties).
      3. If available, then run preprocess_data logic of execute_logic property (see Model Template Properties)
      4. Execute model level Rapid Optimization Logic (see Intelligence Model(s) Learning & Optimization section) and if non-null result provided, then
         a. Put results on Results Cache. Note: Result should include result type of rapid optimization so calculation of mean model execution time (as described in Model Grouping Logic for Concurrent Execution by Workers section) can exclude this execution time.
         b. Worker exits because work is complete
      5. If all security check pass as described in Security section, then execute model. Run the execute step from the execute_logic property (see Model Template Properties). Then if available, run the run_after_execute step from the execute_logic property (see Model Template Properties).
      6. Put results on Results Cache
h. Asynchronously waits a configured time to receive all worker results from Results Cache. If Request Handler does not receive all results and complete remaining processing in the configured time, then response is returned to client informing that work is not complete and update record in Datastore Service with result of timeout.
i. Calculate server-side weighted average for each type of model (predictor-duplicate, predictor-error, etc.) using the default WAA queried from ConfigurationService for dataset/repository/tenant
j. Run Decision Logic for each model type to determine decisions
k. Asynchronously update record in Datastore Service with results and decisions
l. If value of ConfigurationService key saveToBlockchain is true, then asynchronously save data, dataset metadata and information, model information (version, inputs, etc.), results, decisions, any available feedback, any available user information, and source of data to Blockchain Service.
m. Asynchronously sends all available results and decisions in response returned to client

3. Intelligence Client Module does the following:
a. If configured and feature supported by client, take screenshots at configured interval
b. Receive response from Request Handler
c. Calculate the weighted average final result with client-side model results and server-side model results (not server-side final result) for each type of model (predictor-duplicate, predictor-error, etc.) using the default WAA for dataset/repository/tenant
d. Run Decision Logic for each model type to generate decisions
e. Asynchronously send results and decisions to Request Handler which does the following (NOTE: If the Request Handler Service is unavailable, then cache the data, results, and decisions and send to Request Handler Service when available):
   i. Asynchronously update record in Datastore Service with results and decisions
   ii. If value of ConfigurationService key saveToBlockchain is true, then asynchronously save data, dataset metadata and information, model information (version, inputs, etc.), results, decisions, any available feedback, any available user information, and source of data to Blockchain Service.
f. Asynchronously fire appropriate events based on decisions
g. If user or system consuming results provides feedback, asynchronously send feedback to Request Handler which does the following (NOTE: If the Request Handler Service is unavailable, then cache the data, results, and decisions and send to Request Handler Service when available):
   i. Asynchronously update record in Datastore Service with results and decisions
   ii. If value of ConfigurationService key saveToBlockchain is true, then asynchronously save data, dataset metadata and information, model information (version, inputs, etc.), results, decisions, any available feedback, any available user information, and source of data to Blockchain Service.
h. Asynchronously, perform real-time learning by updating models and client cache of labeled data for the dataset with feedback.
i. If configured and feature supported by client, asynchronously send screenshots to Hyperintelligence Computing System to be saved by the Datastore Service

### Model Grouping Logic for Concurrent Execution by Workers

The model grouping ensures that the granularity of the unit of work performed by a Worker is not too short. Some models execute so fast that running each concurrently would take longer than running them sequentially (non-concurrently). A model group is a set of one or more models grouped into a unit of work that is performed by one Worker. The grouping logic controls the granularity of the unit of work. It needs to be small but not too small that concurrent execution is slower than sequential.

This algorithm groups the longest running models/runs with the shortest running based on a configured maximum execution time. Efficient execution of models is best determined by the available hardware platform, OS and resources (RAM, CPU speed, network, etc) available for the worker. This algorithm assumes that the workers are homogeneous with the same resources which makes this algorithm cloud friendly.

The hyperintelligence computing system server(s) will track execution times of all models. A batch process running at a configured interval will calculate the mean execution time in milliseconds of models for each dataset (normal, subset, joined, etc.). If a prediction/decision was made using Rapid Optimization Logic, then this execution time should not be included in the mean execution time calculation because the execution did not occur on the cluster.

A user may provide custom Model Grouping Logic. The default Model Grouping Logic will sort all models to be executed by their mean execution time in descending order. Then create groups of models where the sum of mean execution time for each group does not exceed the product of the value of ConfigurationService key maxPredictionTimeMillis and the value of ConfigurationService key workerTimePercent. Any model with mean execution time that exceeds the product of the value of ConfigurationService key maxPredictionTimeMillis and the value of ConfigurationService key workerTimePercent will be in a group with only one model. A Worker will sequentially execute each model in a group. Below is the default Model Grouping Logic in Java pseudo code, other implementations may achieve the same or similar behavior:

```
import java.util.*;
Collection<ModelInfo> modelInfos = new ArrayList<ModelInfo>( );
Collection<ModelInfo> modelInfosSortedDescending = /* ArrayList<ModelInfo> sorted
descending by mean execution time */
Collection<Collection> messageItems = new ArrayList<Collection>( );
int smallestTimeIndex = (modelInfosSortedDescending.length > 0 ?
modelInfosSortedDescending.length − 1 : 0);
ModelInfo[ ] modelInfosSortedDescendingArray = modelInfosSortedDescending.toArray( );
int constant MAX_PREDICTION_TIME_MILLIS =
ConfigurationService.getInstance( ).get(“maxPredictionTimeMillis”, “500”, tenantId,
repositoryName, datasetName);
int constant WORKER_TIME_PERCENT =
ConfigurationService.getInstance( ).get(“workerTimePercent”, “0.75”, tenantId, repositoryName,
datasetName);
int constant MAX_WORKER_TIME_MILLIS = MAX_PREDICTION_TIME_MILLIS *
WORKER_TIME_PERCENT;
for (int i = 0; i < modelInfosSortedDescendingArray.length && smallestTimeIndex >= 0; i++) {
  List<ModelInfo> group = new ArrayList<ModelInfo>( );
  if (modelInfosSortedDescendingArray[i].meanExecution TimeMillis >=
MAX_WORKER_TIME_MILLIS) {
    group.add(modelInfosSortedDescendingArray[i]);
    messageItems.add(group);
    continue;
  }
  if (smallestTimeIndex == i) {
    group.add(modelInfosSortedDescendingArray[i]);
    messageItems.add(group);
    break;
  }
  int groupTimeMillis = modelInfosSortedDescendingArray[i].meanExecutionTimeMillis;
  group.add(modelInfosSortedDescendingArray[i]);
  while (groupTimeMillis < MAX_WORKER_TIME_MILLIS && smallestTimeIndex > i) {
    groupTimeMillis +=
modelInfosSortedDescendingArray[smallestTimeIndex].meanExecutionTimeMillis;
        if (groupTimeMillis > MAX_WORKER_TIME_MILLIS) {
      break;
        }
        group.add(modelInfosSortedDescendingArray[smallestTimeIndex]);
    smallestTimeIndex−−;
  }
  messageItems.add(group);
}
```

### Metric Tracking

Metric tracking is necessary to understand the state of hyperintelligence system including the datasets, models and results overtime. Periodic and accumulating snapshots will be supported and calculated by a batch process running on a configurable interval. Understanding if decisions and predictions made by the hyperintelligence system are getting better or worse over time is a requirement. The hyperintelligence system must provide trending metrics per dataset, per repository, and all repositories for a tenant. Metrics shall include:
Values of all data profile metrics
Results of each model execution (and fingerprint/user)
Weighted average results of multiple models for each model type
User responses and labels
Administrator labels

### Generative Capabilities

The disclosed method and system leverage state-of-the-art generative artificial intelligence (AI) and data science techniques to interpret and process inputted information and generate new insights, predictions, and recommendations. The present disclosure relates to method and system for interpreting inputted information, particularly focusing on language models, generative artificial intelligence, automation, generative analytics, and analysis capabilities.

Enabling machines, devices, and systems to make decisions and perform tasks that would normally require human intelligence is a valuable technological advancement. Performing artificial intelligence and automated decision-making in real-time with a variety of information, and immediately learning from good or bad decisions or predictions, feedback, and new information, is valuable innovation with multiple uses and applications.

However, existing systems often lack robust generative capabilities for creating and performing analysis and analytics, which involves not only interpreting inputted information but also generating new insights, predictions, and recommendations based on the processed data, learning, and feedback. Therefore, there is a need for a method and system that incorporates enhanced generative artificial intelligence capabilities into the interpretation, processing, and analysis of inputted information. Benefits include increased efficiency and speed in generating creative and analytical content, enhanced control over the style and characteristics of the generated output, ability to of a systems to immediately act on the generated output, and ability to explore a wider range of creative possibilities.

Many statistics and data science techniques may be used as part of the method and system disclosed and the method and system are not limited to the techniques described. Inferential statistics refers to utilizing sample data to make predictions or draw conclusions about a population. Sampling methods refers to techniques for selecting a subset of data from a larger population for analysis. Confidence intervals refers to statistical ranges used to estimate the likelihood of a parameter falling within a certain range. Hypothesis testing refers to a statistical method to determine if there is enough evidence to support or reject a hypothesis about a population parameter. Parametric tests refer to statistical tests that make assumptions about the parameters of the population distribution. Non-parametric tests refer to statistical tests that do not rely on assumptions about the parameters of the population distribution. Regression analysis refers to analyzing the relationship between variables to understand how one variable affects another. Chi-Square tests refers to statistical tests used to determine if there is a significant association between categorical variables. Bayesian inference refers to a statistical method for updating beliefs about the probability of an event based on evidence.

Machine learning refers to algorithms that enable computers to learn patterns and make predictions from data without being explicitly programmed. Supervised machine learning involves training a model on labeled data, where the algorithm learns the relationship between input features and corresponding target labels, enabling it to make predictions on new, unseen data based on that learned relationship. Unsupervised machine learning, on the other hand, deals with unlabeled data, where the algorithm explores the data structure to find patterns or relationships without explicit guidance, often clustering similar data points together or reducing the dimensionality of the data. Reinforcement learning is another machine learning paradigm where an agent learns to make decisions by interacting with an environment, receiving feedback in the form of rewards or penalties, and optimizing its actions to maximize cumulative rewards over time.

Deep learning is a subset of machine learning, which in turn is a subset of artificial intelligence. A neural network, in the context of artificial intelligence or deep learning, is a computational model designed to simulate the pattern recognition capabilities analogous to biological neural networks. It consists of an interconnected assembly of nodes, known as neurons, which are organized in layers. These layers include an input layer, one or more hidden layers, and an output layer. Each neuron within the network processes input signals received from its preceding layer and transmits an output signal to neurons in the subsequent layer. The signal transmission between neurons is facilitated by connections known as synapses, which carry an associated weight. These weights are adjustable parameters of the neural network and are tuned during the training process. The operation of a neuron involves summing the weighted inputs from all incoming synapses and applying a nonlinear activation function to this sum to produce an output. The choice of activation function, such as the sigmoid, hyperbolic tangent, or rectified linear unit (ReLU), is crucial for introducing nonlinearity into the model, enabling it to learn complex patterns. Training a neural network involves adjusting its weights based on a dataset of input-output pairs. This process typically uses a gradient-based optimization algorithm, such as stochastic gradient descent, in conjunction with a backpropagation algorithm to efficiently compute gradients of a loss function with respect to the weights. The loss function measures the discrepancy between the network's predicted output and the actual target output for each input in the training set. The architecture of a neural network, including the number of layers, the number of neurons in each layer, and the connections between neurons, is designed based on the specific task at hand. This architecture, along with the tuned weights obtained through training, determines the network's ability to accurately model the underlying patterns in the data it was trained on, thereby allowing it to perform tasks such as classification, regression, feature extraction, language translation, text completion, summarization, question-answering, and more. The Transformer architecture was introduced in the paper “Attention is All You Need” by Vaswani et al. in 2017. The core innovation of the Transformer model is the self-attention mechanism, which allows the model to weigh the importance of different words in a sentence, regardless of their distance from each other in the text. This mechanism enables the model to capture complex linguistic structures and relationships, making it particularly effective for understanding and generating human language. Training deep learning models requires large amounts of data and significant computational power, often necessitating the use of specialized hardware such as Graphics Processing Units (GPUs) or Tensor Processing Units (TPUs).

Predictive analytics refers to using data, statistical algorithms, and machine learning techniques to forecast future outcomes. Prescriptive Analytics refers to utilizing data and algorithms to recommend or perform actions to achieve desired outcomes. Optimization techniques refers to algorithms used to find the best solution from a set of feasible solutions. Decision trees are hierarchical structures that use a series of if-then-else decision rules to classify or predict outcomes based on input features, providing a clear visualization of decision-making processes. Heuristics are problem-solving techniques or rules of thumb that guide decision-making by simplifying complex problems into manageable steps, often sacrificing optimality for efficiency.

Simulation modeling refers to creating models to mimic the behavior of real-world systems to analyze their performance under different scenarios. Time series analysis refers to analyzing sequential data points collected over time to identify patterns or trends. Forecasting methods refers to techniques for predicting future values based on historical data. Anomaly detection refers to identifying data points that deviate from normal behavior within a dataset. Computer vision refers to using algorithms to interpret and analyze visual data from the real world.

Natural Language Processing (NLP) refers to processing and analyzing human language data to extract meaning and insights. Sentiment analysis refers to determining the sentiment or emotional tone of a piece of text. Text classification refers to categorizing text documents into predefined categories or classes. Large Language Models refers to advanced neural network models capable of understanding and generating human-like text at scale. Transformer architecture refers to a neural network architecture designed for processing sequential data, widely used in natural language processing tasks.

Generative artificial intelligence refers to artificial intelligence models capable of generating signals, instructions, text, files, images, audio, or video, based on input data and learned patterns. Large language models (LLMs) are specific types of generative AI models trained on vast amounts of textual data, enabling them to understand and generate human-like language. Examples of LLMs include ChatGPT by OpenAI, Llama 2 by Meta, and Gemini by Google. Foundation models are large-scale models or neural network architectures pretrained on massive datasets, such as text corpora or image databases, to learn rich representations of language or visual content. These models serve as the basis or foundation for a wide range of downstream data science, natural language processing (NLP), or computer vision tasks, where they can be fine-tuned on specific datasets or tasks to achieve high performance with relatively little additional training data. Foundation models typically exhibit strong generalization capabilities, capturing intricate patterns and semantics from the pretraining data, and are often used as building blocks for more specialized or task-specific models. Examples of foundation models include Bidirectional Encoder Representations from Transformers (BERT) for NLP tasks and Residual Networks (ResNet) for computer vision tasks.

Multi-modal refers to models that can understand and generate content across multiple modes of input or output. These modes typically include different types of data such as electric signals, BCI signals, gestures, tactile feedback, text, images, audio, video, computer instructions, network data, binary data, and other data provided through aforementioned interfaces. Multi-modal generative AI models are capable of processing and generating content that incorporates information from multiple modalities simultaneously.

Once a LLM is made available to the public as a foundation model, users typically have limited control over the internal configurations, parameters, and underlying architecture of the model. However, there are several ways users can interact with and influence the model's output. Input text allows users provide the initial text or questions, known as prompts, that guide the model's responses. The way a prompt is phrased can significantly affect the model's output. Users can design and refine prompts to elicit more specific or useful responses from the model. This is referred to as prompt engineering. Users can provide additional context or background information in their prompts to help the model generate more relevant responses. Temperature parameter controls the randomness of the model's output. A lower temperature makes the output more deterministic, while a higher temperature introduces more randomness. Top-k sampling parameter limits the sampling to the top-k most likely next words, affecting the diversity and creativity of the output. Users can specify the maximum number of tokens (words or characters) for the model's response, which affects how long or short the output will be. For some models and platforms, users can fine-tune the model on specific datasets to adapt its behavior to particular use cases or domains. This requires access to the model's fine-tuning capabilities and appropriate resources. Some platforms offer different versions or variants of the model, allowing users to choose a version that best fits their needs. When interacting with the model via an API, users can adjust various parameters such as prompt length, response length, and other options provided by the API. Some platforms allow users to provide feedback on the model's responses, which can be used to improve future iterations of the model.

In the context of data science and model performance and accuracy, several key metrics are crucial for evaluating the efficacy of predictive models. These metrics include accuracy, precision, recall, F1 score, mean absolute error (MAE), mean squared error (MSE), root mean squared error (RMSE), area under the receiver operating characteristic curve (AUC-ROC), and log-loss.

Accuracy refers to the proportion of correct predictions made by the model out of the total number of predictions. It is a simple yet powerful indicator of overall model performance, especially when the data is balanced. Precision, also known as positive predictive value, measures the ratio of true positive predictions to the sum of true positive and false positive predictions. It reflects the model's ability to correctly identify positive instances and is particularly important in situations where the cost of false positives is high. Recall, or sensitivity, quantifies the ratio of true positive predictions to the sum of true positive and false negative predictions. This metric highlights the model's ability to identify all relevant instances in the dataset, making it crucial when the cost of false negatives is significant.

The F1 score is the harmonic mean of precision and recall, providing a single metric that balances both concerns. It is particularly useful when the dataset is imbalanced, offering a more comprehensive view of model performance. Mean absolute error (MAE) measures the average magnitude of errors in predictions, without considering their direction. It is a straightforward way to quantify the accuracy of continuous variables, representing the average absolute difference between predicted and actual values. Mean squared error (MSE) also measures the average magnitude of errors, but it squares the differences before averaging them. This approach penalizes larger errors more heavily, providing a more stringent assessment of model accuracy. Root mean squared error (RMSE) is the square root of the mean squared error, translating the error metric back into the original units of the target variable, which can make interpretation more intuitive.

The area under the receiver operating characteristic curve (AUC-ROC) is a performance measurement for classification problems at various threshold settings. It represents the degree or measure of separability, indicating how well the model can distinguish between classes. A higher AUC value denotes a better performing model. Log-loss, or logarithmic loss, measures the performance of a classification model where the prediction output is a probability value between 0 and 1. It penalizes false classifications, especially those that are confident and incorrect, by taking the negative logarithm of the predicted probabilities. Log-loss increases as the predicted probability diverges from the actual label, thus a lower log-loss value indicates a better model.

R-squared (R²) measures the proportion of the variance in the dependent variable that is predictable from the independent variables. It is commonly used in regression analysis to assess the goodness-of-fit of the model. An R² value closer to lindicates that the model explains a large portion of the variance.

Adjusted R-squared adjusts the R² value for the number of predictors in the model, providing a more accurate measure when comparing models with different numbers of independent variables. This metric is useful for determining whether additional predictors improve the model significantly.

Mean Absolute Percentage Error (MAPE) expresses the average absolute errors as a percentage of the actual values. It is particularly useful for comparing forecast accuracy across different datasets or models.

Cohen's Kappa measures the agreement between two raters who each classify items into mutually exclusive categories. It is commonly used in classification problems to evaluate the accuracy of models in relation to a baseline or expected accuracy.

Matthews Correlation Coefficient (MCC) provides a balanced measure that takes into account true and false positives and negatives, suitable for binary classification even when the classes are of very different sizes. It produces a value between −1 and +1, where +1 indicates a perfect prediction, 0 no better than random prediction, and −1 indicates total disagreement between prediction and observation.

Precision-Recall AUC (PR AUC) is similar to AUC-ROC but focuses on the trade-off between precision and recall for different threshold settings. It is especially useful in cases where the positive class is rare, as it gives a more informative picture of a model's performance under these conditions.

Hamming Loss measures the fraction of wrong labels to the total number of labels, applicable in multi-label classification scenarios. A lower Hamming Loss indicates a better performing model.

Gini Coefficient is another measure of a model's discriminative power, derived from the Lorenz curve used in economics. It is often used in credit scoring to evaluate the accuracy of classification models.

Cumulative Gain and Lift Charts are graphical representations that show the effectiveness of a model in identifying the positive class. The cumulative gain chart shows the proportion of the positive class identified as a function of the proportion of the population considered, while the lift chart shows the improvement over random selection.

Balanced Accuracy is particularly useful in situations with imbalanced datasets. It calculates the average of recall obtained on each class, providing a better understanding of the model's performance across different classes.

Brier Score measures the mean squared difference between predicted probability scores and the actual binary outcomes. It is used for probabilistic predictions, with a lower Brier Score indicating better calibrated predictions.

Fowlkes-Mallows Index evaluates the similarity between two sets of clusterings. It is used in clustering analysis to compare the ground truth class assignments with those predicted by the clustering algorithm.

Jaccard Index, also known as Intersection over Union, measures the similarity between two sets of data. In the context of classification, it is used to evaluate the accuracy of models by comparing the intersection of predicted and actual classes over their union.

G-Mean, or Geometric Mean, is used for imbalanced datasets. It is the square root of the product of sensitivity and specificity, ensuring a balance between the two metrics and highlighting the model's ability to perform well on both classes.

Specificity, also known as True Negative Rate, measures the proportion of actual negatives that are correctly identified by the model. It is particularly important in scenarios where false positives are costly or dangerous.

Cross-Entropy Loss is used in classification problems where the goal is to minimize the difference between the predicted probability distribution and the actual distribution. It penalizes confident but incorrect predictions more than less confident ones.

Hinge Loss is used for “maximum-margin” classification, primarily for support vector machines (SVMs). It ensures that predictions are not only correct but also confident.

Mean Squared Logarithmic Error (MSLE) is used when the target values span several orders of magnitude. It is less sensitive to large differences when both predicted and true values are large.

Median Absolute Error (MedAE) measures the median of the absolute errors between predicted and actual values. It is more robust to outliers than MAE.

Symmetric Mean Absolute Percentage Error (sMAPE) is a version of MAPE that treats over- and under-forecasting errors equally. It is particularly useful for time series forecasting.

Akaike Information Criterion (AIC) and Bayesian Information Criterion (BIC) are used to evaluate model complexity and goodness-of-fit, helping in model selection by penalizing models with more parameters.

Concordance Correlation Coefficient (CCC) assesses the agreement between two continuous variables, considering both precision and accuracy.

Informedness, also known as Youden's J statistic, combines sensitivity and specificity to provide a single statistic for model performance evaluation.

Perplexity measures how well a language model predicts a sample. It is the exponentiated average negative log-likelihood of a sequence, with lower perplexity indicating a better model. It is widely used for evaluating language models trained for tasks like text generation and language modeling.

BLEU (Bilingual Evaluation Understudy) score evaluates the quality of machine-translated text against one or more reference translations. It considers the precision of n-grams in the generated text, with higher BLEU scores indicating better performance. It is commonly used for machine translation and text generation tasks.

ROUGE (Recall-Oriented Understudy for Gisting Evaluation) measures the quality of summaries by comparing the overlap of n-grams, word sequences, and word pairs between the generated summary and reference summaries. Variants include ROUGE-N, ROUGE-L, and ROUGE-S, each focusing on different aspects of text overlap.

METEOR (Metric for Evaluation of Translation with Explicit ORdering) is another metric for evaluating machine translation and text generation. It considers precision, recall, synonymy, stemming, and word order, aiming to improve upon the BLEU score.

CIDEr (Consensus-based Image Description Evaluation) evaluates the quality of image captions by comparing them to a set of reference captions. It measures the consensus among multiple references using TF-IDF weighting for n-grams.

SPICE (Semantic Propositional Image Caption Evaluation) assesses the quality of image captions based on the semantic content captured by scene graphs, focusing on the relationships between objects.

BERTScore evaluates text generation by comparing the similarity of contextual embeddings from BERT (Bidirectional Encoder Representations from Transformers) between the generated and reference texts. It uses cosine similarity to measure the alignment of token representations.

Exact Match (EM) measures the percentage of predictions that exactly match the reference answers. It is commonly used for question-answering tasks.

Mean Reciprocal Rank (MRR) evaluates the ranking quality of the model's predictions. It considers the rank of the first correct answer, with higher MRR indicating better performance.

Human Evaluation involves qualitative assessments by human judges, who rate the quality, coherence, relevance, and fluency of the model-generated text. This evaluation is crucial for understanding nuanced aspects of model performance that automated metrics might miss.

Contextual Evaluation examines the model's ability to maintain context and coherence over longer conversations or texts. This is particularly important for dialogue systems and long-form text generation.

Turing Test is an evaluation where human judges interact with the model and try to distinguish it from a human interlocutor. It measures the model's ability to generate human-like responses.

Model explainability and transparency are data science and model performance characteristics that are critical for ensuring trust, accountability, and compliance with regulations. Model explainability refers to the ability to describe the inner workings and predictions of a machine learning model in a way that is understandable to humans. This involves elucidating how input data influences output decisions. Explainability can be achieved through various techniques, including model-agnostic methods like LIME (Local Interpretable Model-agnostic Explanations) and SHAP (SHapley Additive explanations). These methods provide insights by approximating the model locally or assigning importance scores to features, respectively. Additionally, surrogate models, such as decision trees or linear models, can be trained to mimic the behavior of complex models, offering a more interpretable representation.

Transparency pertains to the clarity and openness with which the model's design, functioning, and performance are communicated. Fairness and avoiding bias is considered apart of transparency. Transparency encompasses documenting the model architecture, training process, data used, and any preprocessing steps undertaken. Transparency also involves articulating the rationale behind model choices, such as the selection of specific algorithms, hyperparameters, and validation techniques.

Metrics for assessing model explainability and transparency include feature importance scores, which quantify the influence of individual features on model predictions. Other metrics involve evaluating the fidelity of surrogate models in replicating the behavior of the original complex model. For instance, the R-squared value can measure how well a surrogate model approximates the outputs of a more intricate model.

The method and system in the application shall support A/B Testing where the method and system compare the performance of the current model against a new model on live data. The method and system shall also support champion/challenger framework were a challenger model is executed alongside the current champion model to continuously evaluate if the challenger can perform better.

The method and system ensures that the data science models meet the required standards and thresholds of performance, explainability, or transparency. This requires test data generation from data splitting and synthetic data generation. Data splitting involves automatically splits data into training, validation, and test sets using various techniques such as random sampling, stratified sampling, and cross-validation. Synthetic data generation uses techniques like data augmentation and synthetic data generation to create additional test data. Foundation models and LLMs may be leveraged to generate data.

Automated testing techniques of the method and system may include unit testing, integration testing, regression testing, and stress testing. Unit testing validates individual components of the model, such as data preprocessing steps and feature engineering functions and steps in templates or the build process. Integration testing ensures that different components of the model or ensembles work together as expected. Regression testing automatically compares the performance of new model versions against previous versions to detect any regressions in performance, explainability, or transparency. Stress testing evaluates the model's performance under extreme conditions and large-scale data and load. Foundation models and LLMs may be leveraged to generate automated tests.

The method and system will use validation methods such as cross-validation, bootstrap validation, and holdout validation. Cross-validation implements techniques like k-fold cross-validation to evaluate model performance across different subsets of data. Bootstrap validation uses bootstrapping methods to estimate the accuracy and robustness of the model. Holdout validation reserves a portion of data for final validation to assess the model's generalization ability.

Stream processing provides the infrastructure and capabilities necessary for the real-time processing of continuous or unbounded data streams. It encompasses technologies and frameworks that allow for the scalable and efficient processing of data as it is generated, without the need for storing the data first. Stream processing systems are designed to handle high-velocity and high-volume data streams, enabling features such as real-time data filtering, aggregation, transformation, and complex event processing. Stream processing can handle data at rest or data that is currently stored by sending the data as a stream into the stream processing system.

Prompt engineering is the process of designing, optimizing, and refining input prompts to effectively communicate with generative AI models. This practice leverages the understanding of the model's linguistic, contextual, and knowledge-based processing capabilities to produce desired outcomes. The technique is pivotal in applications ranging from content generation and question answering to complex problem-solving and creative design, where the precision of the input directly influences the quality of the AI's output.

Parts of prompt engineering include prompt design, prompt optimization, contextual framing, and parameter tuning. Prompt design is the initial formulation of the input prompt, which includes the selection of keywords, phrases, and the overall structure of the query to guide the AI's response towards the desired outcome. Prompt optimization is the iterative refinement of the prompt based on feedback loops, where outputs are evaluated for relevance, accuracy, and quality, and the prompt is adjusted accordingly. This process may involve varying the prompt's verbosity, specificity, or the inclusion of instructional tokens that guide the model's generation process.

Tokens are typically words, subwords, characters, or other linguistic elements which serve as the basic units of text that the NPL and generative models process. Common types of tokens are word tokens, subword tokens, and character tokens. In word tokens, each word in text corresponds to a single token. For example, the sentence “The cat sat on the mat” would be tokenized into six separate word tokens: [“The”, “cat”, “sat”, “on”, “the”, “mat”]. With subword tokens, advanced tokenization techniques, such as Byte Pair Encoding (BPE) or WordPiece, break words into smaller subword units. This allows the model to handle out-of-vocabulary words more effectively. For example, the word “unhappiness” might be tokenized into subword tokens: [“un”, “happiness”]. With character tokens, individual characters are treated as tokens. This method can be useful for languages with complex morphology or for handling text with many typos or creative spellings.

The process of converting raw text into tokens is known as tokenization. Tokenization involves text normalization where input text is preprocessed to normalize case, remove punctuation, and handle other language-specific quirks. Then segmentation occurs where normalized text is segmented into tokens based on the chosen tokenization strategy (word, subword, or character). Then encoding occurs where each token is mapped to a unique numerical identifier (token ID) using a predefined vocabulary. The vocabulary is a finite set of all possible tokens the model can recognize, each associated with a unique token ID.

Once tokenized, tokens are converted into embeddings, which are dense vector representations that capture the semantic meaning of the tokens. Token IDs are fed into an embedding layer, which maps each token ID to a fixed-size vector. These vectors are learned during the model training process and are fine-tuned to capture contextual information. Since transformer models do not inherently capture the order of tokens, positional encodings are added to the token embeddings to introduce information about the position of each token in the sequence.

In generative AI models, tokens play a critical role in both the input and output stages. The model receives a sequence of input tokens, processes them through multiple layers of neural transformations, and generates context-aware embeddings. During text generation, the model produces a sequence of output tokens, which are then decoded back into human-readable text. The generation process typically involves techniques like beam search or sampling to ensure fluency and coherence.

Consider the sentence: “AI revolutionizes industries.” The sentence is tokenized into subword tokens: [“AI”, “revolution”, “izes”, “industries”, “.”]. Each token is assigned a token ID from the vocabulary: [102, 5678, 3456, 7890, 12]. The token IDs are converted into embeddings: [vec_102, vec_5678, vec_3456, vec_7890, vec_12], where each vec represents a high-dimensional vector.

Efficient token management is crucial for model performance, particularly in terms of speed, memory usage, and accuracy of the generated text. Existing methods of token management often face limitations in handling large prompts and vocabularies and ensuring coherent text generation. Foundation models and generative models that allow manipulation of tokens, tokenization, embedding, or vectors will be used by the hyperintelligence system to enhance the desired output.

Contextual framing is incorporating context directly into the prompt or through appended context, to provide the model with sufficient background information. This enhances the model's ability to generate responses that are contextually grounded and relevant. Parameter tuning is adjusting model parameters such as temperature, top-p, max tokens, or other parameters in conjunction with prompt engineering to control the creativity, length, and determinism of the generated outputs.

In a broader system or method utilizing generative AI, prompt engineering serves as a critical interface for directing the AI's generative capabilities. By meticulously designing prompts that align with the AI's training and operational paradigms, inventors can harness the full potential of generative models to solve specific problems, generate novel content, or provide insights that would be challenging to obtain otherwise.

The practice of prompt engineering necessitates a deep understanding of both the technical mechanics of generative AI models and the nuanced ways in which language can be structured to guide these models towards generating intended responses. It combines elements of linguistic theory, psychology, and computational logic to craft prompts that effectively communicate the task at hand to the AI.

The application of prompt engineering in conjunction with generative AI models represents a significant advancement in the field of artificial intelligence, enabling more precise, efficient, and goal-oriented interactions with AI systems. This technique is instrumental in unlocking the versatile capabilities of generative AI, allowing for its application across a wide range of domains and industries. The strategic optimization of prompts enhances the utility, performance, and applicability of generative AI, making it a critical element in the development of innovative AI-driven solutions.

Retrieval-Augmented Generation (RAG) is a hybrid computational framework designed to enhance the capabilities of natural language processing (NLP) systems by integrating two distinct methodologies: a retrieval mechanism and a generative model. The primary objective of RAG is to augment the response quality of generative models through the dynamic incorporation of external, contextually relevant information obtained via the retrieval mechanism. This approach allows for the generation of responses that are not only syntactically and semantically coherent but also rich in factual accuracy and specificity.

The retrieval mechanism within RAG operates by querying a large-scale data repository, which could be a structured database, an unstructured knowledge base, or a vast collection of textual documents. This mechanism employs advanced algorithms to search for and retrieve information snippets that are contextually relevant to the input query. The retrieval process often leverages vector space models, where both queries and documents are represented as vectors in a high-dimensional space. Similarity metrics, such as cosine similarity, are used to identify the documents most relevant to the given query based on the proximity of their vector representations. The retrieval mechanism will have access to all data stored in the hyperintelligence system as well as documentation, specifications for application programming interfaces, and example computer source code and instructions for the hyperintelligence system and desired services internal or external to the hyperintelligence system.

Following the retrieval of relevant information, the generative model processes the input query in conjunction with the retrieved information to produce a coherent and contextually enriched response. The generative model is pre-trained on a vast corpus of text, enabling it to understand and generate human-like text. Generative models include foundation models and LLMs. The integration of external information through the retrieval mechanism significantly enhances the generative model's ability to generate responses that are not only linguistically fluent or syntactically valid but also deeply grounded in the factual content of the retrieved documents.

The synergy between the retrieval mechanism and the generative model in RAG systems enables the generation of responses that are both contextually relevant and informationally rich. This is particularly advantageous in applications such as question answering, content creation, and conversational AI, where the quality of the response is paramount. The dynamic nature of the retrieval process allows RAG systems to adapt to new information and topics, providing answers that reflect the most current and relevant information available.

The RAG framework represents a significant advancement in the field of artificial intelligence, particularly in enhancing the capabilities of NLP systems. Its novel approach of augmenting generative models with externally retrieved information addresses critical challenges in generating accurate, relevant, and contextually informed responses. This makes RAG an essential component of any system that requires high-quality natural language generation, leveraging the vast amounts of information available in digital form to produce responses that are informed, accurate, and highly relevant to a system's or user's query.

### Prompt Engineering Example:

Objective: Generate a new machine learning model or an ensemble of models that can outperform the existing models in detecting fraudulent credit card transactions. The existing models are a RandomForestClassifier with 92% accuracy and an MLPClassifier with 93% accuracy.

Context: Below is the most current test data from the database, including features such as timestamp, amount, vendor, vendor industry, and vendor zip code. Additionally, the results of the existing data science models on this data and their accuracy are provided.

```
Test Data in JSON:
[
  {“timestamp”: “2024-07-27T14:45:00”, “amount”: 250.75, “vendor”: “VendorA”,
“vendor_industry”: “Retail”, “vendor_zip_code”: “10001”, “is_fraud”: false },
  {“timestamp”: “2024-07-27T15:00:00”, “amount”: 89.99, “vendor”: “VendorB”,
“vendor_industry”: “Electronics”, “vendor_zip_code”: “10002”, “is_fraud”: false },
  {“timestamp”: “2024-07-27T15:15:00”, “amount”: 4200.00, “vendor”: “VendorC”,
“vendor_industry”: “Luxury Goods”, “vendor_zip_code”: “10003”, “is_fraud”: true },
  {“timestamp”: “2024-07-27T15:30:00”, “amount”: 45.50, “vendor”: “VendorD”,
“vendor_industry”: “Groceries”, “vendor_zip_code”: “10004”, “is_fraud”: false }
]
Current Model Results in JSON:
[
  {“model”: “RandomForestClassifier”, “accuracy”: 0.92},
  {“model”: “MLPClassifier”, “accuracy”: 0.93}
]
```

### Specifications:

1. The new model(s) should be implemented in Python.
2. The goal is to achieve accuracy higher than 93%.
3. Consider using advanced techniques such as hyperparameter tuning, feature engineering, and ensemble methods.
4. Provide the complete Python code for training the new model(s).
5. The code must have a build method with this signature: def build (manifest: Any, input_configuration: Any, df_train: pd.DataFrame, data_profile: Any, logger)->Any
6. The code must have a run method with this signature: def run (model, inputs, logger)

Streaming analytics is a computational paradigm that facilitates real-time analysis and interpretation of data streams. It enables the detection of significant patterns, trends, and relationships within live data, allowing immediate decision-making and action-taking. Streaming analytics systems leverage advanced algorithms and computational techniques to analyze data in motion, providing insights that are critical for time-sensitive applications across various industries such as finance, healthcare, manufacturing, and telecommunications.

Both streaming analytics and stream processing are crucial for applications that require immediate insights and responses to rapidly changing data like inputted information. They are foundational for developing systems that can adapt to real-time conditions, optimize operations, enhance user experiences, and mitigate risks promptly.

Method and system for generative artificial intelligence of inputted data are described herein. In some embodiments, a method comprises processing inputted information using one or more intelligence modules employing one or more intelligence models to process the inputted information; making one or more decisions about inputted information based on the one or more intelligence models; learning to update the one or more intelligence models; interpreting inputted information based on the one or more decisions; and generating new insights, interpretations, predictions, or recommendations based on the processed data and feedback.

Users interact with the method and system through a chat-based, image, audio, video, or brain-computer interface, allowing them to ask questions, request analysis, request analytics, provide feedback about the results of the method and system, perform administrative tasks, and learn more about the generated insights and recommendations. These interfaces facilitate seamless concurrent two-way and multi-way communication between users and the hyperintelligence system, enhancing user experience and enabling efficient collaboration.

Inputted information may be concurrently provided through a plurality of aforementioned interfaces. Users may interact with the hyperintelligence system through a brain-computer interface. Commands provided through any interface of the hyperintelligence system may be transformed into prompts or input for existing state of the art like natural language processing models, LLMs, and foundation models which then use application programming interfaces or other interfaces of the hyperintelligence system to complete the commands. Commands to the brain-computer interface of the hyperintelligence system may leverage the signal processing and device control components that directly use the application programming interfaces of the hyperintelligence system to service commands.

Additionally, the method and system incorporate mechanisms for collecting feedback from users and administrators, allowing continuous improvement of artificial intelligence models, and enhancing the accuracy and relevance of generated insights and recommendations. Users can provide feedback on the correctness of predictions, the usefulness of recommendations, and the overall performance of the system, enabling iterative refinement and optimization.

Furthermore, the method and system are designed to operate in real time or near real time, ensuring timely response to user queries and requests. This real-time capability enhances the usability and practicality of the system in dynamic environments where quick decision-making is crucial.

Overall, the method and system leverage state of the art generative artificial intelligence techniques, user-friendly interfaces, and real-time processing capabilities to provide enhanced generative analytics and analysis capabilities, empowering users to make informed decisions and derive valuable insights from inputted information.

The microservices based architecture of the hyperintelligence system 300 may additionally include, but are not limited to, the brain-computer interface (BCI) service and generative service. The BCI service is responsible for providing additional signal handling and device control and logic related to handling instructions from the BCI. Common need for this is the cases when the BCI of the hyperintelligence system does not leverage the signal processing and device control components that directly use the application programming interfaces of the hyperintelligence system. The BCI service may serve as an intermediary and abstraction between the BCI and services and application programming interfaces of the hyperintelligence system.

The generative service is responsible for handling requests to generate signals, instructions, text, files, images, audio, video, and other multi-modal output. Output may be finite or bounded set of data or an infinite or unbounded stream of data. Input provided to the generative service may be multi-modal, finite or bounded set of data, or an infinite or unbounded stream of data. Generative service may delegate to a plurality of models, including and not limited to LLMs and foundation models, to generate the desired output. Desired output may include and not be limited to data and information stored or available in the hyperintelligence system, information from a third-party source such as the internet, training data of a model, answers to questions, analysis, data queries and results, computer programming language code or configuration, other capabilities of foundation models, LLMs, and the current state of artificial intelligence, and analysis, explanation, interpretation, presentation, or derivation of any of the aforementioned output. To implement the responsibilities of the generative service, various algorithm packages containing foundation models, LLMs, and other data science techniques may be deployed to the Model Storage Service. Then the generative service may impersonate a Client Device 306 or use application programming interfaces of the Hyperintelligence System 300 or intelligence modules of the hyperintelligence system to generate the output from a plurality of models. The output of the generative service may be provided to users, systems, or devices, through any aforementioned interface. Output includes and is not limited to actions that change the state of the hyperintelligence systems, automation, recommended algorithm packages, implementation and deployment of Model Type Template Properties, Model Template Properties, Algorithm Packages, Model Packages, configuration, optimization, label selection, label selection logic, result generation logic, computer programming language code, computer instructions, algorithms, directed acyclic graphs (DAGs), decision logic, and Data Preprocessing Logic. Other output includes and is not limited to analysis of stream processing, stream analytics, charts, visualizations, metric tracking, predictive analytics, forecasts, other analytics, predictions, inference, and data science outputs. For example, a foundation model may be fine-tuned with the documentation of the hyperintelligence system, application programming interfaces, schema of the results of the execution of intelligence models in the Datastore Service. Then a user of a chat-interface issues a request for a chart of the hourly count of the classes for models with a return type of binary-classification for the last 24 hours. Upon reviewing the chart, the user decides that changes are needed to the threshold configuration for a weighted average algorithm. The user provides this instruction through the chat-interface and the hyperintelligence system updates the threshold as commanded.

The generative service may integrate with services like automation services, application services, or enterprise information management services to provide desired modes of output or perform actions. Services may be related to data storage, data management, data processing, data analysis, customer relationship management, business intelligence, data science notebook, data catalog, data graph, ontology, data integration, master data management, data profiling, data quality, data exploration, data visualization, business process management, workflow, and robotic process automation. The generative service may create instructions for the desired plurality of services and execute the instructions.

### Generative Service Example: Real-time Predictive Maintenance

Consider a scenario where sensor data from industrial machines is inputted into the hyperintelligence system. Data preprocessing steps, such as smoothing, noise reduction, and normalization, are applied to the incoming sensor data. A predictive maintenance model or ensemble is executed in real-time, predicting potential failures or maintenance needs. When the model predicts a potential failure, the generative service generates alerts and notifications, providing details about the predicted issue and recommended actions. The service integrates with automation systems to execute predefined actions, such as scheduling maintenance, ordering replacement parts, or adjusting machine parameters to prevent failure. The generative service generates visualizations, including dashboards and reports, to provide insights into machine health, maintenance schedules, and predicted downtimes.

### Generative Service Example: Automated Customer Segmentation and Targeting

Customer data from CRM systems, transaction databases, and online behavior logs is inputted into the hyperintelligence system. Data preprocessing steps, such as cleaning, normalizing, and transforming the data into a suitable format for analysis, are performed. This includes handling missing values, encoding categorical variables, and scaling numerical features. clustering algorithm packages have been deployed to the hyperintelligence system such as K-means, DBSCAN, or hierarchical clustering to segment customers into distinct groups based on their behavior and attributes. A final computation algorithm evaluates the clustering results using metrics like silhouette score, Davies-Bouldin index, and within-cluster sum of squares to ensure meaningful segmentation. The generative service generates detailed profiles for each customer segment, including demographic information, purchasing behavior, and engagement patterns. The generative service generates targeted marketing strategies for each segment, including personalized offers, product recommendations, and communication plans. The generative service integrates with marketing automation platforms to execute the targeted campaigns, monitor their performance, and adjust strategies based on real-time feedback and analytics.

Administration Server Intelligence Module 426 has executable code that provides a graphical user interface (GUI) for performing generative tasks on the hyperintelligence system 300. This will enable users to provide multi-modal prompts, instructions, questions, or other information to Administration Server Intelligence Module 426 which may delegate or communicate with a plurality of intelligence modules available in the hyperintelligence system 300 to cause the execution of a plurality of intelligence models including and not limited to large language models, natural language models, or foundation models to provide a response and determine what actions should be taken by the hyperintelligence system 300. These models may be trained or fine-tuned with or the retrieval mechanism within RAG will have access to inputted information, data profiles, data schemas, prepared data, results of one or more artificial intelligence models, decisions, predictions, metrics, feedback, metadata, configuration, data storage details, information about the hyperintelligence system 300 (such as the architecture, interfaces, application programming interfaces, or documentation), or other data and information available in the hyperintelligence system 300 or data available about the hyperintelligence system 300 or another system that is integrated with the hyperintelligence system through an interface of the other system. This training and fine-tuning will enable the Administration Server Intelligence Module 426 to handle a very board number of multi-modal inputs with great accuracy. For example, a user may request a graph of the number of error predictions monthly for the last two years to be appended to an attached presentation file. Or a user may request that the hyperintelligence system stop processing information related to the sales orders. A user may desire to change the price of a product in an integrated e-commerce system, decrease the quantity of a part in a supply chain system, change the logistics vendor in an order fulfillment system, or change the profile of a customer in a customer relationship management system.

A user may prompt the hyperintelligence system to integrate with another system by providing the system name, version, connection information and authentication credentials. If the hyperintelligence system is unable to find necessary interface details through an internet search or the use of LLM or foundation model, then the user will be requested to prompt the hyperintelligence system with the application programming interface details, other interface details, and documentation. This approach will enable the hyperintelligence system to interface with any desired system as well as enable the hyperintelligence system to perform operations on itself.

### Lifecycle Steps

1. Receive inputted information. Inputted information may be from or to any of the following: Client Device 306, Hyperintelligence Computing System 308, Destination Information System 310, Proxy System 312, Hyperintelligence Administration System 314, Administrator Computing System 316, and a user, device, or system interfacing with any of the aforementioned systems.
2. Make decision by executing a plurality of models by a plurality of intelligence modules
3. Store decision, inputted information, and all model results
4. Receive and process request from user or system
   a. Infer intent of request
   b. Retrieve relevant information including previous relevant feedback
   c. Perform prompt engineering for generative model
   d. Provide relevant information and prompt to a plurality of generative models
   e. Receive responses
   f. Optionally execute instructions or computer code in received responses
5. Respond to request by providing received responses or the result of executing the instructions or computer code.
6. Collect and store feedback about response
7. Learn and adapt (seems this is not necessary because step 4.b. uses the feedback to learn)

These steps may be repeated during a chat-based interaction of a user or similar interaction with the hyperintelligence system.

### Secure Peer-to-Peer Network

Data science models, especially those used in critical applications, require secure and authenticated execution to maintain their integrity and reliability. Traditional client-server architectures pose risks of single points of failure and centralized vulnerabilities. A peer-to-peer (P2P) network can mitigate these risks by distributing the computational load and increasing redundancy. However, ensuring security in a decentralized environment requires robust mechanisms for signing, verifying, and securely executing data science models.

The system comprises nodes that can download, verify, and execute models. Each model is signed with a cryptographic signature, ensuring authenticity. The ensemble of models improves prediction accuracy and robustness.

Each node in the P2P network is a computing entity capable of executing data science models. Nodes communicate with each other to share and verify models and execution results. Nodes discover peers using a decentralized mechanism, such as a Distributed Hash Table (DHT). Nodes agree on the state of the network and the models' authenticity using a consensus protocol, such as Practical Byzantine Fault Tolerance (PBFT) or a similar algorithm. Data science models are signed using a digital signature algorithm (e.g., RSA, ECDSA). The model developer signs the model with a private key. When a node receives a model, it verifies the signature using the corresponding public key. This ensures the model's authenticity and integrity. Nodes execute models within a Trusted Execution Environment, such as Intel SGX or ARM TrustZone. This ensures that model execution is secure and isolated from potential threats on the host machine. Models are encrypted during transmission between nodes using symmetric encryption (e.g., AES). Only nodes with the appropriate decryption key can execute the model. Nodes collaboratively form an ensemble of models. Each node can execute a subset of the models in the ensemble. Execution results from individual models are aggregated to form the final prediction. Aggregation methods include majority voting, weighted averaging, stacking, or any other custom algorithm deployed as an algorithm package. For privacy-preserving computations, nodes can use homomorphic encryption to perform calculations on encrypted data without decrypting it. To ensure the privacy of the data used for model training and execution, nodes can implement differential privacy techniques. Continuous monitoring and logging of model execution is used for auditing and troubleshooting. Role-based access control (RBAC) ensures that only authorized nodes and users can access specific models and data. The system complies with relevant data protection regulations, such as General Data Protection Regulation of the European Union and California Consumer Privacy Act.

In the description and FIGS. 1-12, devices, systems and sequence or state diagrams were shown to illustrate the methods executed in or by a hyperintelligence system and one or more networks and computing environment, in accordance with some embodiments in various deployment configurations. In accordance with the embodiments, a method for interpreting inputted information comprising processing inputted information wherein processing inputted information uses one or more intelligence modules using one or more intelligence models to process the inputted information; making, by the one or more intelligence modules, one or more decisions about inputted information based on the one or more intelligence models; learning, by the one or more intelligence modules, to update the one or more intelligence models; and interpreting inputted information based on the one or more decisions has been disclosed.

Also disclosed is such method set forth above wherein the learning is based on one or more of the following: inputted information, feedback from a user, feedback from a device, feedback from a system, and information in a data store. Shown and described was the method further executing the intelligence models concurrently to process inputted information to make one or more decisions based on the intelligence models.

The method set forth above further comprises one or more client devices having a client intelligence module and a data store accessible by the client intelligence module and comprises one or more networks coupling each client device wherein the making one or more decisions and learning are executed concurrently by client intelligence modules using the one or more networks.

The method set forth above further comprises a client intelligence module and a data store accessible by the client intelligence module.

The method set forth above wherein processing inputted information includes storing inputted information in the data store.

The method set forth above wherein the making one or more decisions and learning are executed by the client intelligence module.

The method set forth above wherein the making one or more decisions and learning are concurrently executed by the client intelligence module.

The method set forth above wherein the one or more decisions are stored in the data store.

The method set forth above further comprising a hyperintelligence computing system having a server intelligence module.

The method set forth above wherein the making one or more decisions and learning are concurrently executed by the intelligence modules in at least one or more of the following: one or more client devices, one or more hyperintelligence computing systems, one or more proxy systems, or one or more destination computer systems.

The method set forth above further comprising one or more networks coupling one or more of the following: one or more client device, one or more hyperintelligence computing systems, one or more proxy systems, one or more destination computer systems, or any combination of the aforementioned or one or more client intelligence modules using the one or more networks and the one or more server intelligence modules using the one or more networks.

The method set forth above further comprising a hyperintelligence administration system coupled to one or more networks and having an administration server intelligence module.

The method set forth above further comprising an administrator computing system coupled to one or more networks and having an administration client intelligence module.

The method set forth above further comprising passing, by the one or more intelligence modules, inputted information along wherein passing the information along uses the one or more decisions as determined by the one or more intelligence modules.

The method set forth above further comprising changing inputted information before passing information along using the one or more decisions as determined by the one or more intelligence modules.

The method set forth above further comprising generating, by the one or more intelligence modules, one or more responses to the inputted information.

The method set forth above further comprising passing, by the one or more intelligence modules, inputted information using available feedback related to the one or more responses as determined by the one or more intelligence modules.

The method set forth above further comprising changing inputted information before passing information along using available feedback related to the one or more responses as determined by the one or more intelligence modules.

The method set forth above] wherein processing inputted information includes processing a continuous stream of information in real-time and intercepting information in real-time.

The method set forth above further comprising one or more client devices each having a client intelligence module and one or more networks coupling each client device wherein the step of making, by the one or more intelligence modules, one or more decisions about inputted information further and learning are offline executed when one or more networks is unavailable, one or more client devices are unavailable, one or more client intelligence modules are unavailable, or the one or more client devices are not coupled by the one or more networks to other systems.

The method set forth above wherein the making one or more decisions and learning are offline executed when one or more of the following occurs: the one or more networks is unavailable, one or more client devices are unavailable or not coupled by the one or more networks to other systems or client devices, one or more intelligence modules are unavailable, one or more hyperintelligence computing systems are unavailable or not coupled by the one or more networks to other systems or client devices, one or more proxy systems are unavailable or not coupled by the one or more networks to other systems or client devices, one or more destination computer systems are unavailable or not coupled by the one or more networks to other systems or client devices.

The method set forth above wherein the learning step further comprises real-time learning, by the one or more intelligence modules, to update the one or more intelligence models.

The method set forth above further comprising the assignment of weights to one or more intelligence models and said weights are used by a weighted average algorithm to make, by the one or more intelligence modules, one or more decisions about inputted information based on the one or more weighted intelligence models.

The method set forth above further comprising weight optimizing one or more intelligence modules.

The method set forth above further comprising security for using the one or more intelligence models.

The method set forth above further comprising storing one or more of the following: information inputted, one of more decisions by the one or more intelligence modules, or one or more results of the one or more intelligence models.

The method set forth above further comprising securely storing one or more of the following: information inputted, one of more decisions by the one or more intelligence modules, or one or more results of the one or more intelligence models.

The method set forth above further comprising securely storing, in an authentic, unalterable, verifiable, permanent and distributed way, one or more of the following: information inputted, one of more decisions by the one or more intelligence modules, or one or more results of the one or more intelligence models.

The method set forth above further comprising storing, in one or more blockchains, one or more of the following: information inputted, one of more decisions by the one or more intelligence modules, or one or more results of the one or more intelligence models.

The method further comprises storing one or more of: the one or more responses or available feedback related to the one or more responses; further comprising securely storing one or more of the following: the one or more responses or available feedback related to the one or more responses or further comprising securely storing, in an authentic, unalterable, verifiable, permanent and distributed way, one or more of the following: the one or more responses or available feedback related to the one or more responses.

The method may also further comprise storing, in one or more blockchains, one or more of the following: the one or more responses or available feedback related to the one or more responses.

The method set forth above further comprising supporting one or more versions of the one or more intelligence modules.

The method set forth above further comprising an administrator computing system couple to one or more networks. In yet another embodiment, method for interpreting inputted information, the method comprising: making, by one or more intelligence modules, one or more decisions about inputted information based on one or more intelligence models; learning, by the one or more intelligence modules; and wherein the learning step further comprises the step of optimizing, by the one or more intelligence modules, the one or more intelligence models using feedback related to the one or more decisions.

Still referring to FIGS. 1-12, the devices, systems and sequence or state diagrams show additional methods executed in or by a hyperintelligence system and one or more networks and computing environment, in accordance with some embodiments in various deployment configurations. In accordance with the embodiments, an additional method is described for interpreting information input from an input device, the method comprising processing information inputted from the input device wherein processing information inputted uses one or more intelligence modules to process the information inputted before passing information along, the one or more intelligence modules using one or more intelligence models to make one or more decisions about the information inputted; making, by the one or more intelligence modules, one or more decisions about the information inputted based on the one or more intelligence models; passing, by the one or more intelligence modules, the information inputted along wherein passing the information along uses the one or more decisions as determined by the one or more intelligence modules; changing the information inputted before passing information along using the one or more decisions as determined by the one or more intelligence modules; and learning, by the one or more intelligence modules, to update the one or more intelligence models.

In accordance with the embodiments, another additional method for interpreting information input from an input device comprising processing information inputted from the input device wherein processing information inputted uses intelligence modules having intelligence models to process the information inputted before passing information along; executing, by the intelligence modules, the intelligence models concurrently to process information inputted from the input device to generate one or more real-time decisions based on the intelligence models; learning, by the intelligence modules, through concurrent optimization of the intelligence models; and passing information corresponding to the information inputted using the one or more real-time decisions as determined by the intelligence modules.

In accordance with the embodiments, yet another additional method for interpreting information input from an input device, the method comprising processing information inputted from the input device wherein processing information inputted uses intelligence modules having intelligence models to process the information inputted before passing information along; executing, by the intelligence modules, the intelligence models concurrently to process information inputted from the input device to generate one or more real-time decisions based on the intelligence models; learning, by the intelligence modules, through concurrent optimization of the intelligence models; passing, by the one or more intelligence modules, the information inputted along wherein passing the information uses the one or more real-time decisions as determined by intelligence modules; and changing the information inputted before passing information along using the one or more real-time decisions as determined by the intelligence modules.

The method set forth above or other methods herein wherein all steps do not require lifeform intelligence or interaction or not require lifeform intelligence.

The method set forth above wherein prior knowledge or conditions, including but not limited to source, destination, transport mechanism, type, format, structure, schema, or related information, of the inputted data is not required to perform all steps of the methods described herein.

The methods set forth herein wherein prior knowledge or conditions, including but not limited to source, destination, transport mechanism, type, format, structure, schema, or related information, of the inputted data or the one or more responses or available feedback related to the one or more responses is not required to perform all steps of the of the methods herein.

The method set forth above] wherein inputted information may be structured or unstructured. The method herein wherein inputted information may be structured or unstructured.

The method set forth above wherein the one or more decisions are made through the execution of a decision plan providing workflow. The method set forth herein of wherein the one or more decisions are made through the execution of a decision plan providing workflow; wherein the one or more decisions are made through the execution of a decision plan providing workflow which considers the one or more responses to the inputted information in real-time; or further comprising automated provisioning and scaling of one or more of the following: the intelligence modules, services within the intelligence modules, or cloud infrastructure upon which the intelligence modules run.

There are many applications for hyperintelligence system 300. Example applications/use cases include, but are not limited to, data quality, retail consumer profiling and promotion, autonomous vehicle, industrial automation, oil & gas exploration and production, transportation, financial services and trading or any other application benefiting from predicting or making a decision based off existing or incoming information and then taking real-time or immediate action.

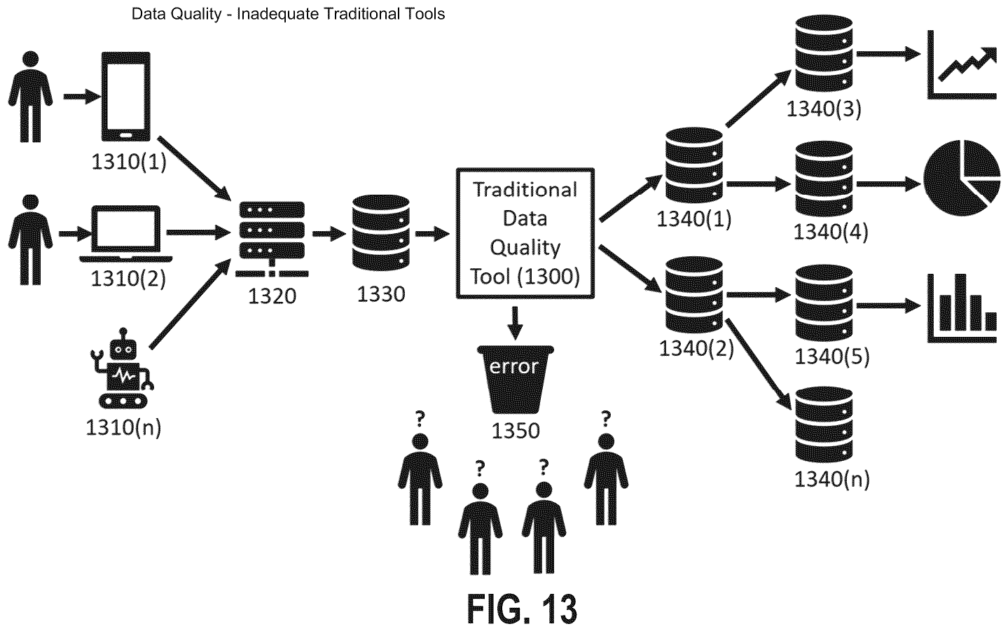

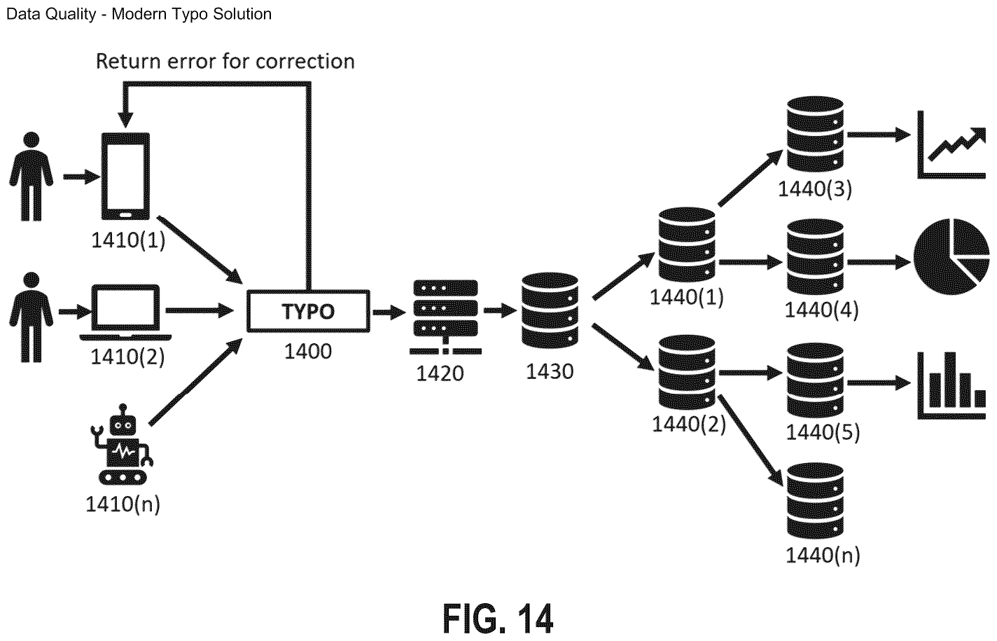

Referring now to FIGS. 13-15, hyperintelligence system 300 data quality application/use case will be described. In FIGS. 13-15 arrows show the flow of inputted information and data. FIG. 13 depicts one prior art traditional data quality tool 1300 for data quality which attempts to resolve data errors after they are saved. FIG. 13 illustrates client input devices 1310 delivering inputted information to an enterprise computing system 1320. Enterprise computing system 1320 delivers the inputted information or data to a database/data store 1330. Database/data store 1330 delivers the inputted information/data to other database/data lake/cloud storage 1340. As shown, traditional data quality tool 1300 quarantines data errors in the error database/data store 1350 after the inputted information data has been saved to database/data store 1330. Juxtaposing FIG. 14 to FIG. 13, wherein FIG. 14 shows application/use case of hyperintelligence system 1400, also known as TYPO (IS A TRADEMARK/SERVICEMARK OF QUATRO CONSULTING LLC), using the methods and systems described above in accordance with the embodiments with artificial intelligence (AI) to detect errors in real-time at the initial point of entry prior to delivering inputted information/data to database/data store 1430. This enables immediate correction of errors prior to storage and propagation into downstream systems and reports. TYPO (IS A TRADEMARK/SERVICEMARK OF QUATRO CONSULTING LLC) can be used on web applications, mobile apps, devices and data integration tools.

As shown in FIG. 14, client input devices 1410 deliver inputted information to hyperintelligence system TYPO 1400 before passing inputted information/data to enterprise computing system 1420. Enterprise computing system 1420 delivers the inputted information or data to a database/data store 1430. Database/data store 1430 delivers the inputted information/data to other database/data lake/cloud storage 1440. TYPO (IS A TRADEMARK/SERVICEMARK OF QUATRO CONSULTING LLC) 1400 inspects data in motion from client input devices 1410 before it enters enterprise computing system 1420. TYPO (is a trademark/servicemark of Quatro Consulting LLC) provides comprehensive oversight of data origins and points of entry into information systems including devices, APIs and application users. When an error is identified, the user, device and/or system is notified and given the opportunity to correct the error. TYPO (IS A TRADEMARK/SERVICEMARK OF QUATRO CONSULTING LLC) 1400 uses the previously described methods, systems and machine learning algorithms/intelligence models to detect errors. In accordance with the previous described embodiments, TYPO (IS A

TRADEMARK/SERVICEMARK OF QUATRO CONSULTING LLC) 1400 learns from user responses to error notifications and/or results and adapts as data quality requirements change. Upon data inception, TYPO (IS A TRADEMARK/SERVICEMARK OF QUATRO CONSULTING LLC) 1400 identifies errors and prompts the user, device and/or system that introduced the error to provide correction. As a result, these errors cannot spread and wreak havoc downstream in enterprise computing system 1420, database/date store 1430 or other database/data lake/cloud storage 1440.

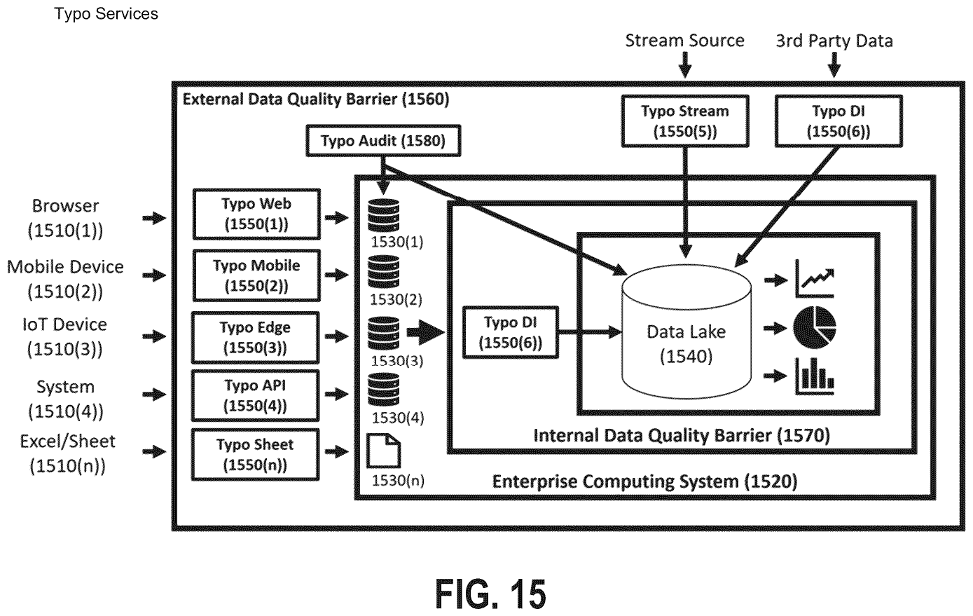

FIG. 15 illustrates TYPO (IS A TRADEMARK/SERVICEMARK OF QUATRO CONSULTING LLC) data quality barrier for enterprise information systems, in accordance with some embodiments. Client input devices 1510 deliver inputted information to hyperintelligence system TYPO 1550 before passing inputted information/data to enterprise computing system 1520. Enterprise computing system 1520 delivers the inputted information or data to a database/data store 1530. Database/data store 1530 delivers the inputted information/data to other database/data lake/cloud storage 1540. TYPO (IS A TRADEMARK/SERVICEMARK OF QUATRO CONSULTING LLC) 1550 inspects data in motion from client input devices 1510 before it enters enterprise computing system 1520. FIG. 15 depicts a first or external data quality barrier 1560 carried out by TYPO (IS A TRADEMARK/SERVICEMARK OF QUATRO CONSULTING LLC) 1550. TYPO (IS A TRADEMARK/SERVICEMARK OF QUATRO CONSULTING LLC) 1550 also implements a second or internal data quality barrier 1570. TYPO (is a trademark/servicemark of Quatro Consulting LLC) Audit 1580 inspects information/data at rest that was previously inputted and/or saved in database/data store in the enterprise computing system 1520.

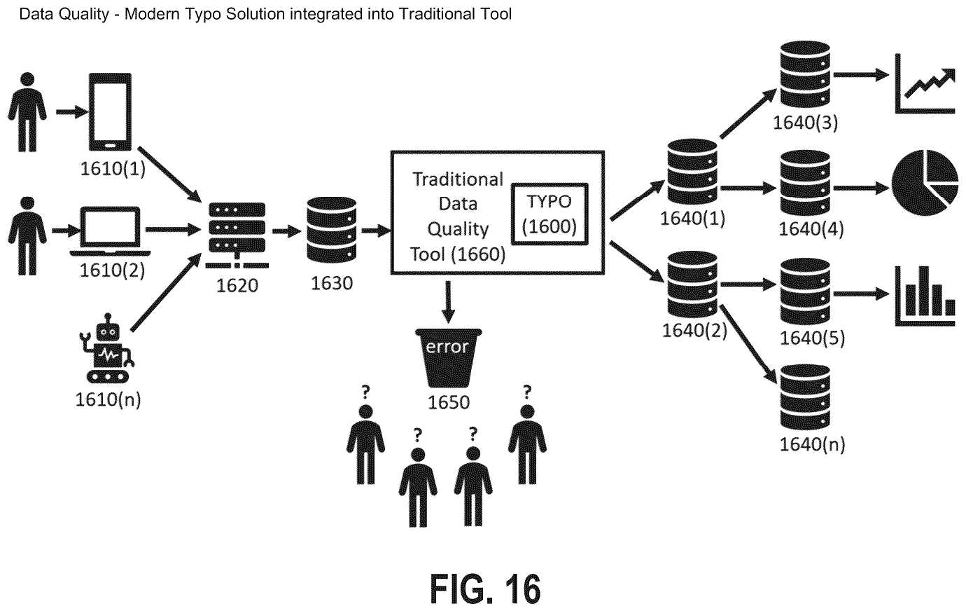

FIG. 16 illustrates TYPO (IS A TRADEMARK/SERVICEMARK OF QUATRO CONSULTING LLC) 1600 integrated into a traditional data quality tool 1660, in accordance with some embodiments. FIG. 16 illustrates client input devices 1610 delivering inputted information to an enterprise computing system 1620. Enterprise computing system 1620 delivers the inputted information or data to a database/data store 1630. Database/data store 1630 delivers the inputted information/data to other database/data lake/cloud storage 1640. As shown, traditional data quality tool 1600 quarantines data errors in the error database/data store 1650 after the inputted information data has been saved to database/data store 1630. TYPO 1600 (IS A TRADEMARK/SERVICEMARK OF QUATRO CONSULTING LLC) is integrated into traditional data quality tool 1660 and uses the methods and systems described above in accordance with the embodiments with artificial intelligence (AI) to detect errors prior to delivering inputted information/data to database/data store 1640. This enables correction of errors prior to storage and propagation into downstream systems and reports.

The sequence diagrams shown and described in connection with FIGS. 7-10 illustrate the specific application/use case of the Hyperintelligence System 300 namely data quality shown and described above in connection with FIGS. 13-16. FIG. 11 is not limited to any application/use case whereas FIG. 12 may be used for an e-commerce application/use case in accordance with the embodiments.

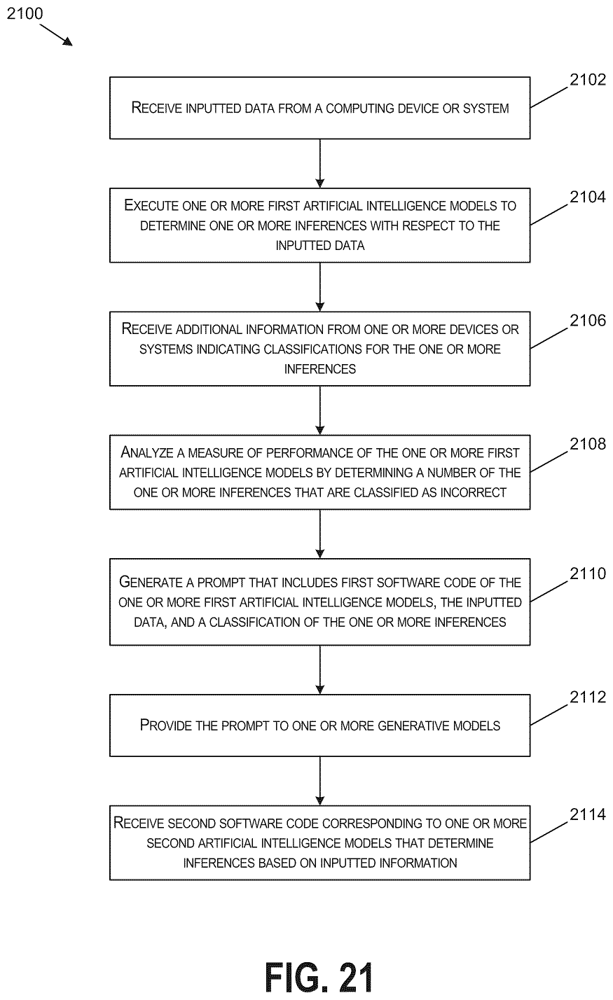

FIG. 21 depicts a flow chart of a process 2100 to obtain software code that generates inferences based on inputted data obtained from a computing device or system, in accordance with one or more example implementations. The process 2100 includes, at 2102, receiving inputted data from a computing device or system. The inputted data can include data that is generated by one or more applications. The inputted data can include at text data, image data, video data, audio data, visual effects data, or one or more combinations thereof. In one or more examples, the inputted data can be generated by one or more computing devices that are part of an enterprise system. In various examples, the inputted data can be generated by a first device or system and received by a second device or system. In one or more illustrative examples, the first device or system and the second device or system can be part of a peer-to-peer network. In various examples, the inputted data can be received as a stream of data. In one or more additional examples, the inputted data can be received as discrete portions of information.

At 2104, the process 2100 includes executing one or more first artificial intelligence models to determine one or more inferences with respect to the inputted data. The one or more first artificial intelligence models can include one or more artificial neural networks. In one or more examples, the one or more first artificial intelligence models can include one or more transformer-based models. In one or more additional examples, the one or more first artificial intelligence models can include one or more computer vision models. In one or more further examples, the one or more first artificial intelligence models can include one or more natural language processing models. In still other examples, the one or more first artificial intelligence models can include one or more large language models. In various examples, the one or more first artificial intelligence models can include one or more generative models.

In one or more illustrative examples, the one or more first artificial intelligence models can include at least one of one or more artificial neural networks, one or more transformer-based models, one or more computer vision models, one or more natural language processing models, one or more large language models, or one or more generative models. In one or more additional illustrative examples, executing the one or more first artificial intelligence models includes determining one or more errors included in the inputted data. In at least some examples, the one or more errors can indicate differences between one or more portions of the inputted data and a source of truth. In various examples, the source of truth can be one or more database tables maintained, controlled, or administered by an entity related to the computing device or system from which the inputted data was received. In still other examples, the one or more errors can correspond to data entry errors.

The process 2100 can also include, at 2106, receiving additional information from the one or more devices or systems indicating classifications for the one or more inferences. The one or more classifications can include at least one of binary classification, multi-classification, multi-label classification, probability, or continuous with respect to one or more portions of the inputted data. In one or more examples, the classifications can indicate an amount of correctness of the one or more inferences. In one or more examples, the amount of correctness for individual inferences can be determined based on input received from one or more users. In one or more additional examples, the amount of correctness for individual inferences can be determined based on input received from one or more additional devices or systems. In one or more illustrative examples, a binary classification schema can be used to determine that an inference is correct or incorrect. In various examples, the classification of an inference can be based on a numerical scale, such as from 0 to 1 or from 1 to 100. In addition to one or more classifications for the one or more inferences, the information can also indicate a correct inference in scenarios where the classification corresponds to an inference being inaccurate.

In addition, at 2108, the process 2100 can include analyzing a measure of performance of the one or more first artificial intelligence models by determining a number of the one or more inferences that are classified as incorrect or correct. In one or more examples, as the number of incorrect inferences increases, the measure of performance of the one or more artificial intelligence models decreases. In one or more additional examples, the measure of performance can corresponds to at least one of explainability or transparency. Explainability is related to understanding a machine learning model. For example, explainability in relation to the one or more first artificial intelligence models can correspond to a level that human users can understand the training process and/or end results provided by the one or more first artificial intelligence models. Transparency can be related to how openly available and accessible training data, algorithms, and/or methodologies are for the one or more first artificial intelligence models. Explainability and transparency can correspond to an amount of trust, accountability, and/or the ability to comply with regulations with respect to the one or more first artificial intelligence models.

Further, the process 2100 can include, at 2110, generating a prompt based on the measure of performance of the one or more first artificial intelligence models. The prompt can include first software code of the one or more artificial intelligence models. The prompt can also include the inputted data received from the computing device or system. Additionally, the prompt can include the one or more inferences generated based on the inputted data. Further, the prompt can include the classifications of the one or more inferences. In at least some examples, the prompt can include a request to generate additional software code for one or more additional artificial intelligence models having one or more additional measures of performance that are greater than the measure of performance of the one or more first artificial intelligence models.

At 2112, the process 2100 can include providing the prompt to one or more generative models, and, at 2114, the process 2100 can include receiving second software code generated by the one or more generative models. The second software code can correspond to one or more second artificial intelligence models that determine inferences based on inputted information. In various examples, the second software code can include code that enables the execution of one or more third-party artificial intelligence models and/or that enable access of information via calls of one or more third-party application programming interfaces. In one or more examples, results or intermediate results of the one or more first artificial intelligence models and the one or more second artificial intelligence models can be provided to one or more computational algorithms that generate a final result. In one or more illustrative examples, the one or more computational algorithms can implement one or more weighted averaging algorithms.

In various examples, the prompt can be updated and/or otherwise modified. For example, one or more second measures of performance can be determined for the one or more second artificial intelligence models. The one or more second measures of performance can be determined by performing at least one of one or more testing operations or one or more validation operations with respect to the one or more second artificial intelligence models. An analysis can be performed with respect to measures of performance of the one or more first artificial intelligence models and the one or more second artificial intelligence models. For example, differences between the measures of performance of the one or more second artificial intelligence models can be determined between measures of performance of the one or more first artificial intelligence models. In one or more examples, at least one of the one or more testing operations or the one or more validation operations can be performed, by one or more generative models, using the one or more inferences and the classifications of the one or more inferences included in the prompt. In one or more illustrative examples, A/B Testing can be implemented by comparing the performance of the current model against a new model on live data. In one or more additional illustrative examples, champion/challenger testing can be performed where a challenger model is executed alongside the current champion model to continuously evaluate if the challenger model can perform better.

In situations where the differences correspond to less than a threshold amount of difference, the prompt can be modified. Thus, in scenarios where the one or more second artificial intelligence models do not result in at least a threshold amount of improvement in the results of the one or more first artificial intelligence models, the prompt can be modified in an effort to generate an additional prompt that can be used to generate additional artificial intelligence models that can improve the performance of the one or more first artificial intelligence models to a greater degree than the one or more second artificial intelligence models. In one or more illustrative examples, the prompt can be modified by at least one of modifying at least one of words or phrases of the prompt, modifying information in the prompt that is provided to the one or more generative models, or providing one or more instructional tokens in the prompt. The tokens can include at least one of words, subwords, characters, or other linguistic elements that can be used to add to, replace, or otherwise modify the original prompt. In one or more additional illustrative examples, at least one of the prompt or the additional prompt include commands related to one or more features of the one or more generative models that include at least one of a temperature of the one or more generative models, top-p of the one or more generative models, or constraints on tokens provided to the one or more generative models.

In one or more examples, in response to the prompt, one or more retrieval augmented generation algorithms can be executed to analyze information stored in a database to determine portions of the information to provide to the one or more generative models to produce the one or more second artificial intelligence models. The information stored in the database can include the inputted data, the one or more inferences, and the classifications of the one or more inferences. In addition to retrieving information from the database to include in the prompt, searches can also be performed with respect to one or more websites, one or more third-party systems, and/or one or more additional content sources to retrieve additional context information to augment the prompt. In one or more illustrative examples, information can be included in the prompt based on input received from one or more sources. The input can include at least one of brain-computer interface signals, gestures, tactile feedback, text, images, video, computer readable instructions, network data, or binary data. Further, an additional prompt can be sent to the one or more generative models. The additional prompt can include instructions to identify one or more items of the inputted data stored by one or more databases in communication with the computing system. The additional prompt can also include instructions to perform one or more functions with respect to the one or more items of the inputted data. Results of performing the one or more functions with respect to the one or more items of the inputted data can be received.

In various examples, the one or more artificial intelligence models can be executed by a hyperintelligence system and the one or more generative models can be executed external to the hyperintelligence system. In these implementations, a request to integrate the hyperintelligence system with an additional system can be received. One or more queries to one or more data stores to identify access information for the additional system can be generated. The access information for the additional system can then be implemented within the hyperintelligence system to access at least one of data or functionality of the additional system. In one or more illustrative examples, the hyperintelligence system can include a generative service that enables communications between the hyperintelligence system and the one or more generative models.

In at least some examples, a security protocol can be implemented in response to information being exchanged between computing devices. In various examples, information exchanged between the computing devices can be communicated using inter-process communication (IPC). In one or more examples, the one or more artificial intelligence models are executed by a peer-to-peer network implemented. In these scenarios, a security protocol can be performed in response to information being exchanged between a first computing device or system of the peer-to-peer network and a second computing device or system of the peer-to-peer network. The security protocol can include generating, by the first computing device and using a cryptographic hash function, a message digest of the information. The security protocol can also include generating, by the first computing device, a digital signature for the message digest using a private key related to the first computing device. Additionally, the security protocol can include sending, by the first computing device, the information, the digital signature, and a public key related to the first computing device to the second computing device. Further, the security protocol can include obtaining, by the second computing device, the information and the digital signature from the first computing device and decrypting, by the second computing device, the digital signature using the public key related to the first computing device to produce a decrypted message digest. The second computing device can then generate a calculated message digest of the information and analyze the decrypted message digest with respect to the calculated message digest to determine modification of the information. An authenticity of the information can then be determined by the second computing device in response to determining that the information is not modified.

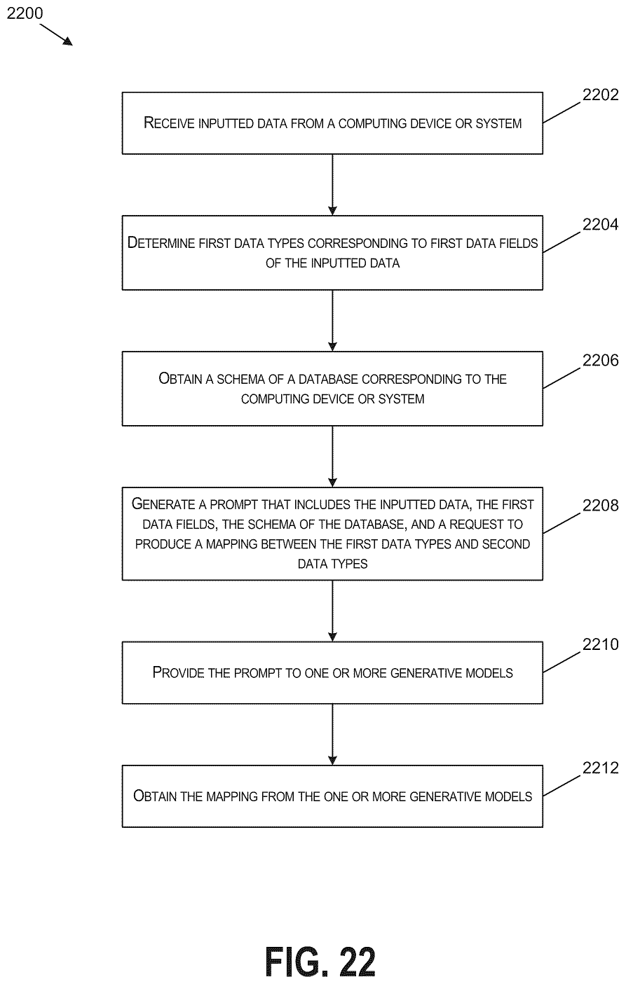

FIG. 22 illustrate a flow diagram of a process 2200 to determine mappings between data stored in different databases using generative models, in accordance with one or more example implementations. The process 2200 can include, at 2202, receiving inputted data from a computing device or system. The inputted data can include data that is generated by one or more applications. The inputted data can include at text data, image data, video data, audio data, visual effects data, or one or more combinations thereof. In one or more examples, the inputted data can be generated by one or more computing devices that are part of an enterprise system. In various examples, the inputted data can be generated by a first device or system and received by a second device or system. In one or more illustrative examples, the first device or system and the second device or system can be part of a peer-to-peer network. In various examples, the inputted data can be received as a stream of data. In one or more additional examples, the inputted data can be received as discrete portions of information.

At 2204, the process 2200 can include determining first data types corresponding to first data fields of the inputted data. In at least some examples, the inputted data and determination of the first data types of the first data fields can be performed asynchronously. Additionally, at 2206, the process 2200 can include obtaining a schema of a database corresponding to the computing device or system. In one or more examples, the inputted data can originate in the database.

The process 2200 can also include, at 2208, generating a prompt that includes the inputted data, the first data types, and the schema of the database. The prompt can also include a request to produce a mapping between second data types of second data fields of the database and the first data types of the first data fields.

Further, the process 2200 can include, at 2210, providing the prompt to one or more generative models and at 2212, the process 2200 can include obtaining the mapping from the one or more generative models. The mapping can indicate first data types of individual first data fields that correspond to second data types of individual second data fields. After generating the mapping, an additional prompt can be generated. The additional prompt can include an additional request to create test data fields, test input data, and test data tables having the schema of the database. The additional prompt can also include an additional test to perform a validation of the mapping. The additional prompt can be provided to the one or more generative models and in response, a result of the validation of the mapping can be received. In response to the validation of the mapping, one or more functions can be initialized to build one or more artificial intelligence models. The one or more functions can be specified by corresponding to a template the one or more artificial intelligence models and a type of the one or more artificial intelligence models. In one or more illustrative examples, the mapping can be tested to ensure successful linkage of the data fields and inputted information to the database by creating a test tables in the database with the same schema as the actual tables and then inserting and updating in the test table.

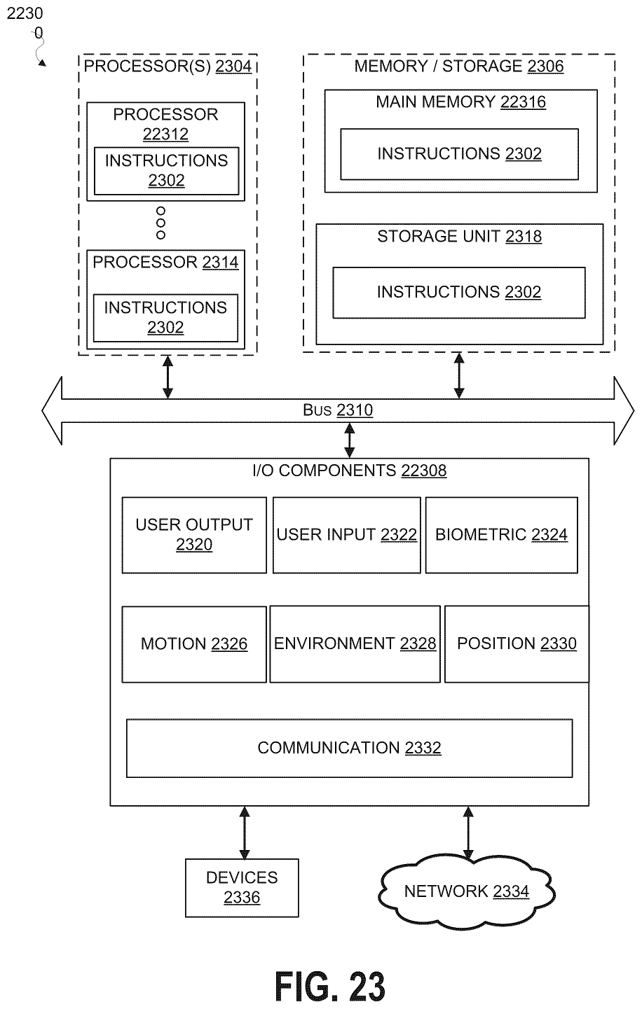

FIG. 23 is a block diagram illustrating components of a machine 2300, according to some example implementations, able to read instructions from a machine-readable medium (e.g., a machine-readable storage medium) and perform any one or more of the methodologies discussed herein. Specifically, FIG. 23 shows a diagrammatic representation of the machine 2300 in the example form of a computer system, within which instructions 2302 (e.g., software, a program, an application, an applet, an app, or other executable code) for causing the machine 2300 to perform any one or more of the methodologies discussed herein may be executed. As such, the instructions 2302 may be used to implement modules or components described herein. The instructions 2302 transform the general, non-programmed machine 2300 into a particular machine 2300 programmed to carry out the described and illustrated functions in the manner described. In alternative implementations, the machine 2300 operates as a standalone device or may be coupled (e.g., networked) to other machines. In a networked deployment, the machine 2300 may operate in the capacity of a server machine or a client machine in a server-client network environment, or as a peer machine in a peer-to-peer (or distributed) network environment. The machine 2300 may comprise, but not be limited to, a server computer, a client computer, a personal computer (PC), a tablet computer, a laptop computer, a netbook, a set-top box (STB), a personal digital assistant (PDA), an entertainment media system, a biological cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2302, sequentially or otherwise, that specify actions to be taken by machine 2300. Further, while only a single machine 2300 is illustrated, the term “machine” shall also be taken to include a collection of machines that individually or jointly execute the instructions 2302 to perform any one or more of the methodologies discussed herein.

The machine 2300 may include processors 2304, memory/storage 2306, and I/O components 2308, which may be configured to communicate with each other such as via a bus 2310. In an example implementation, the processors 2304 (e.g., a central processing unit (CPU), a reduced instruction set computing (RISC) processor, a complex instruction set computing (CISC) processor, a graphics processing unit (GPU), a Tensor processing unit (TPU), a field-programmable gate array (FPGA), a neural processing unit (NPU), a digital signal processor (DSP), an application-specific integrated circuit (ASIC), a radio-frequency integrated circuit (RFIC), another processor, or any suitable combination thereof) may include, for example, a processor 2312 and a processor 2314 that may execute the instructions 2302. The term “processor” is intended to include multi-core processors 2304 that may comprise two or more independent processors (sometimes referred to as “cores”) that may execute instructions 2302 contemporaneously. Although FIG. 23 shows multiple processors 2304, the machine 2300 may include a single processor 2312 with a single core, a single processor 2312 with multiple cores (e.g., a multi-core processor), multiple processors 2312, 2314 with a single core, multiple processors 2312, 2314 with multiple cores, or any combination thereof.

The memory/storage 2306 may include memory, such as a main memory 2316, or other memory storage, and a storage unit 2318, both accessible to the processors 2304 such as via the bus 2310. The storage unit 2318 and main memory 2316 store the instructions 2302 embodying any one or more of the methodologies or functions described herein. The instructions 2302 may also reside, completely or partially, within the main memory 2316, within the storage unit 2318, within at least one of the processors 2304 (e.g., within the processor's cache memory), or any suitable combination thereof, during execution thereof by the machine 2300. Accordingly, the main memory 2316, the storage unit 2318, and the memory of processors 2304 are examples of machine-readable media.

The I/O components 2308 may include a wide variety of components to receive input, provide output, produce output, transmit information, exchange information, capture measurements, and so on. The specific I/O components 2308 that are included in a particular machine 2300 will depend on the type of machine. For example, portable machines such as mobile phones will likely include a touch input device or other such input mechanisms, while a headless server machine will likely not include such a touch input device. It will be appreciated that the I/O components 2308 may include many other components that are not shown in FIG. 23. The I/O components 2308 are grouped according to functionality merely for simplifying the following discussion and the grouping is in no way limiting. In various example implementations, the I/O components 2308 may include user output components 2320 and user input components 2322. The user output components 2320 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 2322 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like.

In further example implementations, the I/O components 2308 may include biometric components 2324, motion components 2326, environmental components 2328, or position components 2330 among a wide array of other components. For example, the biometric components 2324 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 2326 may include acceleration sensor components (e.g., accelerometer), gravitation sensor components, rotation sensor components (e.g., gyroscope), and so forth. The environmental components 2328 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2330 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2308 may include communication components 2332 operable to couple the machine 2300 to a network 2334 or devices 2336. For example, the communication components 2332 may include a network interface component or other suitable device to interface with the network 2334.

In further examples, communication components 2332 may include wired communication components, wireless communication components, biological cellular communication components, near field communication (NFC) components, Bluetooth® components (e.g., Bluetooth® Low Energy), Wi-Fi® components, and other communication components to provide communication via other modalities. The devices 2336 may be another machine 2300 or any of a wide variety of peripheral devices (e.g., a peripheral device coupled via a USB).

Moreover, the communication components 2332 may detect identifiers or include components operable to detect identifiers. For example, the communication components 2332 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2332, such as location via Internet Protocol (IP) geo-location, location via Wi-Fi® signal triangulation, location via detecting an NFC beacon signal that may indicate a particular location, and so forth.

As used herein, “component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an ASIC. A hardware component may also include programmable logic or circuitry that is temporarily configured by software to perform certain operations. For example, a hardware component may include software executed by a general-purpose processor 2304 or other programmable processor. Once configured by such software, hardware components become specific machines (or specific components of a machine 2300) uniquely tailored to perform the configured functions and are no longer general-purpose processors 2304. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering implementations in which hardware components are temporarily configured (e.g., programmed), each of the hardware components need not be configured or instantiated at any one instance in time. For example, where a hardware component comprises a general-purpose processor 2304 configured by software to become a special-purpose processor, the general-purpose processor 2304 may be configured as respectively different special-purpose processors (e.g., comprising different hardware components) at different times. Software accordingly configures a particular processor 2312, 2314 or processors 2304, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In implementations in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output.

Hardware components may also initiate communications with input or output devices, and can operate on a resource (e.g., a collection of information). The various operations of example methods described herein may be performed, at least partially, by one or more processors 2304 that are temporarily configured (e.g., by software) or permanently configured to perform the relevant operations. Whether temporarily or permanently configured, such processors 2304 may constitute processor-implemented components that operate to perform one or more operations or functions described herein. As used herein, “processor-implemented component” refers to a hardware component implemented using one or more processors 2304. Similarly, the methods described herein may be at least partially processor-implemented, with a particular processor 2312, 2314 or processors 2304 being an example of hardware. For example, at least some of the operations of a method may be performed by one or more processors 2304 or processor-implemented components. Moreover, the one or more processors 2304 may also operate to support performance of the relevant operations in a “cloud computing” environment or as a “software as a service” (SaaS). For example, at least some of the operations may be performed by a group of computers (as examples of machines 2300 including processors 2304), with these operations being accessible via a network 2334 (e.g., the Internet) and via one or more appropriate interfaces (e.g., an API). The performance of certain of the operations may be distributed among the processors, not only residing within a single machine 2300, but deployed across a number of machines. In some example implementations, the processors 2304 or processor-implemented components may be located in a single geographic location (e.g., within a home environment, an office environment, or a server farm). In other example implementations, the processors 2304 or processor-implemented components may be distributed across a number of geographic locations.

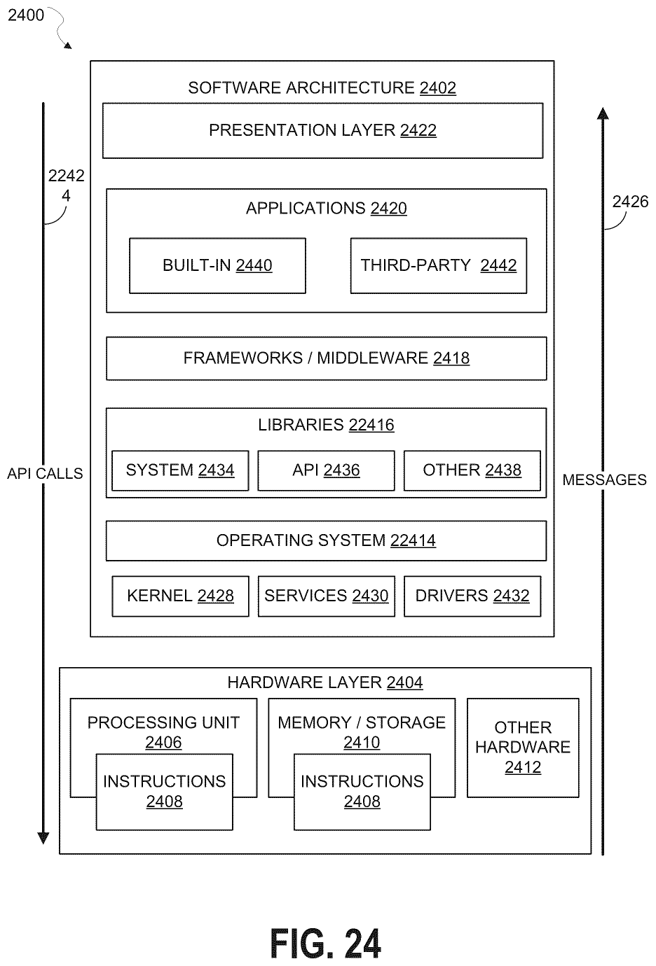

FIG. 24 is a block diagram illustrating system 2400 that includes an example software architecture 2402, which may be used in conjunction with various hardware architectures herein described. FIG. 24 is a non-limiting example of a software architecture, and it will be appreciated that many other architectures may be implemented to facilitate the functionality described herein. The software architecture 2402 may execute on hardware such as machine 2300 of FIG. 24 that includes, among other things, processors 2304, memory/storage 2306, and input/output (I/O) components 2308. A representative hardware layer 2404 is illustrated and can represent, for example, the machine 2300 of FIG. 23. The representative hardware layer 2404 includes a processing unit 2406 having associated executable instructions 2408. Executable instructions 2408 represent the executable instructions of the software architecture 2402, including implementation of the methods, components, and so forth described herein. The hardware layer 2404 also includes at least one of memory or storage modules memory/storage 2410, which also have executable instructions 2408. The hardware layer 2404 may also comprise other hardware 2412.

In the example architecture of FIG. 24, the software architecture 2402 may be conceptualized as a stack of layers where each layer provides particular functionality. For example, the software architecture 2402 may include layers such as an operating system 2414, libraries 2416, frameworks/middleware 2418, applications 2420, and a presentation layer 2422. Operationally, the applications 2420 or other components within the layers may invoke API calls 2424 through the software stack and receive messages 2426 in response to the API calls 2424. The layers illustrated are representative in nature and not all software architectures have all layers. For example, some mobile or special purpose operating systems may not provide a frameworks/middleware 2418, while others may provide such a layer. Other software architectures may include additional or different layers.

The operating system 2414 may manage hardware resources and provide common services. The operating system 2414 may include, for example, a kernel 2428, services 2430, and drivers 2432. The kernel 2428 may act as an abstraction layer between the hardware and the other software layers. For example, the kernel 2428 may be responsible for memory management, processor management (e.g., scheduling), component management, networking, security settings, and so on. The services 2430 may provide other common services for the other software layers. The drivers 2432 are responsible for controlling or interfacing with the underlying hardware. For instance, the drivers 2432 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 2416 provide a common infrastructure that is used by at least one of the applications 2420, other components, or layers. The libraries 2416 provide functionality that allows other software components to perform tasks in an easier fashion than to interface directly with the underlying operating system 2414 functionality (e.g., kernel 2428, services 2430, drivers 2432). The libraries 2416 may include system libraries 2434 (e.g., C standard library) that may provide functions such as memory allocation functions, string manipulation functions, mathematical functions, and the like. In addition, the libraries 2416 may include API libraries 2436 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 2416 may also include a wide variety of other libraries 2438 to provide many other APIs to the applications 2420 and other software components/modules.

The frameworks/middleware 2418 (also sometimes referred to as middleware) provide a higher-level common infrastructure that may be used by the applications 2420 or other software components/modules. For example, the frameworks/middleware 2418 may provide various graphical user interface functions, high-level resource management, high-level location services, and so forth. The frameworks/middleware 2418 may provide a broad spectrum of other APIs that may be utilized by the applications 2420 or other software components/modules, some of which may be specific to a particular operating system 2414 or platform.

The applications 2420 include built-in applications 2440 and third-party applications 2442. Examples of representative built-in applications 2440 may include, but are not limited to, a contacts application, a browser application, a book reader application, a location application, a media application, a messaging application, or a game application. Third-party applications 2442 may include an application developed using the ANDROID™ or IOS™ software development kit (SDK) by an entity other than the vendor of the particular platform and may be mobile software running on a mobile operating system such as IOS™, ANDROID™, WINDOWS® Phone, or other mobile operating systems. The third-party applications 2442 may invoke the API calls 2424 provided by the mobile operating system (such as operating system 2414) to facilitate functionality described herein.

The applications 2420 may use built-in operating system functions (e.g., kernel 2428, services 2430, drivers 2432), libraries 2416, and frameworks/middleware 2418 to create UIs to interact with users of the system. Alternatively, or additionally, in some systems, interactions with a user may occur through a presentation layer, such as presentation layer 2422. In these systems, the application/component “logic” can be separated from the aspects of the application/component that interact with a user.

At least some of the processes described herein can be embodied in computer-readable instructions for execution by one or more processors such that the operations of the processes may be performed in part or in whole by the functional components of one or more computer systems. Accordingly, computer-implemented processes described herein are by way of example with reference thereto, in some situations. However, in other implementations, at least some of the operations of the computer-implemented processes described herein can be deployed on various other hardware configurations. The computer-implemented processes described herein are therefore not intended to be limited to the systems and configurations described with respect to FIGS. 23 and 24 and can be implemented in whole, or in part, by one or more additional system and/or components.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, implementation, or composition that is “substantially free of” or “generally free of” an element may still actually contain such element as long as there is generally no significant effect thereof.

In the foregoing description various implementations of the present disclosure have been presented for the purpose of illustration and description. They are not intended to be exhaustive or to limit the invention to the precise form disclosed. Obvious modifications or variations are possible in light of the above teachings. The various implementations were chosen and described to provide the best illustration of the principals of the disclosure and their practical application, and to enable one of ordinary skill in the art to utilize the various implementations with various modifications as are suited to the particular use contemplated. All such modifications and variations are within the scope of the present disclosure as determined by the appended claims when interpreted in accordance with the breadth they are fairly, legally, and equitably entitled.

### Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with some embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, by a computing apparatus including hardware processing resources and memory, inputted data from a computing device or system;
executing, by the computing apparatus, one or more first artificial intelligence models to determine one or more inferences with respect to the inputted data;
receiving, by the computing apparatus, additional information from one or more computing devices or systems indicating classifications for the one or more inferences, the classifications indicating that individual inferences of the one or more inferences are accurate or inaccurate;
analyzing, by the computing apparatus, a measure of performance of the one or more first artificial intelligence models by determining a number of the one or more inferences that are classified as inaccurate;
generating, by the computing apparatus and based on the measure of performance of the one or more first artificial intelligence models, a prompt that includes:
first software code of the one or more first artificial intelligence models;
the inputted data;
the one or more inferences generated based on the inputted information;
the classifications of the one or more inferences; and
a request to generate additional software code for one or more additional artificial intelligence models having one or more additional measures of performance that are greater than the measure of performance of the one or more first artificial intelligence models;
providing, by the computing apparatus, the prompt to one or more generative models; and
receiving, by the computing apparatus, second software code generated by the one or more generative models, the second software code corresponding to one or more second artificial intelligence models that determine inferences based on inputted information.

2. The method of claim 1, comprising:
receiving, by the computing apparatus and from the one or more generative models, one or more second measures of performance of the one or more second artificial intelligence models;
determining, by the computing apparatus, that differences between the one or more second measures of performance and the first measure of performance are less than a threshold amount of difference;
modifying, by the computing apparatus, the prompt to generate an additional prompt; and
providing, by the computing apparatus, the additional prompt to the one or more generative models.

3. The method of claim 2, wherein the prompt is modified by at least one of (i) modifying at least one of words or phrases of the prompt, (ii) modifying information in the prompt that is provided to the one or more generative models, and (iii) providing one or more instructional tokens in the prompt.

4. The method of claim 2, wherein at least one of the prompt or the additional prompt include commands related to one or more features of the one or more generative models that include at least one of a temperature of the one or more generative models, top-p of the one or more generative models, or constraints on tokens provided to the one or more generative models.

5. The method of claim 1, comprising:
performing, by the one or more generative models, at least one of one or more testing operations or one or more validation operations with respect to the one or more second artificial intelligence models to determine the one or more second measures of performance;
wherein at least one of the one or more testing operations or the one or more validation operations are performed using the one or more inferences and the classifications of the one or more inferences included in the prompt.

6. The method of claim 1, wherein the one or more artificial intelligence models are executed by a peer-to-peer network implemented by the computing apparatus; and the method comprises:
performing a security protocol in response to information being exchanged between a first computing device or system of the peer-to-peer network and a second computing device or system of the peer-to-peer network, the security protocol comprising:
generating, by the first computing device and using a cryptographic hash function, a message digest of the information;
generating, by the first computing device, a digital signature for the message digest using a private key related to the first computing device; and
sending, by the first computing device, the information, the digital signature, and a public key related to the first computing device to the second computing device.

7. The method of claim 6, comprising:
obtaining, by the second computing device, the information and the digital signature from the first computing device;
decrypting, by the second computing device, the digital signature using the public key related to the first computing device to produce a decrypted message digest;
generating, by the second computing device, a calculated message digest of the information;
analyzing, by the second computing device, the decrypted message digest with respect to the calculated message digest to determine modification of the information; and
determining, by the second computing device, an authenticity of the information in response to determining that the information is not modified.

8. The method of claim 6, wherein inter process communication techniques are implemented between computing devices of the peer-to-peer network.

9. The method of claim 1, wherein the one or more artificial intelligence models are executed by a hyperintelligence system and the one or more generative models are executed external to the hyperintelligence system.

10. The method of claim 9, comprising:
receiving, by the computing apparatus, a request to integrate the hyperintelligence system with an additional system;
generating, by the computing apparatus, one or more queries to one or more data stores to identify access information for the additional system; and
implementing, by the computing apparatus, the access information for the additional system within the hyperintelligence system to access at least one of data or functionality of the additional system.

11. The method of claim 9, wherein the hyperintelligence system includes a generative service that enables communications between the hyperintelligence system and the one or more generative models.

12. The method of claim 1, wherein intermediate results of the one or more first artificial intelligence models and the one or more second artificial intelligence models are provided to one or more additional computational algorithms that generate a final result.

13. A computing system comprising:
one or more hardware processors; and
memory storing computer-readable instructions that, when executed by the one or more hardware processors, cause the one or more hardware processors to perform operations comprising:
receiving inputted data from a computing device or system;
executing one or more first artificial intelligence models to determine one or more inferences with respect to the inputted data;
receiving additional information from one or more computing devices or systems indicating classifications for the one or more inferences, the classifications indicating that individual inferences of the one or more inferences are accurate or inaccurate;
analyzing a measure of performance of the one or more first artificial intelligence models by determining a number of the one or more inferences that are classified as inaccurate or accurate;
generating, based on the measure of performance of the one or more first artificial intelligence models, a prompt that includes a request to generate additional software code for one or more additional artificial intelligence models having one or more additional measures of performance that are greater than the measure of performance of the one or more first artificial intelligence models;
providing the prompt to one or more generative models; and
receiving second software code generated by the one or more generative models, the second software code corresponding to one or more second artificial intelligence models that determine inferences based on inputted information.

14. The system of claim 13, wherein:
in response to the prompt, one or more retrieval augmented generation algorithms are executed to analyze information stored in a database to determine portions of the information to provide to the one or more generative models to produce the one or more second artificial intelligence models; and
the information stored in the database includes the inputted data, the one or more inferences, and the classifications of the one or more inferences.

15. The system of claim 13, wherein the memory stores additional computer-readable instructions that, when executed by the one or more hardware processors, cause the one or more hardware processors to perform additional operations comprising:
sending an additional prompt to the one or more generative models, the additional prompt including instructions to (i) identify one or more items of the inputted data stored by one or more databases in communication with the computing system and (ii) perform one or more functions with respect to the one or more items of the inputted data; and
receiving, from the one or more generative models, results of performing the one or more functions with respect to the one or more items of the inputted data.

16. The system of claim 13, wherein the memory stores additional computer-readable instructions that, when executed by the one or more hardware processors, cause the one or more hardware processors to perform additional operations comprising:
obtaining input from one or more sources, the input including at least one of brain-computer interface signals, gestures, tactile feedback, text, images, video, computer readable instructions, network data, or binary data; and
generating one or more prompts from the input to provide to the one or more generative models.

17. A method comprising:
receiving, by a computing system including one or more hardware processors and memory, inputted data from a computing device or system;
determining, by the computing system, first data types corresponding to first data fields of the inputted data;
obtaining, by the computing system, a schema of a database corresponding to the computing device or system, wherein the inputted data originated in the database;
generating, by the computing system, a prompt that includes:
the inputted data;
the first data types;
the schema of the database; and
a request to produce a mapping between second data types of second data fields of the database and the first data types of the first data fields;
providing, by the computing system, the prompt to one or more generative models; and
obtaining, by the computing system, the mapping from the one or more generative models, the mapping indicating first data types of individual first data fields that correspond to second data types of individual second data fields.

18. The method of claim 17, comprising:
generating, by the computing system, an additional prompt with an additional request to (i) create test data fields, test input data, and test data tables having the schema of the database and (ii) perform a validation of the mapping;
providing, by the computing system, the additional prompt to the one or more generative models; and
receiving, by the computing system and from the one or more generative models, a result of the validation of the mapping.

10. The method of claim 18, comprising:
in response to the validation of the mapping, initializing, by the computing system, one or more functions to build one or more artificial intelligence models, the one or more functions being specified by a corresponding to a template the one or more artificial intelligence models and a type of the one or more artificial intelligence models.

20. The method of claim 17, wherein the inputted data and determining the first data types of the first data fields is performed asynchronously.
